(19) United States
(12) Patent Application Publication
(10) Pub. No.: US 2025/0350521 A1
(43) Pub. Date: Nov. 13, 2025

(54) SIGNALING DESIGNS FOR ENHANCED LONG RANGE (ELR) TRANSMISSIONS

(71) Applicant: QUALCOMM Incorporated, San Diego, CA (US)

(72) Inventors: Lin YANG, San Diego, CA (US); Tzu-Hsuan CHOU, San Diego, CA (US); Bin TIAN, San Diego, CA (US); Youhan KIM, Saratoga, CA (US)

(21) Appl. No.: 19/080,068

(22) Filed: Mar. 14, 2025

Related U.S. Application Data
(60) Provisional application No. 63/644,435, filed on May 8, 2024.

(51) Int. Cl. H04L 27/26; H04L 1/00

(52) U.S. Cl. CPC H04L 27/2613; H04L 1/0003; H04L 27/2614

(57) ABSTRACT

This disclosure provides methods, components, devices, and systems for signaling designs for enhanced long range (ELR) transmissions. Some aspects more specifically relate to preamble field designs of ELR physical layer (PHY) protocol data unit (PPDU) formats. In some implementations, a wireless communication device may transmit, via a universal signal (U-SIG) field, a first indication that a PPDU is associated with an ELR format and a second indication of a station (STA) identifier. Additionally, or alternatively, a wireless communication device may transmit, via a set of ELR symbols within a PPDU, an ELR sequence in accordance with a mapping between basic service sets (BSSs) and ELR sequences. Additionally, or alternatively, a wireless communication device may include one or more subfields within an ELR-signal (ELR-SIG) field in accordance with a location of the ELR-SIG field and employ one or more transmission schemes associated with the ELR-SIG field and an ELR-data field.

### PRIORITY INFORMATION

The present Application for Patent claims priority under 35 U.S.C. § 119 to U.S. Provisional Patent Application No. 63/644,435 by Yang et al., filed May 8, 2024 and entitled “SIGNALING DESIGNS FOR ENHANCED LONG RANGE (ELR) TRANSMISSIONS,” which is assigned to the assignee hereof and hereby expressly incorporated by reference herein.

### TECHNICAL FIELD

This disclosure relates generally to wireless communication and, more specifically, to signaling designs for enhanced long range (ELR) transmissions.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by or at wireless communication device. The method may include receiving, via a universal signal (U-SIG) field of a physical layer (PHY) protocol data unit (PPDU), a first indication that the PPDU is associated with an enhanced long range (ELR) format, where a first subfield of the U-SIG field includes the first indication and receiving, via the U-SIG field of the PPDU, a second indication of a first station (STA) identifier associated with the PPDU, where a second subfield of the U-SIG field includes the second indication.

Another innovative aspect of the subject matter described in this disclosure can be implemented in a wireless communication device. The wireless communication device may include a processing system that includes processor circuitry and memory circuitry that stores code. The processing system may be configured to cause the wireless communication device to receive, via a U-SIG field of a PPDU, a first indication that the PPDU is associated with an ELR format, where a first subfield of the U-SIG field includes the first indication and receive, via the U-SIG field of the PPDU, a second indication of a first STA identifier associated with the PPDU, where a second subfield of the U-SIG field includes the second indication.

Another innovative aspect of the subject matter described in this disclosure can be implemented in a wireless communication device. The wireless communication device may include means for receiving, via a U-SIG field of a PPDU, a first indication that the PPDU is associated with an ELR format, where a first subfield of the U-SIG field includes the first indication and means for receiving, via the U-SIG field of the PPDU, a second indication of a first STA identifier associated with the PPDU, where a second subfield of the U-SIG field includes the second indication.

Another innovative aspect of the subject matter described in this disclosure can be implemented in a non-transitory computer-readable medium storing code for wireless communication by a wireless communication device. The code may include instructions executable by a processing system to receive, via a U-SIG field of a PPDU, a first indication that the PPDU is associated with an ELR format, where a first subfield of the U-SIG field includes the first indication and receive, via the U-SIG field of the PPDU, a second indication of a first STA identifier associated with the PPDU, where a second subfield of the U-SIG field includes the second indication.

In some implementations of the method, wireless communication devices, and non-transitory computer-readable medium described herein, the U-SIG field excludes a puncture channel information subfield, a modulation and coding scheme (MCS) subfield, a quantity of symbols subfield, and a spatial reuse subfield.

In some implementations of the method, wireless communication devices, and non-transitory computer-readable medium described herein, selectively parsing a remainder of the PPDU that follows the U-SIG field in accordance with at least the first indication.

In some implementations of the method, wireless communication devices, and non-transitory computer-readable medium described herein, the first subfield may be an ELR subfield within a version dependent portion of the U-SIG field and the ELR subfield may be present within the U-SIG field in accordance with a codepoint indicated by a version identifier subfield within a version independent portion of the U-SIG field.

In some implementations of the method, wireless communication devices, and non-transitory computer-readable medium described herein, the second subfield may be a STA identifier subfield within a version dependent portion of the U-SIG field and the STA identifier subfield may be present within the U-SIG field in accordance with the first indication that the PPDU may be associated with the ELR format.

Another innovative aspect of the subject matter described in this disclosure can be implemented in a method for wireless communication by or at wireless communication device. The method may include receiving, via a set of ELR symbols of a PPDU, a first ELR sequence, where the first ELR sequence corresponds to a first basic service set (BSS) associated with the PPDU in accordance with a mapping between a set of multiple ELR sequences and a set of multiple BSSs.

Another innovative aspect of the subject matter described in this disclosure can be implemented in a wireless communication device. The wireless communication device may include a processing system that includes processor circuitry and memory circuitry that stores code. The processing system may be configured to cause the wireless communication device to receive, via a set of ELR symbols of a PPDU, a first ELR sequence, where the first ELR sequence corresponds to a first BSS associated with the PPDU in accordance with a mapping between a set of multiple ELR sequences and a set of multiple BSSs.

Another innovative aspect of the subject matter described in this disclosure can be implemented in a wireless communication device. The wireless communication device may include means for receiving, via a set of ELR symbols of a PPDU, a first ELR sequence, where the first ELR sequence corresponds to a first BSS associated with the PPDU in accordance with a mapping between a set of multiple ELR sequences and a set of multiple BSSs.

Another innovative aspect of the subject matter described in this disclosure can be implemented in a non-transitory computer-readable medium storing code for wireless communication by a wireless communication device. The code may include instructions executable by a processing system to receive, via a set of ELR symbols of a PPDU, a first ELR sequence, where the first ELR sequence corresponds to a first BSS associated with the PPDU in accordance with a mapping between a set of multiple ELR sequences and a set of multiple BSSs.

In some implementations of the method, wireless communication devices, and non-transitory computer-readable medium described herein, selectively parsing a remainder of the PPDU that follows the set of ELR symbols in accordance with the PPDU being associated with the first BSS.

Some implementations of the method, wireless communication devices, and non-transitory computer-readable medium described herein may further include operations, features, means, or instructions for communicating, via one or more association frames, information indicative of a second BSS associated with the wireless communication device, where the second BSS corresponds to a second ELR sequence in accordance with the mapping, and where selectively parsing the remainder of the PPDU that follows the set of ELR symbols may be in accordance with a correlation between the first ELR sequence and the second ELR sequence.

In some implementations of the method, wireless communication devices, and non-transitory computer-readable medium described herein, selectively parsing the remainder of the PPDU that follows the set of ELR symbols may include operations, features, means, or instructions for parsing at least a portion of the remainder of the PPDU in accordance with the correlation between the first ELR sequence and the second ELR sequence satisfying a threshold correlation level.

In some implementations of the method, wireless communication devices, and non-transitory computer-readable medium described herein, in accordance with satisfying the threshold correlation level, the first ELR sequence and the second ELR sequence may be a same sequence and, in accordance with the first ELR sequence and the second ELR sequence being the same sequence, the first BSS and the second BSS may be a same BSS.

In some implementations of the method, wireless communication devices, and non-transitory computer-readable medium described herein, selectively parsing the remainder of the PPDU that follows the set of ELR symbols may include operations, features, means, or instructions for dropping the remainder of the PPDU in accordance with the correlation between the first ELR sequence and the second ELR sequence failing to satisfy a threshold correlation level.

In some implementations of the method, wireless communication devices, and non-transitory computer-readable medium described herein, in accordance with failing to satisfy the threshold correlation level, the first ELR sequence and the second ELR sequence may be different and, in accordance with the first ELR sequence and the second ELR sequence being different, the first BSS and the second BSS may be different.

Another innovative aspect of the subject matter described in this disclosure can be implemented in a method for wireless communication by or at wireless communication device. The method may include receiving, via a preamble portion of a PPDU associated with an ELR format, an ELR-signal (ELR-SIG) field that includes an uplink/downlink indicator subfield, a length subfield, a coding indicator subfield, and an MCS subfield and receiving, via a data portion of the PPDU associated with the ELR format, an ELR-data field in accordance with one or more of the uplink/downlink indicator subfield, the length subfield, the coding indicator subfield, and the MCS subfield included by the ELR-SIG field.

Another innovative aspect of the subject matter described in this disclosure can be implemented in a wireless communication device. The wireless communication device may include a processing system that includes processor circuitry and memory circuitry that stores code. The processing system may be configured to cause the wireless communication device to receive, via a preamble portion of a PPDU associated with an ELR format, an ELR-SIG field that includes an uplink/downlink indicator subfield, a length subfield, a coding indicator subfield, and an MCS subfield and receive, via a data portion of the PPDU associated with the ELR format, an ELR-data field in accordance with one or more of the uplink/downlink indicator subfield, the length subfield, the coding indicator subfield, and the MCS subfield included by the ELR-SIG

### FIELD

Another innovative aspect of the subject matter described in this disclosure can be implemented in a wireless communication device. The wireless communication device may include means for receiving, via a preamble portion of a PPDU associated with an ELR format, an ELR-SIG field that includes an uplink/downlink indicator subfield, a length subfield, a coding indicator subfield, and an MCS subfield and means for receiving, via a data portion of the PPDU associated with the ELR format, an ELR-data field in accordance with one or more of the uplink/downlink indicator subfield, the length subfield, the coding indicator subfield, and the MCS subfield included by the ELR-SIG field.

Another innovative aspect of the subject matter described in this disclosure can be implemented in a non-transitory computer-readable medium storing code for wireless communication by a wireless communication device. The code may include instructions executable by a processing system to receive, via a preamble portion of a PPDU associated with an ELR format, an ELR-SIG field that includes an uplink/downlink indicator subfield, a length subfield, a coding indicator subfield, and an MCS subfield and receive, via a data portion of the PPDU associated with the ELR format, an ELR-data field in accordance with one or more of the uplink/downlink indicator subfield, the length subfield, the coding indicator subfield, and the MCS subfield included by the ELR-SIG field.

Some implementations of the method, wireless communication devices, and non-transitory computer-readable medium described herein may further include operations, features, means, or instructions for receiving, via the preamble portion of the PPDU associated with the ELR format, an ELR-long training field (ELR-LTF), where the ELR-SIG field may be located after the ELR-LTF.

Some implementations of the method, wireless communication devices, and non-transitory computer-readable medium described herein may further include operations, features, means, or instructions for receiving, via the preamble portion of the PPDU associated with the ELR format, one or both of an ELR-short training field (ELR-STF) or an ELR-long training field (ELR-LTF), where the ELR-SIG field may be located prior to the ELR-STF or the ELR-LTF.

In some implementations of the method, wireless communication devices, and non-transitory computer-readable medium described herein, the ELR-SIG field and the ELR-data field may be associated with a coding rate of one-third in accordance with being associated with a distributed resource unit (dRU) size of 52 tones.

In some implementations of the method, wireless communication devices, and non-transitory computer-readable medium described herein, the ELR-SIG field and the ELR-data field may be associated with a coding rate of two-thirds and a two-times (2×) coded bits repetition in accordance with being associated with a binary phase-shift keying (BPSK) modulation scheme.

In some implementations of the method, wireless communication devices, and non-transitory computer-readable medium described herein, the ELR-SIG field and the ELR-data field may be associated with a coding rate of one-half and a three-times (3×) coded bits repetition in accordance with being associated with a quadrature phase-shift keying (QPSK) modulation scheme.

In some implementations of the method, wireless communication devices, and non-transitory computer-readable medium described herein, the ELR-SIG field and the ELR-data field may be associated with a concatenation of an outer code with a repetition coding and the repetition coding may be performed prior to an interleaving.

Another innovative aspect of the subject matter described in this disclosure can be implemented in a method for wireless communication by or at wireless communication device. The method may include transmitting, via a U-SIG field of a PPDU, a first indication that the PPDU is associated with an ELR format, where a first subfield of the U-SIG field includes the first indication and transmitting, via the U-SIG field of the PPDU, a second indication of a first STA identifier associated with the PPDU, where a second subfield of the U-SIG field includes the second indication.

Another innovative aspect of the subject matter described in this disclosure can be implemented in a wireless communication device. The wireless communication device may include a processing system that includes processor circuitry and memory circuitry that stores code. The processing system may be configured to cause the wireless communication device to transmit, via a U-SIG field of a PPDU, a first indication that the PPDU is associated with an ELR format, where a first subfield of the U-SIG field includes the first indication and transmit, via the U-SIG field of the PPDU, a second indication of a first STA identifier associated with the PPDU, where a second subfield of the U-SIG field includes the second indication.

Another innovative aspect of the subject matter described in this disclosure can be implemented in a wireless communication device. The wireless communication device may include means for transmitting, via a U-SIG field of a PPDU, a first indication that the PPDU is associated with an ELR format, where a first subfield of the U-SIG field includes the first indication and means for transmitting, via the U-SIG field of the PPDU, a second indication of a first STA identifier associated with the PPDU, where a second subfield of the U-SIG field includes the second indication.

Another innovative aspect of the subject matter described in this disclosure can be implemented in a non-transitory computer-readable medium storing code for wireless communication by a wireless communication device. The code may include instructions executable by a processing system to transmit, via a U-SIG field of a PPDU, a first indication that the PPDU is associated with an ELR format, where a first subfield of the U-SIG field includes the first indication and transmit, via the U-SIG field of the PPDU, a second indication of a first STA identifier associated with the PPDU, where a second subfield of the U-SIG field includes the second indication.

In some implementations of the method, wireless communication devices, and non-transitory computer-readable medium described herein, the U-SIG field excludes a puncture channel information subfield, an MCS subfield, a quantity of symbols subfield, and a spatial reuse subfield.

Some implementations of the method, wireless communication devices, and non-transitory computer-readable medium described herein may further include operations, features, means, or instructions for generating the U-SIG field of the PPDU in accordance with the PPDU being associated with the ELR format and in accordance with an intended receiver of the PPDU, where the intended receiver of the PPDU may be associated with the first STA identifier.

In some implementations of the method, wireless communication devices, and non-transitory computer-readable medium described herein, the first subfield may be an ELR subfield within a version dependent portion of the U-SIG field and the ELR subfield may be present within the U-SIG field in accordance with a codepoint indicated by a version identifier subfield within a version independent portion of the U-SIG field.

In some implementations of the method, wireless communication devices, and non-transitory computer-readable medium described herein, the second subfield may be a STA identifier subfield within a version dependent portion of the U-SIG field and the STA identifier subfield may be present within the U-SIG field in accordance with the first indication that the PPDU may be associated with the ELR format.

Another innovative aspect of the subject matter described in this disclosure can be implemented in a method for wireless communication by or at wireless communication device. The method may include transmitting, via a set of ELR symbols of a PPDU, a first ELR sequence, where the first ELR sequence corresponds to a first BSS associated with the PPDU in accordance with a mapping between a set of multiple ELR sequences and a set of multiple BSSs.

Another innovative aspect of the subject matter described in this disclosure can be implemented in a wireless communication device. The wireless communication device may include a processing system that includes processor circuitry and memory circuitry that stores code. The processing system may be configured to cause the wireless communication device to transmit, via a set of ELR symbols of a PPDU, a first ELR sequence, where the first ELR sequence corresponds to a first BSS associated with the PPDU in accordance with a mapping between a set of multiple ELR sequences and a set of multiple BSSs.

Another innovative aspect of the subject matter described in this disclosure can be implemented in a wireless communication device. The wireless communication device may include means for transmitting, via a set of ELR symbols of a PPDU, a first ELR sequence, where the first ELR sequence corresponds to a first BSS associated with the PPDU in accordance with a mapping between a set of multiple ELR sequences and a set of multiple BSSs.

Another innovative aspect of the subject matter described in this disclosure can be implemented in a non-transitory computer-readable medium storing code for wireless communication by a wireless communication device. The code may include instructions executable by a processing system to transmit, via a set of ELR symbols of a PPDU, a first ELR sequence, where the first ELR sequence corresponds to a first BSS associated with the PPDU in accordance with a mapping between a set of multiple ELR sequences and a set of multiple BSSs.

Some implementations of the method, wireless communication devices, and non-transitory computer-readable medium described herein may further include operations, features, means, or instructions for selecting the first ELR sequence from the set of multiple ELR sequences in accordance with an intended receiver of the PPDU, where the first ELR sequence corresponds to the first BSS associated with the intended receiver of the PPDU.

In some implementations of the method, wireless communication devices, and non-transitory computer-readable medium described herein, in accordance with the mapping, each BSS of the set of multiple BSSs corresponds to a respective ELR sequence of the set of multiple ELR sequences, the set of multiple BSSs including the first BSS and the set of multiple ELR sequences including the first ELR sequence.

In some implementations of the method, wireless communication devices, and non-transitory computer-readable medium described herein, each ELR sequence of the set of multiple ELR sequences corresponds to a respective BSS color value of a set of multiple BSS color values, each BSS color value corresponding to a respective BSS of the set of multiple BSSs.

Another innovative aspect of the subject matter described in this disclosure can be implemented in a method for wireless communication by or at wireless communication device. The method may include transmitting, via a preamble portion of a PPDU associated with an ELR format, an ELR-SIG field that includes an uplink/downlink indicator subfield, a length subfield, a coding indicator subfield, and an MCS subfield and transmitting, via a data portion of the PPDU associated with the ELR format, an ELR-data field in accordance with one or more of the uplink/downlink indicator subfield, the length subfield, the coding indicator subfield, and the MCS subfield included by the ELR-SIG field.

Another innovative aspect of the subject matter described in this disclosure can be implemented in a wireless communication device. The wireless communication device may include a processing system that includes processor circuitry and memory circuitry that stores code. The processing system may be configured to cause the wireless communication device to transmit, via a preamble portion of a PPDU associated with an ELR format, an ELR-SIG field that includes an uplink/downlink indicator subfield, a length subfield, a coding indicator subfield, and an MCS subfield and transmit, via a data portion of the PPDU associated with the ELR format, an ELR-data field in accordance with one or more of the uplink/downlink indicator subfield, the length subfield, the coding indicator subfield, and the MCS subfield included by the ELR-SIG field.

Another innovative aspect of the subject matter described in this disclosure can be implemented in a wireless communication device. The wireless communication device may include means for transmitting, via a preamble portion of a PPDU associated with an ELR format, an ELR-SIG field that includes an uplink/downlink indicator subfield, a length subfield, a coding indicator subfield, and an MCS subfield and means for transmitting, via a data portion of the PPDU associated with the ELR format, an ELR-data field in accordance with one or more of the uplink/downlink indicator subfield, the length subfield, the coding indicator subfield, and the MCS subfield included by the ELR-SIG field.

Another innovative aspect of the subject matter described in this disclosure can be implemented in a non-transitory computer-readable medium storing code for wireless communication by a wireless communication device. The code may include instructions executable by a processing system to transmit, via a preamble portion of a PPDU associated with an ELR format, an ELR-SIG field that includes an uplink/downlink indicator subfield, a length subfield, a coding indicator subfield, and an MCS subfield and transmit, via a data portion of the PPDU associated with the ELR format, an ELR-data field in accordance with one or more of the uplink/downlink indicator subfield, the length subfield, the coding indicator subfield, and the MCS subfield included by the ELR-SIG field.

Some implementations of the method, wireless communication devices, and non-transitory computer-readable medium described herein may further include operations, features, means, or instructions for transmitting, via the preamble portion of the PPDU associated with the ELR format, an ELR-LTF, where the ELR-SIG field may be located after the ELR-LTF.

Some implementations of the method, wireless communication devices, and non-transitory computer-readable medium described herein may further include operations, features, means, or instructions for transmitting, via the preamble portion of the PPDU associated with the ELR format, one or both of an ELR-STF or an ELR-LTF, where the ELR-SIG field may be located prior to the ELR-STF or the ELR-LTF.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a frequency diagram depicting an example distributed tone mapping.

FIG. 5 shows example universal signal (U-SIG) field designs associated with some example PPDU formats.

FIG. 6 shows example enhanced long range (ELR) PPDU formats that support signaling designs for ELR transmissions.

FIG. 7 shows an example signaling diagram that supports signaling designs for ELR transmissions.

FIG. 8 shows example U-SIG field designs that support signaling designs for ELR transmissions.

FIG. 9 shows an example sequence selection scheme that supports signaling designs for ELR transmissions.

FIG. 10 shows example ELR-SIG field designs that support signaling designs for ELR transmissions.

FIG. 11 shows an example modulation table that supports signaling designs for ELR transmissions.

FIG. 12 shows an example transmit procedure that supports signaling designs for ELR transmissions.

FIG. 13 shows an example modulation table that supports signaling designs for ELR transmissions.

FIG. 14 shows an example duplication (DUP) scheme that supports signaling designs for ELR transmissions.

FIG. 15 shows a block diagram of an example wireless communication device that supports signaling designs for ELR transmissions.

FIGS. 16-21 show flowcharts illustrating example processes performable by or at a wireless communication device that supports signaling designs for ELR transmissions.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)), or 6G standards promulgated by the 3rd Generation Partnership Project (3GPP), among others.

The described examples can be implemented in any suitable device, component, system, or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO), and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, a wireless communication device may transmit a physical layer (PHY) protocol data unit (PPDU) to an intended receiver. The PPDU may include a preamble portion and a data portion. One or more select fields of the preamble portion may indicate one or more of a format, a version, or a mode associated with the PPDU and the data portion may carry a data payload in accordance with the indicated format, version, or mode. The wireless communication device, which may be an access point (AP) or a station (STA), may generate and transmit the PPDU in accordance with one of various formats. For example, according to a capability of the wireless communication device, the wireless communication device may transmit the PPDU in accordance with an extremely high throughput (EHT) format or an ultra-high reliability (UHR) format, among other examples.

In some networks, a wireless communication device may support enhanced long range (ELR) transmissions, which may extend a coverage associated with the wireless communication device. ELR transmissions may be associated with a dedicated PPDU format to facilitate use of a relatively higher transmit power or to otherwise increase a range of the PPDU. By way of the greater communication range associated with ELR transmissions, a relatively large quantity of devices within a network may “hear” or detect an ELR PPDU, including both devices relatively near to a transmitting device and devices relatively far from the transmitting device. To avoid causing unnecessary power consumption due to PPDU parsing at “overhearing” devices that are not the intended receiver, the transmitting device may include information relatively early within a PPDU (such as within a preamble portion) to facilitate an “early drop” of the PPDU at unintended receivers. Different fields of a preamble portion of an ELR PPDU, however, may be associated with different amounts of power boosting, such that receiving devices may acquire different information depending on a proximity to the transmitting device. In such scenarios, various wireless communication devices may benefit from additional ELR signaling mechanisms to facilitate an “early drop” at various points throughout a preamble of an ELR PPDU, among other aspects related to ELR PPDU formatting and modulation.

Various aspects relate generally to signaling designs for ELR transmissions. Some aspects more specifically relate to preamble field designs and corresponding subfield interpretations associated with ELR PPDU formats. The preamble field and subfield designs may facilitate a selective parsing at one or more wireless communication devices that receive a PPDU associated with an ELR format. In some implementations, a wireless communication device may format a universal signal (U-SIG) field within a preamble portion of a PPDU to include a first indication that the PPDU is associated with an ELR format and to include a second indication of a STA identifier associated with an intended receiver of the PPDU. In some implementations, a codepoint of a PHY version identifier subfield within a version independent portion of the U-SIG field may convey the first indication. In some other implementations, a value of an ELR subfield within a version dependent portion of the U-SIG field may convey the first indication. A STA identifier subfield within the version dependent portion of the U-SIG may convey the second indication. Additionally, or alternatively, a wireless communication device may transmit an ELR sequence (such as an ELR-Mark sequence) via a set of ELR symbols within a preamble portion of an ELR PPDU and may utilize a mapping between basic service sets (BSSs) and ELR sequences to select which ELR sequence to transmit. The wireless communication device may transmit, via the set of ELR symbols, an ELR sequence that corresponds to a BSS of the wireless communication device. If a repetition of a legacy signal field (L-SIG) (RL-SIG) field is present before (such as immediately before) the ELR symbols, an ELR sequence may be modulated by quadrature binary phase-shift keying (QBPSK) (such as binary phase shift keying (BPSK) with a 90-degree rotation) to reduce a false alarm from other PPDU formats. Alternatively, if a U-SIG field is present before (such as immediately before) the ELR symbols, an ELR sequence may be modulated by BPSK, by QBPSK, or by tone alternating BPSK and QBPSK to reduce a false alarm from random quadrature amplitude modulation (QAM), a short training field (STF), or a long training field (LTF) from other PPDU formats. As used herein, a “false alarm” may be understood as a scenario in which a receiving device parses a PPDU in accordance with incorrectly determining or assuming that the received PPDU is an ELR PPDU intended for the receiving device.

Some further aspects more specifically relate to a content and a placement of an ELR-signal (ELR-SIG) field within a preamble of an ELR PPDU and one or more modulation and resource allocation schemes associated with one or both of the ELR-SIG field and an ELR-data field. In some implementations, a wireless communication device may format an ELR-SIG field to include at least an uplink/downlink indicator subfield, a length subfield, a coding indicator subfield, and a modulation and coding scheme (MCS) subfield. A wireless communication device may transmit or receive an ELR-data field in accordance with one or more of the uplink/downlink indicator subfield, the length subfield, the coding indicator subfield, and the MCS subfield. The ELR-SIG field may further include one or more additional fields and, in some implementations, a presence of at least one of such additional fields may depend on a location of the ELR-SIG field (such as if the ELR-SIG field is before or after one or more ELR training fields). Additionally, or alternatively, a wireless communication device may support one or more coding rates, one or more coded bits repetition schemes, or one or more duplication (DUP) schemes associated with the ELR-SIG field and the ELR-data field.

Particular aspects of the subject matter described in this disclosure can be implemented to realize one or more of the following potential advantages. In some implementations, by including, within a U-SIG field of a PPDU, a first indication that the PPDU is associated with an ELR format and a second indication of a STA identifier associated with an intended receiver of the PPDU, the described techniques can be used to enable one or more unintended receiving devices to perform an “early drop” of the PPDU. For example, a non-ELR-capable receiving device may terminate a parsing procedure upon receiving the first indication and an ELR-capable but unintended receiving device may terminate a parsing procedure upon receiving the second indication (because the ELR-capable device may continue parsing past the first indication in accordance with having a matching capability). Further, by transmitting an ELR sequence (such as an ELR-Mark sequence) via a set of ELR symbols that corresponds to a specific BSS, a receiving device may selectively parse a remainder of the PPDU after the set of ELR symbols in accordance with whether the receiving device has a matching BSS. For example, if the receiving device does not have a matching BSS with the BSS conveyed by the ELR sequence, the receiving device may select, determine, identify, or ascertain that the PPDU is likely intended for a different device and terminate a parsing procedure accordingly. In accordance with facilitating such an “early drop” at one or more unintended receiving devices, the unintended receiving devices may save power (which may increase battery life) or use now-available processing or RF circuitry for one or more other tasks (which may increase processing speed and enhance a user experience), or both.

Additionally, or alternatively, by including an uplink/downlink indicator subfield, a length subfield, a coding indicator subfield, and an MCS subfield within an ELR-SIG field of an ELR PPDU preamble, a transmitting device may provide greater signal quality and extended range by way of providing relevant information, via the ELR-SIG field, that a receiving device may use to receive, parse, or interpret an ELR-data field. For example, in accordance with one or more of the uplink/downlink indicator subfield, the length subfield, the coding indicator subfield, and the MCS subfield provided by the ELR-SIG field, the receiving device may obtain an accurate determination (such as an accurate selection or identification) of various characteristics associated with the ELR PPDU (including the ELR-data field) and may have a relatively greater likelihood of successfully decoding the ELR PPDU. Moreover, by utilizing one or more of the disclosed coding rates, coded bits repetition schemes, or DUP schemes for one or both of the ELR-SIG field or the ELR-data field, wireless communication devices may similarly achieve greater signal quality and extended range by efficiently achieving a target data rate with a target reliability. In accordance with achieving such greater signal quality and extended range, the described techniques can be further implemented to realize relatively higher data rates, greater spectral efficiency, and greater system capacity, among other benefits.

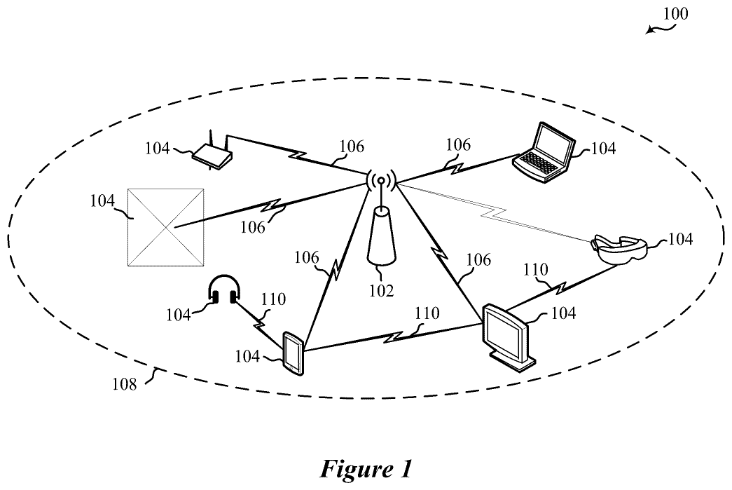

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.1lay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. In some implementations, the BSSID may be referred to as a BSS color, and information associated with the BSS or BSSID may be referred to as BSS color information. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHZ, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the PHY and MAC layers. The AP 102 and STAs 104 transmit and receive wireless communications (hereinafter also referred to as “Wi-Fi communications” or “wireless packets”) to and from one another in the form of PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHz-52.6 GHZ), FR3 (7.125 GHz-24.25 GHZ), FR4a or FR4-1 (52.6 GHZ-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHZ bands, each of which is divided into multiple 20 MHz channels. As such, these PPDUs are transmitted over a physical channel having a minimum bandwidth of 20 MHZ, but larger channels can be formed through channel bonding. For example, PPDUs may be transmitted over physical channels having bandwidths of 40 MHZ, 80 MHZ, 160 MHz, 240 MHz, 320 MHZ, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting UHR communications or communication according to the IEEE 802.11bn standard amendment can be configured to operate, monitor, contend and communicate using multiple primary 20 MHZ channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some implementations, an AP 102 or a STA 104 may support one or more signaling- or configuration-based mechanisms according to which the AP 102 (such as an AP STA) or the STA 104 (such as a non-AP STA) may transmit or receive one or more PPDUs associated with an ELR format. An AP 102 or a STA 104 may perform an ELR transmission to increase a coverage range of the AP 102 or the STA 104. For example, the AP 102 or the STA 104 may power boost one or more portions (such as one or more fields) of a PPDU associated with an ELR format to facilitate relatively longer range communication. Additionally, or alternatively, the AP 102 or the STA 104 may modulate or leverage a resource allocation scheme to facilitate the relatively longer range communication.

In some implementations, the AP 102 or the STA 104 may support one or more signaling designs or field/subfield interpretations, or both, to enable or facilitate a selective parsing at one or more receiving devices. For example, in association with transmitting a PPDU in a manner that facilitates longer range communication, relatively more devices may receive or detect the PPDU. To avoid causing unnecessary power consumption (due to, for example, parsing operations) across such a relatively larger quantity of potential receiving devices, wireless communication devices (such as one or more APs 102 or one or more STAs 104, or any combination thereof) within the wireless communication network 100 may employ signaling designs or field/subfield interpretations, or both, to facilitate mechanisms according to which a receiving device may stop (such as cease, suspend, pause, terminate, or cancel) parsing a received PPDU at a relatively early stage if the PPDU is not intended for that receiving device. Further, in accordance with some example implementations, two or more wireless communication devices may exchange (such as transmit or receive) one or more of capability signaling, configuration signaling, or activation/deactivation signaling associated with one or more of the example signaling designs, formats, or field/subfield interpretations disclosed herein.

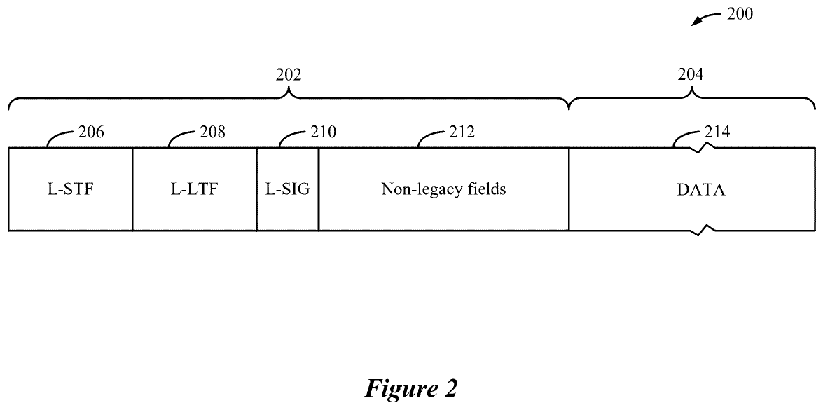

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and an L-SIG 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a BPSK modulation scheme. The payload 204 may be modulated according to a BPSK modulation scheme, a QBPSK modulation scheme, a QAM modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some implementations, the one or more non-legacy fields 212 may include a U-SIG field, an ELR field (such as an ELR-mark field) including one or more ELR symbols (such as one or more ELR-mark symbols), an ELR-STF (which may sometimes be referred to as an ELR-STF field), an ELR-LTF (which may sometimes be referred to as an ELR-LTF field), and an ELR-SIG field. In such implementations, the data field 214 may be an example of an ELR-data field. A transmitting wireless communication device, such as an AP 102 or a STA 104, may generate the PDU 200 to include the U-SIG field, the ELR field, the ELR-STF field, the ELR-LTF field, and the ELR-SIG field in association with formatting the PDU 200 in accordance with an ELR format, such as an ELR PPDU format.

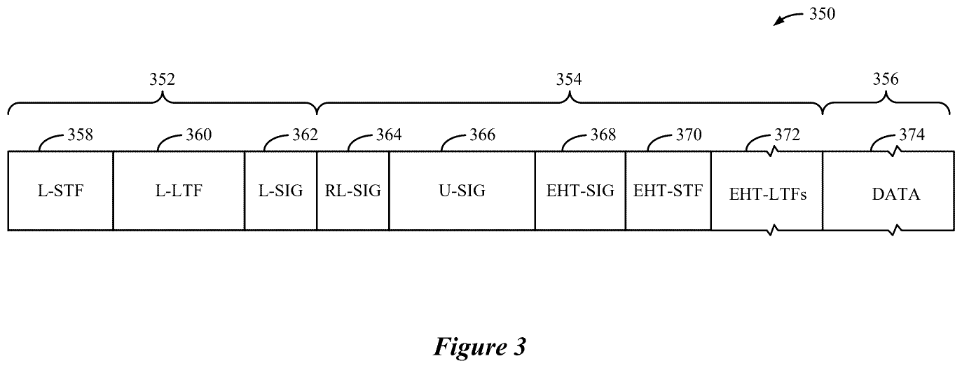

FIG. 3 shows an example PPDU 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes an RL-SIG 364 and multiple wireless communication protocol version-dependent signal fields after RL-SIG 364. For example, the non-legacy portion 354 may include a U-SIG field (referred to herein as “U-SIG 366”) and an EHT signal field (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field (referred to herein as “EHT-STF 370,” although it may be structured as, and carry version-dependent information for, other wireless communication protocol versions beyond EHT) and one or more additional long training fields (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink or downlink resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For uplink MU transmissions, an AP 102 can transmit a trigger frame to initiate and synchronize an uplink OFDMA or uplink MU-MIMO transmission from multiple STAs 104 to the AP 102. Such trigger frames may thus enable multiple STAs 104 to send uplink traffic to the AP 102 concurrently in time. A trigger frame may address one or more STAs 104 through respective association identifiers (AIDs), and may assign each AID (and thus each STA 104) one or more RUs that can be used to send uplink traffic to the AP 102. The AP also may designate one or more random access (RA) RUs that unscheduled STAs 104 may contend for.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHZ). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHZ, 80 MHz or more. The use of dRUs may be limited to uplink communications because benefits to addressing PSD limits may only be present for uplink communications.

In some implementations, a wireless communication device (such as an AP 102 or a STA 104) may use the PPDU 350 in accordance with employing an EHT format, such as an EHT PPDU format, and may use a different PPDU in accordance with employing other formats, such as a UHR PPDU format or an ELR PPDU format. In some implementations, the wireless communication device may indicate a format of a PPDU via a PHY version identifier subfield of a U-SIG field, such as the U-SIG 366. For example, in some implementations, a first codepoint (such as a “0” value as denoted by, for example, “000” codepoint) of the PHY version identifier subfield may indicate that the PPDU 350 is associated with the EHT format. A second codepoint (such as a “1” value as denoted by, for example, a “001” codepoint) of the PHY version identifier subfield may indicate that a PPDU is associated with a UHR format. In some implementations, the second codepoint may indicate that the PPDU is associated with a UHR format or an ELR format. Alternatively, a third codepoint (such as a “2” value as denoted by, for example, a “010” codepoint, or such as a “7” value as denoted by, for example, a “111” codepoint) of the PHY version identifier subfield may indicate that the PPDU is associated with an ELR format.

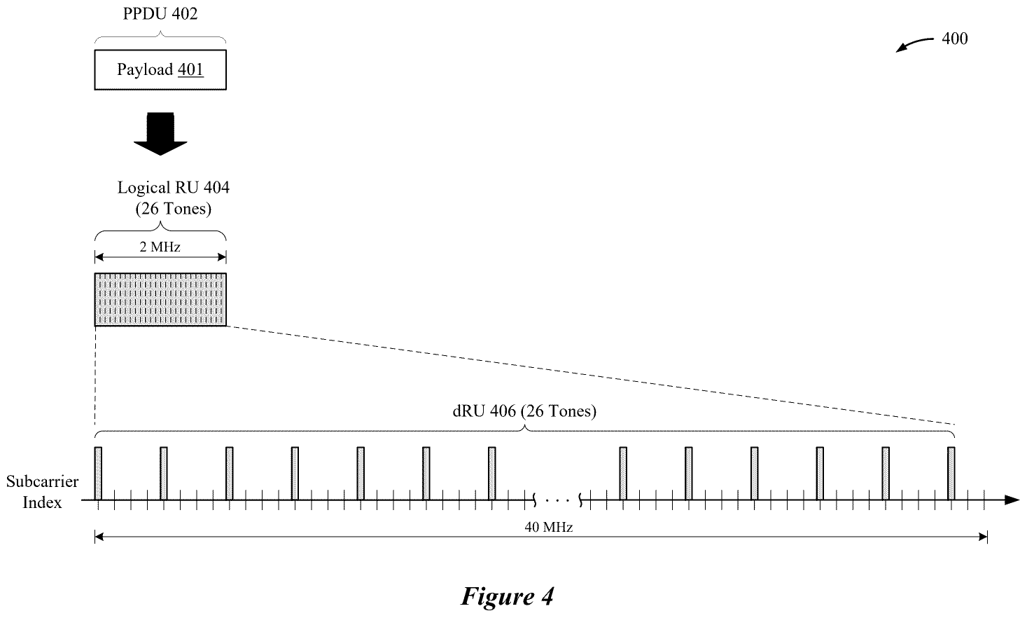

FIG. 4 shows a frequency diagram 400 depicting an example distributed tone mapping. More specifically, FIG. 4 shows an example mapping of how the tones of a payload 401 of a PPDU 402 are distributed for transmission over a spreading bandwidth of a wireless channel. In the illustrated example, the tones in a logical RU 404 (which may represent an rRU of non-distributed tones in accordance with a legacy tone plan) associated with payload 401 are mapped to a distributed RU (dRU) 406 in accordance with a distributed tone plan.

Aspects of the present disclosure recognize that by distributing the tones across a wider bandwidth, the per-tone transmit power of a logical RU 404 may be increased to provide greater flexibility in medium utilization for PSD-limited wireless channels. For example, when mapped to an rRU such as logical RU 404, the transmit power of the logical RU 404 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 404 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 402, without exceeding the PSD limits of the wireless channel. As shown in the example of FIG. 4, the STA 104 may map logical RU 404 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 4 effectively reduces the number of tones (of the logical RU 404) in each 1 MHZ subchannel. For example, each of the 26 tones can be mapped to a different 1 MHz subchannel of the 40 MHz channel. As a result, each AP 102 or STA 104 implementing the distributed tone mapping of FIG. 4 can maximize its per-tone transmit power (which may maximize the overall transmit power of the logical RU 404).

In some examples (not shown in FIG. 4), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 402 is transmitted on tones spanning an rRU, such as a logical RU 404 (according to a legacy tone plan), or a dRU 406 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 404 to the dRU 406 in the frequency domain. The dRU 406 is converted to a time-domain signal (such as by an inverse fast Fourier transform (IFFT)) for transmission over a wireless channel. The AP 102 may receive the time-domain signal and reconstruct the dRU 406 (such as by a fast Fourier transform (FFT)). In some implementations, the AP 102 may include a distributed tone demapper that demaps the dRU 406 to the logical RU 404. In other words, the distributed tone demapper reverses the mapping performed by the distributed tone mapper at the STA 104. The AP 102 can recover the information carried (or modulated) on the logical RU 404 as a result of the demapping.

In the example of FIG. 4, the logical RU 404 is distributed evenly across the spreading bandwidth. While the example shown in FIG. 4 illustrates a spreading bandwidth of 40 MHz, spreading bandwidths also may include 80 MHz, 160 MHz, or 320 MHz. In some implementations, the logical RU 404 can be mapped to any suitable pattern of noncontiguous subcarrier indices. For example, in various implementations, the distance between any pair of adjacent modulated tones may be less than or greater than the distances depicted in FIG. 4.

In some implementations, a wireless communication device (such as an AP 102 or a STA 104) may use one or more RUs (such as a contiguous RU) or one or more dRUs 406 for one or more fields or portions (such as an ELR-SIG field or an ELR-data field, or both) of a PPDU associated with an ELR format. For example, the wireless communication device may use one or more RUs to transmit one or more fields or portions of the PPDU in association with applying a frequency domain DUP to the one or more fields or portions of the PPDU. Alternatively, the wireless communication may use one or more dRUs 406 to transmit one or more fields or portions of the PPDU in association with an absence of frequency domain DUP or to otherwise enable usage of a relatively higher transmit power associated with the one or more fields or portions of the PPDU.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some examples, an AI/ML model may be used for spatial reuse (SR) techniques and determinations. For example, a wireless communication device may exchange signaling to ascertain inputs to an AI/ML model and utilize an output of the AI/ML model to perform wireless communications in accordance with a SR procedure to improve the effectiveness of the SR procedure. For example, by using an AI/ML model (and in some aspects, shared observations and measurements from other devices as inputs to the AI/ML model), a transmitting device may more effectively generate SR parameters supporting SR transmissions, resulting in more effective use of available system resources, improved throughput, improved reliability, decreased latency, and better user experience. For example, a STA, an AP, or both, may use an AI/ML model to obtain one or more SR parameters, such as an overlapping basic service set (OBSS) preamble detection (PD) value, or a threshold of detected interference below which the device may transmit at a lower transmit power.

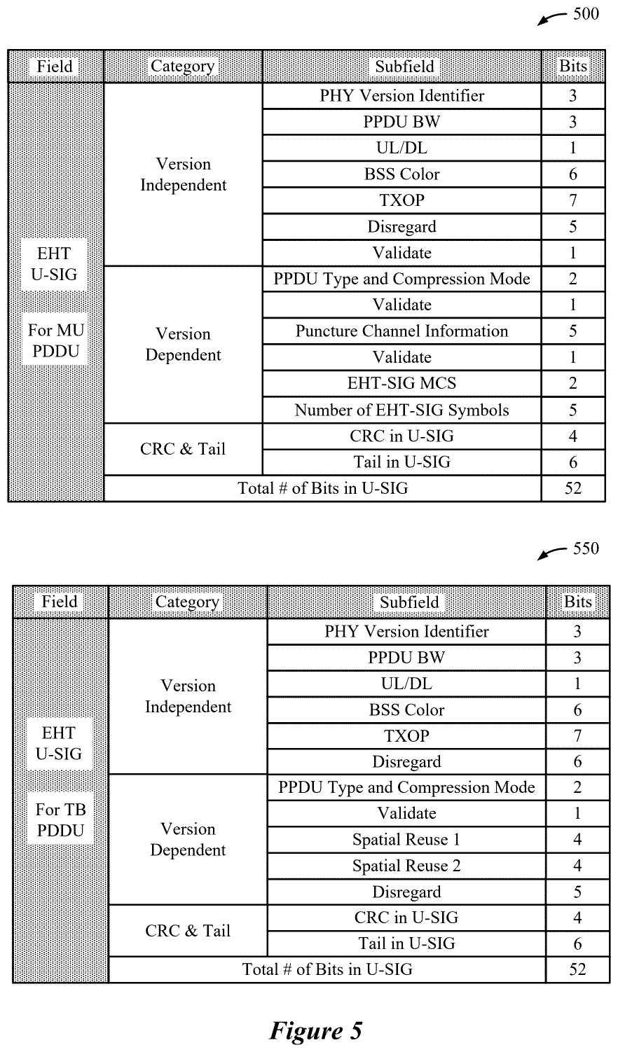

FIG. 5 shows example U-SIG field designs 500 and 550 associated with some example PPDU formats. For example, the U-SIG field designs 500 and 550 may be associated with an EHT PPDU format and a wireless communication device (such as a STA 104 or an AP 102) may include a U-SIG field associated with the U-SIG field design 500 or the U-SIG field design 550 within an EHT PPDU. A wireless communication device may generate and include a U-SIG field associated with the U-SIG field design 500 for an MU PPDU. A wireless communication device may generate and include a U-SIG field associated with the U-SIG field design 550 for a TB PPDU.

The U-SIG field designs 500 and 550 may be associated with (such as include) a version independent portion and a version dependent portion. The version independent portion may include one or more version independent fields (such as fields that are included within a U-SIG field regardless of the version or format of the U-SIG field or of the PPDU carrying the U-SIG field) and the version dependent portion may include one or more version dependent fields (such as fields that are conditionally, selectively, or optionally included within a U-SIG field depending on the version or format of the U-SIG field or of the PPDU carrying the U-SIG field).

For example, the version independent portion of the U-SIG field designs 500 and 550 may include a PHY version identifier subfield of 3 bits, a PPDU bandwidth (BW) subfield of 3 bits, an uplink/downlink indicator subfield (which may be equivalently referred to herein as an “UL/DL subfield”) of 1 bit, a BSS color subfield of 6 bits, a transmission opportunity (TXOP) subfield of 7 bits, a disregard subfield of 5 bits, and a validate subfield of 1 bit. Additionally, both the U-SIG field designs 500 and 550 may be associated with (such as include) a cyclic redundancy check (CRC) and tail portion, which may include a CRC subfield of 4 bits and a tail subfield of 6 bits in both the U-SIG field designs 500 and 550. Further, both the U-SIG field designs 500 and 550 may be associated with (such as include or occupy) 52 bits in total.

The version dependent portion of the U-SIG field design 500 (associated with the MU PPDU format) may include a PPDU type and compression mode subfield of 2 bits, a validate subfield of 1 bit, a puncture channel information subfield of 5 bits, a validate subfield of 1 bit, an EHT-SIG MCS subfield of 2 bits, and a number of EHT-SIG symbols subfield of 2 bits. The version dependent portion of the U-SIG field design 550 (associated with the TB PPDU format) may include a PPDU type and compression mode subfield of 2 bits, a validate subfield of 1 bit, a first spatial reuse subfield of 4 bits, a second spatial reuse subfield of 4 bits, and a disregard subfield of 5 bits.

In some implementations, one or more wireless communication devices may support one or more updated U-SIG field designs associated with (such as to support) additional versions or formats of the U-SIG field or of the PPDU carrying the U-SIG field. For example, one or more wireless communication devices may support one or more U-SIG field designs associated with ELR communication, such as U-SIG field designs associated with PPDUs that are associated with an ELR format (such as ELR PPDU formats). One or more wireless communication devices may support one or more additional or replacing subfields or one or more additional or replacing subfield interpretations, or both. Further, in some implementations, a transmitting device and a receiving device may leverage (such as use or employ) such one or more additional or replacing subfields or one or more additional or replacing subfield interpretations, or both, to enable a selective (such as conditional) parsing of the PPDU at the receiving device. Such a selective parsing may include a continuation of a parsing of the PPDU or a dropping of the PPDU (which may be referred to herein as an “early drop” of the PPDU). Additionally, or alternatively, the U-SIG of an ELR PPDU may follow a similar format or structure as an EHT or UHR MU PPDU. For example, an ELR PPDU may include a U-SIG field formatted in accordance with one of the U-SIG field design 500 or the U-SIG field design 550.

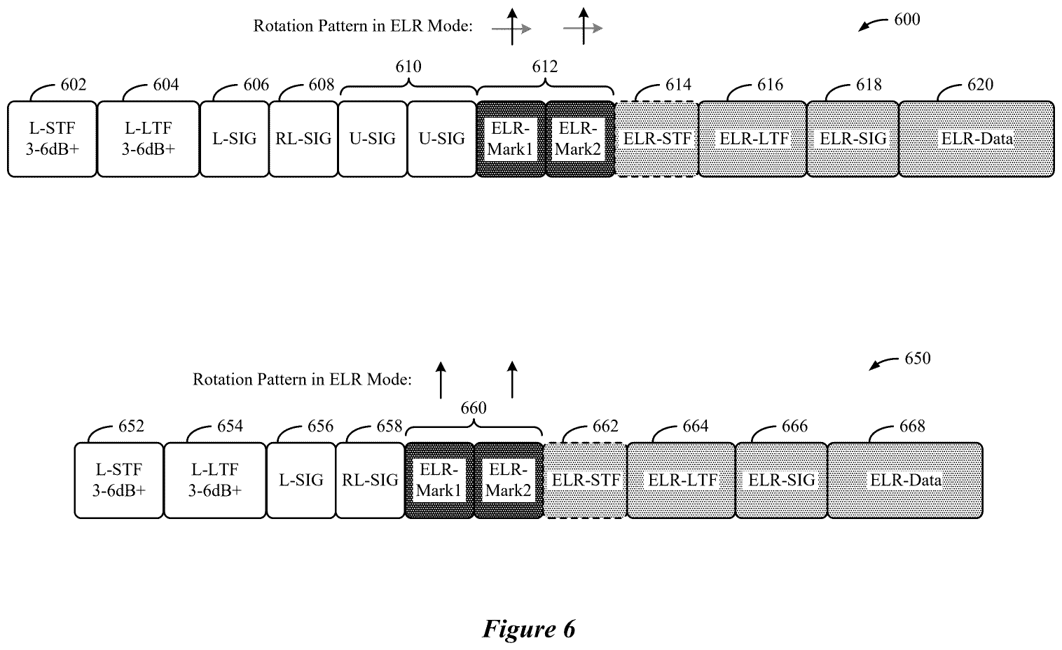

FIG. 6 shows example ELR PPDU formats 600 and 650 that support signaling designs for ELR transmissions. The ELR PPDU formats 600 and 650 may be example PPDU formats that support or are otherwise associated with ELR communication. For example, a wireless communication device participating in ELR communication may generate and transmit, or receive and parse, a PPDU in accordance with the ELR PPDU format 600 or the ELR PPDU format 650. The ELR PPDU format 600 may be associated with a placement of an ELR-mark after a U-SIG field. The ELR PPDU format 650 may be associated with a placement of an ELR-mark after an RL-SIG field in the absence of a U-SIG field.

In accordance with the ELR PPDU format 600, a PPDU may include an L-STF 602 (which may be power boosted by approximately 3-6 decibels (dB)), an L-LTF 604 (which may be power boosted by approximately 3-6 dB), an L-SIG field 606, an RL-SIG field 608, a U-SIG field 610 (which may include multiple symbols, such as two symbols), an ELR field 612 (such as an ELR-mark field) including a set of ELR symbols (such as ELR-mark symbols), an ELR-STF field 614 (which may be absent in some implementations), an ELR-LTF field 616, an ELR-SIG field 618, and an ELR-data field 620. The ELR-STF field 614 may include one or multiple ELR-STF symbols. The ELR-LTF field 616 may include one or multiple ELR-LTF symbols. In some implementations, the placement of the ELR field 612 (including the set of ELR symbols) after the U-SIG field may enable a relatively greater quantity of non-ELR-capable devices to detect the PPDU, as a baseline mode detection may already be performed by the time a receiving device reaches the ELR-mark. In some implementations, a transmitting wireless communication device may modulate the set of ELR symbols of the ELR field 612 with BPSK or hybrid BPSK and QBPSK (such as BPSK with a 90-degree rotation) on (or otherwise via) alternating data tones to reduce false alarms from random QAM, STF, or LTF. As used herein, a “false alarm” may be understood as a scenario in which a receiving device parses a PPDU in accordance with incorrectly determining that the received PPDU is an ELR PPDU. In accordance with the ELR PPDU format 600, the set of ELR symbols of the ELR field 612 may be associated with a first rotation pattern in ELR mode.

In accordance with the ELR PPDU format 650, a PPDU may include an L-STF 652 (which may be power boosted by approximately 3-6 dB), an L-LTF 654 (which may be power boosted by approximately 3-6 dB), an L-SIG field 656, an RL-SIG field 658, an ELR field 660 (such as an ELR-mark field) including a set of ELR symbols (such as a set of ELR-mark symbols), an ELR-STF field 662 (which may be absent in some implementations), an ELR-LTF field 664, an ELR-SIG field 666, and an ELR-data field 668. The ELR-STF field 662 may include one or multiple ELR-STF symbols. The ELR-LTF field 664 may include one or multiple ELR-LTF symbols. In some implementations, the placement of the ELR field 660 (including the set of ELR symbols) after the RL-SIG field 658 may enable or facilitate an early mode classification, as a receiving device may identify, select, determine, or otherwise ascertain that a received PPDU is associated with an ELR format upon receiving (and attempting to parse) the set of ELR symbols of the ELR field 660. In some implementations, a transmitting wireless communication device may modulate the set of ELR symbols of the ELR field 660 with QBPSK (such as BPSK with a 90-degree rotation) to reduce false alarms. In accordance with the ELR PPDU format 650, the set of ELR symbols of the ELR field 660 may be associated with a second rotation pattern in ELR mode.

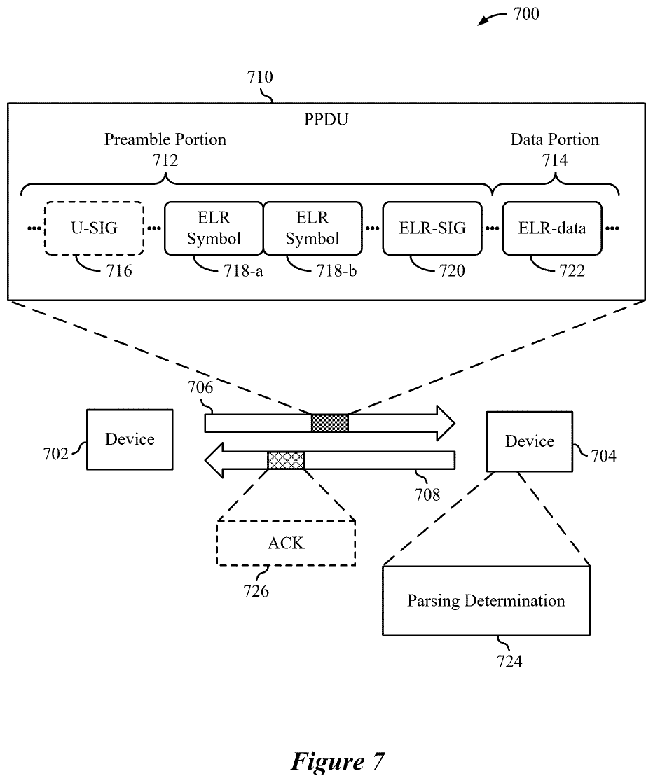

FIG. 7 shows an example signaling diagram 700 that supports signaling designs for ELR transmissions. The signaling diagram 700 illustrates communication between a wireless communication device 702 and a wireless communication device 704 via a communication link 706 and a communication link 708. The wireless communication device 702 may be an example of a STA 104 or an AP 102, such as a STA 104 or an AP 102 as illustrated by and described with reference to FIG. 1. The wireless communication device 704 may be an example of a STA 104 or an AP 102, such as a STA 104 or an AP 102 as illustrated by and described with reference to FIG. 1. Generally, the wireless communication device 702 may be understood or function as a transmitting device and the wireless communication device 704 may be understood or function as a receiving device.

For example, the wireless communication device 702 may transmit, via the communication link 706, a PPDU 710, and the wireless communication device 704 may receive, via the communication link 706, the PPDU 710. In some implementations, the PPDU 710 may be associated with an ELR format, such as the ELR PPDU format 600 or the ELR PPDU format 650 as illustrated by and described with reference to FIG. 6. If the PPDU 710 is associated with the ELR PPDU format 600, a preamble portion 712 of the PPDU 710 may include a U-SIG field 716, an ELR field (such as an ELR-mark field) including an ELR symbol 718-a and an ELR symbol 718-b, and an ELR-SIG field 720, among other fields (as illustrated by and described with reference to FIG. 6). If the PPDU 710 is associated with the ELR PPDU format 650, the preamble portion 712 of the PPDU 710 may exclude (such as be absent of) the U-SIG field 716. A data portion 714 of the PPDU 710 may include an ELR-data field 722, among potentially other data fields.

In some implementations, the wireless communication device 704 may receive and parse at least a portion of the PPDU 710 and, in accordance with parsing the portion of the PPDU 710, may perform a parsing determination 724. In accordance with the parsing determination 724, the wireless communication device 704 may select, determine, calculate, identify, or otherwise ascertain whether to continue parsing the PPDU 710 or to drop (and not parse) a remainder of the PPDU 710. Thus, the parsing determination 724 performed by the wireless communication device 704 may be equivalently referred to as a parsing decision, a parsing selection, a parsing calculation, or a parsing identification, among other examples. If the wireless communication device 704 drops a remainder of the PPDU 710 in accordance with the parsing determination 724, the wireless communication device 704 may be understood as performing an “early drop” of the PPDU 710, which may save power and processing resources at the wireless communication device 704.

The wireless communication device 704 may drop a remainder of the PPDU 710 in association with selecting, determining, identifying, calculating, or otherwise ascertaining that the wireless communication device 704 is not an intended receiver of the PPDU 710 or that the wireless communication device 704 is a non-ELR-capable device (and therefore not capable of parsing the PPDU 710 if the PPDU 710 is associated with an ELR format). Alternatively, the wireless communication device 704 may continue parsing (at least a portion of) the PPDU 710 in association with selecting, determining, identifying, calculating, or otherwise ascertaining that the wireless communication device 704 is an intended receiver of the PPDU 710 and that the wireless communication device 704 is an ELR-capable device (and therefore is capable of parsing the PPDU 710 if the PPDU 710 is associated with an ELR format). If the wireless communication device 704 is the intended receiver and successfully parses the PPDU 710, the wireless communication device 704 may transmit, to the wireless communication device 702 via the communication link 708, an acknowledgment (ACK) 726. The ACK 726 may be a block ACK (BA) frame, among other example feedback frames.

The wireless communication device 702 and the wireless communication device 704 may use any one or more of the U-SIG field 716, the ELR symbol 718-a and the ELR symbol 718-b, and the ELR-SIG field 720 to facilitate or enable the parsing determination 724 at the wireless communication device 704. In some implementations, for example, the wireless communication device 702 and the wireless communication device 704 may use one or more subfields or subfield interpretations of the U-SIG field 716 to facilitate or enable the parsing determination 724 at the wireless communication device 704. In some such implementations, the wireless communication device 702 may include a first indication in the U-SIG field 716 indicating whether the PPDU 710 is associated with an ELR format and may include a second indication in the U-SIG field 716 indicating a STA identifier associated with the PPDU 710 (such as a STA identifier associated with an intended receiver of the PPDU 710).

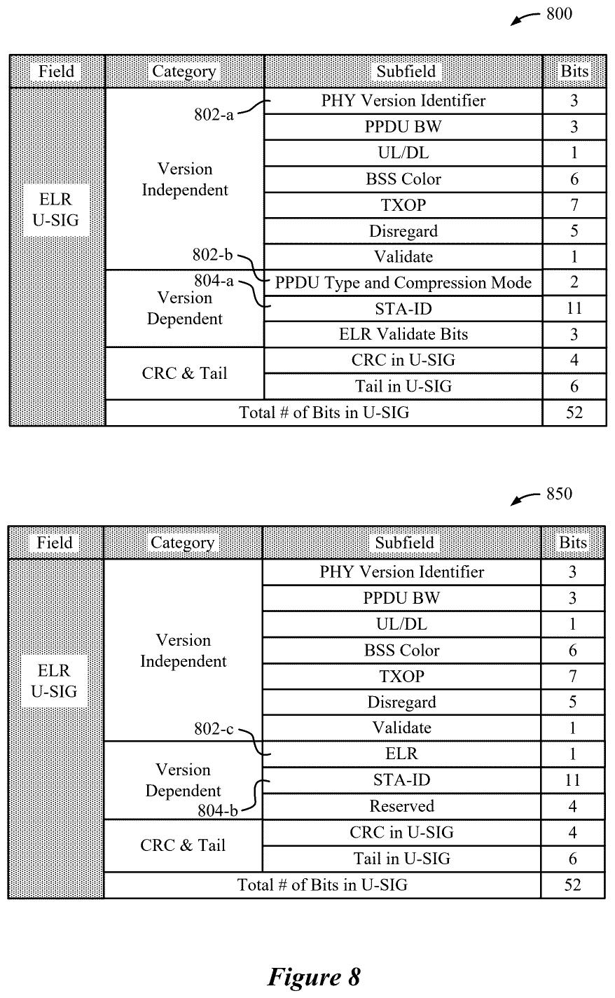

In some implementations, the wireless communication device 702 may include the second indication in the U-SIG field 716 in accordance with the PPDU 710 being associated with an ELR format. Otherwise (such as if the PPDU 710 is associated with, for example, an EHT format), the U-SIG field 716 may exclude the second indication. The wireless communication device 704 may receive and parse the U-SIG field 716 and selectively parse a remainder of the PPDU 710 that follows the U-SIG field 716 in accordance with at least the first indication. If the wireless communication device 704 is capable of parsing the PPDU 710 in accordance with the first indication (such as if the wireless communication device 704 is an ELR-capable device), the wireless communication device 704 may selectively parse the remainder of the PPDU 710 that follows the U-SIG field 716 in accordance with the second indication. For example, the wireless communication device 704 may use the second indication to determine, select, identify, or ascertain whether the wireless communication device 704 is an intended receiver of the PPDU 710 if (such as only if) the wireless communication device 704 is capable of parsing an ELR PPDU. Additional details relating to such first and second indications via the U-SIG field 716 are illustrated by and described herein with reference to FIG. 8.

Additionally, or alternatively, the wireless communication device 702 and the wireless communication device 704 may use the ELR symbol 718-a and the ELR symbol 718-b (or, generally, a set of ELR-mark symbols) to facilitate or enable the parsing determination 724 at the wireless communication device 704. For example, the wireless communication device 702 and the wireless communication device 704 may communicate (such as transmit or receive) a sequence (which may be referred to herein as an ELR sequence or an ELR-mark sequence) via the ELR symbol 718-a and the ELR symbol 718-b and, in some implementations, may use the sequence to convey information. For example, the ELR symbol 718-a and the ELR symbol 718-b may support ELR mode classification. Such information may be known at both the wireless communication device 702 and the wireless communication device 704 to facilitate an early drop, such as information indicative of a BSS (such as BSS color information) associated with the PPDU 710.

For example, the wireless communication device 702 and the wireless communication device 704 may support and leverage a mapping between BSSs and ELR sequences. In accordance with the mapping, each BSS may correspond to a respective ELR sequence. Accordingly, the wireless communication device 702 may select an ELR sequence that corresponds (in accordance with the mapping) to a BSS associated with the wireless communication device 702 and may transmit the selected ELR sequence via the ELR symbol 718-a and the ELR symbol 718-b. The wireless communication device 704 may receive the selected ELR sequence via the ELR symbol 718-a and the ELR symbol 718-b and may perform a correlation between the received ELR sequence and an ELR sequence that corresponds (in accordance with the mapping) to a BSS associated with the wireless communication device 704.

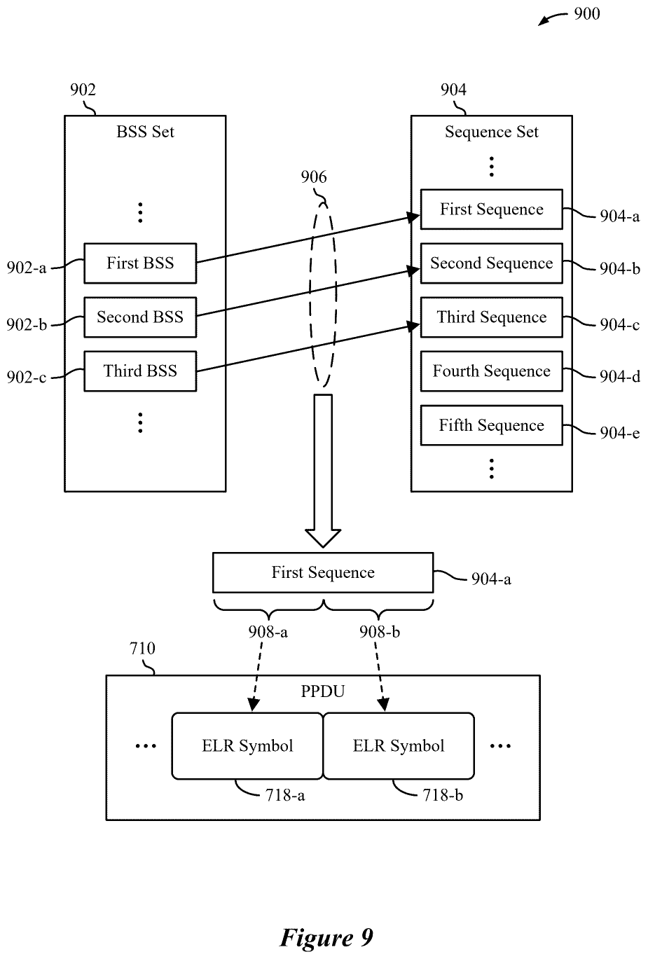

If the correlation satisfies a threshold correlation level, the wireless communication device 704 may measure, determine, identify, select, or ascertain that the two ELR sequences are the same and, accordingly, that a transmitter of the PPDU 710 (such as the wireless communication device 702) is within a same BSS as the wireless communication device 704. In such implementations, the wireless communication device 704 may continue parsing at least a portion of the PPDU 710. Alternatively, if the correlation fails to satisfy a threshold correlation level, the wireless communication device 704 may measure, determine, identify, select, or ascertain that the two ELR-mark sequences are different and, accordingly, that a transmitter of the PPDU 710 (the wireless communication device 702) is within a different BSS as compared to the wireless communication device 704. In such implementations, the wireless communication device 704 may drop the remainder of the PPDU 710. Additional details relating to such ELR sequences sent via the ELR symbol 718-a and the ELR symbol 718-b are illustrated by and described herein with reference to FIG. 9.

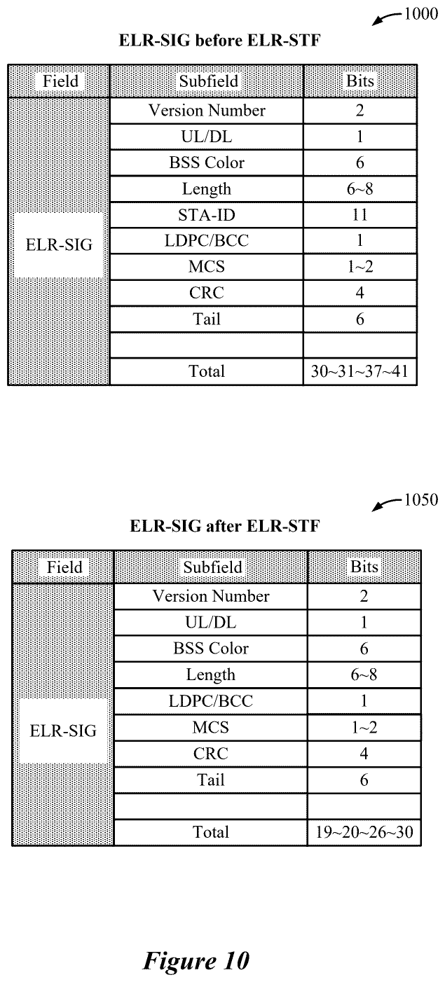

Additionally, or alternatively, the wireless communication device 702 and the wireless communication device 704 may use one or more subfields or subfield interpretations of the ELR-SIG field 720 to facilitate or enable the parsing determination 724 at the wireless communication device 704. For example, the wireless communication device 702 may include, within the ELR-SIG field 720, one or both of a BSS color subfield or a STA identifier subfield. The BSS color subfield may indicate a BSS color value that corresponds to a BSS of the wireless communication device 702. The STA identifier subfield may indicate an intended receiver of the PPDU 710. The wireless communication device 704 may select, identify, determine, or otherwise ascertain whether the wireless communication device 704 is the intended receiver in accordance with one or both of the BSS color subfield or the STA identifier and may selectively parse a remainder of the PPDU 710 that follows the ELR-SIG field 720 accordingly. Additional details relating to such indications sent via the ELR-SIG field 720 are illustrated by and described herein with reference to FIG. 10.

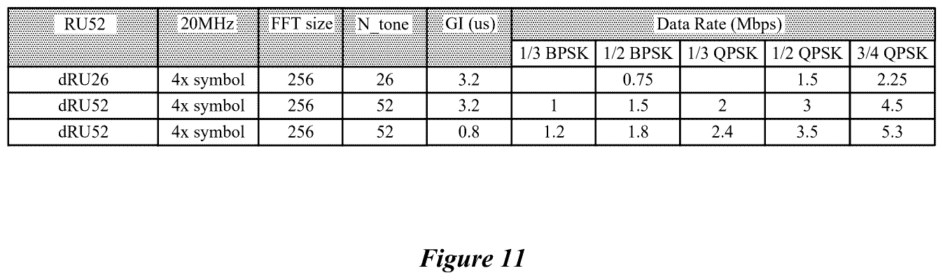

Additionally, or alternatively, the wireless communication device 702 and the wireless communication device 704 may support one or more (mutually understood) modulation techniques associated with the ELR-SIG field 720 and the ELR-data field 722. In some implementations, the wireless communication device 702 and the wireless communication device 704 may employ the modulation techniques to achieve a target data rate, such as a target megabits per second (Mbps). For example, the wireless communication device 702 and the wireless communication device 704 may (de) modulate the ELR-SIG field 720 and the ELR-data field 722 in accordance with one or more modulation techniques that support, enable, facilitate, or generate a 1 Mbps data rate. In some implementations, the wireless communication device 702 and the wireless communication device 704 may employ one or both of coded-bits repetition or frequency domain DUP for one or both of the ELR-SIG field 720 and the ELR-data field 722. Additional details relating to such modulation techniques associated with the ELR-SIG field 720 and the ELR-data field 722 are illustrated by and described herein with reference to FIGS. 11-14.

FIG. 8 shows example U-SIG field designs 800 and 850 that support signaling designs for ELR transmissions. In some implementations, the wireless communication device 702 and the wireless communication device 704 may use the U-SIG field design 800 or the U-SIG field design 850 for the U-SIG field 716 to enable or facilitate a selective parsing of the remainder of the PPDU 710 at the wireless communication device 704. For example, the wireless communication device 702 may transmit, via the U-SIG field 716, a first indication (such as a first indication 802-a, a first indication 802-b, or a first indication 802-c) of whether the PPDU 710 is associated with an ELR format and a second indication (such as a second indication 804-a or a second indication 804-b) of a STA identifier associated with the PPDU 710. The wireless communication device 704 may use at least some of such U-SIG content to defer or drop power from the PPDU 710 (such as an ELR packet).

In some implementations, the wireless communication device 704 may use the first indication to receive information indicative of whether the PPDU 710 is associated with an ELR format and may compare such received information with a capability associated with the wireless communication device 704 (if the wireless communication device 704 receives the PPDU 710 above a PD threshold and can detect the U-SIG field 716). For example, if the wireless communication device 704 is an EHT- or UHR-capable device (but a non-ELR-capable device), the wireless communication device 704 may stop parsing the PPDU 710 after the U-SIG field 716 if the first indication informs the wireless communication device 704 that the PPDU 710 is associated with an ELR format. Generally, the wireless communication device 704 may use at least a PHY version identifier subfield, an uplink/downlink indicator subfield (or bit), a BSS color subfield, a TXOP subfield, or a combination thereof to select, identify, determine, or otherwise ascertain whether to continue parsing the PPDU 710.

Alternatively, if the wireless communication device 704 is an ELR-capable device, the wireless communication device 704 may continue parsing at least another one or more subfields of the U-SIG field 716 (if not an entirety of the remainder of the PPDU 710) if the first indication informs the wireless communication device 704 that the PPDU 710 is associated with an ELR format. The wireless communication device 704 may additionally use the second indication to select, identify, determine, or otherwise ascertain whether the wireless communication device 704 is the intended receiver of the PPDU 710. For example, the wireless communication device 704 (as an ELR-capable device) may use at least a PHY version identifier subfield, an uplink/downlink indicator subfield (or bit), a BSS color subfield, a TXOP subfield, the second indication, or a combination thereof to select, identify, determine, or otherwise ascertain whether to continue parsing the PPDU 710.

In some implementations, and as illustrated in the example of the U-SIG field design 800, a PHY version identifier subfield of the U-SIG field 716 may include the first indication 802-a. In some such implementations, the wireless communication device 702 and the wireless communication device 704 may use different PHY version identifier numbers for UHR and ELR. For example, a PHY version identifier subfield that includes a codepoint indicative of a first value (such as a “1” value) may indicate that the PPDU 710 is associated with a UHR format and a PHY version identifier subfield that includes a codepoint indicative of a second value (such as a “2” or a “7” value) may indicate that the PPDU 710 is associated with an ELR format.

In some other implementations, and as illustrated in the example of the U-SIG field design 800, a PPDU type and compression mode subfield (such as described with reference to FIG. 5) may include the first indication 802-b. In some such implementations, the wireless communication device 702 and the wireless communication device 704 may use a same PHY version identifier number for UHR and ELR and a separate field (such as the PPDU type and compression mode subfield, an ELR subfield, or another subfield) to differentiate between UHR and ELR. For example, a PHY version identifier subfield that includes a codepoint indicative of a first value (such as a “1” value) may indicate that the PPDU 710 is associated with a UHR format or an ELR format (and may not differentiate between the two formats). The U-SIG field 716 may include the PPDU type and compression mode subfield within a version dependent portion of the U-SIG field 716. The PPDU type and compression mode subfield may be selectively or conditionally present in accordance with a value of, for example, the PHY version identifier subfield. For example, if the PHY version identifier subfield indicates that the PPDU 710 is associated with a UHR format or an ELR format, the wireless communication device 702 may include the PPDU type and compression mode subfield within the version dependent portion of the U-SIG field 716 to provide the first indication 802-b to the wireless communication device 704. For example, the PPDU type and compression mode subfield may include two bits. If the PPDU type and compression mode subfield is set to a first value (such as a “3” value, with a codepoint of “11”), the PPDU type and compression mode subfield may indicate that the PPDU is an ELR PPDU.

As illustrated in the example of the U-SIG field design 850, an ELR subfield of the U-SIG field 716 may include the first indication 802-c. For example, a PHY version identifier subfield that includes a codepoint indicative of a first value (such as a “1” value) may indicate that the PPDU 710 is associated with a UHR format or an ELR format (and may not differentiate between the two formats). In accordance with the example of the U-SIG field design 850, the U-SIG field 716 may include the ELR subfield (such as a PPDU type and compression mode subfield or another subfield indicating ELR information) within a version dependent portion of the U-SIG field 716. The ELR subfield may be selectively or conditionally present in accordance with a value of, for example, the PHY version identifier subfield. For example, if the PHY version identifier subfield indicates that the PPDU 710 is associated with a UHR format or an ELR format, the wireless communication device 702 may include the ELR subfield within the version dependent portion of the U-SIG field 716 to provide the first indication 802-c to the wireless communication device 704. The ELR subfield may include one bit, two bits, or any other quantity of bits.

In association with the PHY version identifier subfield including or otherwise conveying the first indication 802-a, a version dependent portion of the U-SIG field 716 may include five reserved bits. Alternatively, in association with the PPDU type and compression mode subfield including or otherwise conveying the first indication 802-b, a version dependent portion of the U-SIG field 716 may include three reserved bits (such as three ELR Validate bits). Alternatively, in association with the ELR subfield including or otherwise conveying the first indication 802-c, a version dependent portion of the U-SIG field 716 may include four reserved bits (if the ELR subfield includes one bit) or three reserved bits (if the ELR subfield includes two bits). The reserved bits within the version dependent fields/portion of the U-SIG field 716 may be Disregard bits, Validate bits, or may carry additional information.

In accordance with the U-SIG field design 800 and the U-SIG field design 850, a STA identifier subfield (which may be referred to herein as a “STA-ID subfield”) of the U-SIG field 716 may include the second indication (such as a second indication 804-a in accordance with the U-SIG field design 800 or a second indication 804-b in accordance with the U-SIG field design 850). The U-SIG field 716 may include the STA identifier subfield within a version dependent portion of the U-SIG field 716. The STA identifier subfield may occupy 11 bits and, in some implementations, the U-SIG field 716 may provide room (such as a sufficient quantity of available bits) for the STA identifier subfield in accordance with excluding one or more subfields that may be included in other PPDU formats (such as in EHT or UHR PPDU formats). For example, the U-SIG field 716 may exclude one or more of a puncture channel information subfield, an MCS subfield (such as an EHT-MCS subfield), a number of symbols subfield (such as a number of EHT-SIG symbols), and a spatial reuse subfield.

FIG. 9 shows an example sequence selection scheme 900 that supports signaling designs for ELR transmissions. For example, the wireless communication device 702 may employ the sequence selection scheme 900 to select a sequence, such as an ELR sequence, to apply across (and transmit via) the ELR symbol 718-a and the ELR symbol 718-b of the PPDU 710. In some implementations, to facilitate a mutual understanding of the sequence selection scheme 900, the wireless communication device 702 and the wireless communication device 704 may use a mapping 906 between a set of BSSs 902 and a set of sequences 904 (such as a set of ELR sequences). The wireless communication device 702 and the wireless communication device 704 may exchange (such as transmit or receive) signaling indicative of the mapping 906, may retrieve the mapping 906 from one or more respective memories (such as in accordance with a network specification), or may receive the mapping 906 from another network node or entity (such as a central controller).

A sequence that the wireless communication device 702 applies to the ELR symbol 718-a and the ELR symbol 718-b, which may be referred to as an ELR-mark, may identify an ELR packet (such as the PPDU 710). In some implementations, the wireless communication device 702 may use a sequence for the ELR symbol 718-a and the ELR symbol 718-b that is known to the wireless communication device 704 (such as to facilitate use of the sequence to identify the ELR packet). Additionally, in some implementations, the wireless communication device 704 may use the known sequence to boost channel estimation or phase tracking, among other examples. In some implementations, the set of ELR symbols across which the wireless communication device 702 transmits a sequence (such as an ELR-mark sequence) may include two signature symbols (such as to facilitate a target channel gain, such as an approximately 6+dB gain).

In some implementations, the sequence that the wireless communication device 702 uses for the ELR-mark (an ELR-mark sequence) may carry additional information, such as information indicative of a BSS color or identifier, that is known at both the wireless communication device 702 and the wireless communication device 704 to accommodate (such as to facilitate) an early drop of the PPDU 710. For example, an ELR AP/STA with a relatively low PD sensitivity may detect (potentially many) false alarm packets, even potentially from far away OBSS STAs. Using a sequence that corresponds to a BSS color may enable receiving wireless communication devices to correlate with a received ELR sequence, which may enable a receiving device to select, identify, decide, or otherwise determine whether the received packet is an ELR packet and whether the received packet is associated with a same BSS as the receiving device (both of which may enable or facilitate a receiving device to drop off and save power if the packet is an unintended packet).

In some implementations, the ELR symbol 718-a and the ELR symbol 718-b (the two signature symbols) may be present within a legacy preamble portion and a tone plan of the ELR symbol 718-a and the ELR symbol 718-b may follow a one-times (1×) tone plan for 20 MHz that has 48 data tones and 4 pilot tones in each symbol. In other words, the ELR symbol 718-a and the ELR symbol 718-b may each be associated with (such as include) 48 data tones and 4 pilot tones. In some implementations, the 4 pilot tones in each of the ELR symbol 718-a and the ELR symbol 718-b may be associated with pilot tone values corresponding to the preamble, may be associated with LTF values at pilot tones, or may carry additional information. In some implementations, one or more extra channel estimation tones (such as tones −28, −27, 27, 28) on L-SIG/RL-SIG may not be power boosted and, accordingly, may not be used for carrying an ELR sequence. In some other implementations, such one or more extra L-SIG/RL-SIG channel estimation tones may be power boosted and used for carrying an ELR sequence.

To enable an ELR sequence to carry BSS-identifying information (such as an indication of a BSS color) over or within the ELR symbol 718-a and the ELR symbol 718-b (the two signature symbols), the wireless communication device 702 and the wireless communication device 704 may employ the mapping 906 between the set of BSSs 902 and the set of sequences 904. In some implementations, the wireless communication device 702 and the wireless communication device 704 may use the mapping 906 to map the 6-bit BSS color to 64 different sequences on 48*2=96 tones or on (48+4)*2=104 tones. In some implementations, the wireless communication device 702 and the wireless communication device 704 may additionally, or alternatively, utilize one or more mechanisms according to which the wireless communication device 702 and the wireless communication device 704 may achieve a target peak-to-average-power ratio (PAPR), such as a relatively low PAPR. For example, the wireless communication device 702 and the wireless communication device 704 may select the 64 different sequences in accordance with the 64 sequences offering a relatively lowest PAPR. In some implementations, the wireless communication device 702 and the wireless communication device 704 may select the 64 sequences out of a larger set of available sequences, such as out of a larger set of 96 or 104 orthogonal, or approximately orthogonal, sequences. For example, the wireless communication device 702 and the wireless communication device 704 may select a subset of sequences from the set of sequences 904.

In some implementations, the set of sequences 904 may have zero or a relatively low amount of cross-correlation between sequences corresponding to different BSSs of the set of BSSs 902 (such as between sequences corresponding to different BSS color values), which may reduce a false alarm from OBSS packets. In some implementations, the wireless communication device 702 and the wireless communication device 704 may select relatively low (such as approximately zero or negligible) correlation sequences or orthogonal sequences with an order of 96 or 104. For example, the wireless communication device 702 and the wireless communication device 704 may select, generate, determine, calculate, or identify the set of sequences 904 as columns or rows from a Hadamard matrix, as Golay sequences with one or more shifted versions, as a Zadoff-Chu sequence with one or more shifted versions, or as Barker sequences.

If the set of sequences 904 includes 96 orthogonal sequences (such as from either row or column vectors in a Hadamard matrix of order 96), the wireless communication device 702 and the wireless communication device 704 may select 64 ELR sequences from the set of sequences 904 and may map, one-on-one, 64 values from the 6-bit BSS color to the 64 selected ELR sequences. In other words, the 64 values from the 6-bit BSS color may be mapped one-on-one to 64 out of the 96 orthogonal sequences. In accordance with the mapping, each BSS of the set of BSSs 902 may map to a respective sequence from the selected set of 64 ELR sequences. For example, a first BSS 902-a may correspond to a first sequence 904-a, a second BSS 902-b may correspond to a second sequence 904-b, and a third BSS 902-c may correspond to a third sequence 904-c.

To maintain a target or relatively low PAPR for the ELR symbol 718-a and the ELR symbol 718-b, the wireless communication device 702 may select the 64 ELR sequences from the set of sequences 904 in accordance with one or more signaled, configured, or specified mechanisms. In some implementations, for example, the wireless communication device 702 and the wireless communication device 704 may select 64 out of the orthogonal 96 sequences with a relatively lowest PAPR on the ELR symbol 718-a and the ELR symbol 718-b. Additionally, or alternatively, the wireless communication device 702 and the wireless communication device 704 may apply a fixed mask to reduce PAPR and may select 64 out of the (masked) 96 orthogonal sequences with a relatively lowest PAPR on the ELR symbol 718-a and the ELR symbol 718-b. In some implementations, applying a fixed mask may include applying an LTF sequence as a mask to the used tones of the ELR symbol 718-a and the ELR symbol 718-b.

Additionally, or alternatively, the wireless communication device 702 and the wireless communication device 704 may apply a different rotation (such as a different modulation rotation) on at least a subset of tones associated with the ELR symbol 718-a and the ELR symbol 718-b to reduce PAPR and may select 64 out of the 96 orthogonal sequences with a relatively lowest PAPR on the (modulation rotated) ELR symbol 718-a and the (modulation rotated) ELR symbol 718-b. In some implementations, applying a different rotation to at least the subset of tones may include applying a 90-degree rotation on every other data tone. In some additional, or alternative, implementations, applying a different rotation to at least the subset of tones may include applying a 90-degree rotation on a portion of the bandwidth (such as an upper half or a lower half of the bandwidth). In some implementations, such tone rotations may reduce a false alarm rate from other frame formats in ELR mode detection, as such tone rotations may be indicative of or specifically associated with an ELR format. Additionally, or alternatively, the wireless communication device 702 and the wireless communication device 704 may apply a fixed mask, may apply a different rotation (such as a different modulation rotation) on at least a subset of tones associated with the ELR symbol 718-a and the ELR symbol 718-b, and may select 64 out of the (masked) 96 orthogonal sequences with a relatively lowest PAPR on the (modulation rotated) ELR symbol 718-a and the (modulation rotated) ELR symbol 718-b.

In accordance with selecting the 64 ELR sequences, the wireless communication device 702 and the wireless communication device 704 may select the first sequence 904-a, the second sequence 904-b, and the third sequence 904-c (for inclusion within the set of ELR sequences that the wireless communication device 702 and the wireless communication device 704 map to the set of BSSs 902) and may refrain from selecting a fourth sequence 904-d and a fifth sequence 904-e. As compared to the fourth sequence 904-d and the fifth sequence 904-e, the first sequence 904-a, the second sequence 904-b, and the third sequence 904-c may have relatively lower PAPR values. Thus, the wireless communication device 702 and the wireless communication device 704 may refrain from mapping the fourth sequence 904-d and the fifth sequence 904-e to a BSS from the set of BSSs 902.

In some implementations, the wireless communication device 702 may select to transmit the first sequence 904-a via the ELR symbol 718-a and the ELR symbol 718-b in association with the wireless communication device 702 being associated with the first BSS 902-a. For example, because the wireless communication device 702 belongs to the first BSS 902-a, the wireless communication device 702 may transmit the first sequence 904-a via the ELR symbol 718-a and the ELR symbol 718-b to convey, to the wireless communication device 704, that the PPDU 710 is associated with the first BSS 902-a. In some implementations, because each of the ELR symbol 718-a and the ELR symbol 718-b have 48 data tones, the wireless communication device 702 may include a first portion 908-a (such as a first half, such as a first/initial 48 bits) of the first sequence 904-a (a length-96 sequence) in the ELR symbol 718-a and may include a second portion 908-b (such as a second half, such as a second/final 48 bits) of the first sequence 904-a (the length-96 sequence) in the ELR symbol 718-b.

The wireless communication device 704, in accordance with receiving the first sequence 904-a, may selectively parse a remainder of the PPDU 710 in accordance with a correlation level with the first sequence 904-a. For example, if the wireless communication device 704 is also associated with the first BSS 902-a, the wireless communication device 704 may perform a correlation between the sequence received via the ELR symbols and the first sequence 904-a that corresponds to the first BSS 902-a. If the received sequence is also the first sequence 904-a, the wireless communication device 704 may satisfy a threshold correlation level and continue parsing the PPDU 710 accordingly. Alternatively, if the wireless communication device 704 is associated with the second BSS 902-b, the wireless communication device 704 may attempt to correlate the received sequence (the first sequence 904-a) with the second sequence 904-b. In such implementations, the wireless communication device 704 may fail to satisfy a threshold correlation level and may drop the PPDU 710 (in accordance with a determination or assumption that the PPDU 710 is an OBSS transmission from the perspective of the wireless communication device 704).

In some implementations, a modulation scheme associated with a selected sequence (such as an ELR sequence) may be in accordance with whether the ELR symbols via which the sequence is transmitted are present after a U-SIG field 716 of the PPDU 710 (such as in accordance with whether a U-SIG field 716 is included within the PPDU 710). For example, an ELR sequence may be associated with a first set of one or more modulation schemes if an RL-SIG field is present before (such as right before or immediately before) the ELR symbols (which may correspond to examples in which the ELR PPDU format excludes a U-SIG field 716). Such a first set of one or more modulation schemes may include a QBPSK modulation scheme. For further example, an ELR sequence may be associated with a second set of one or more modulation schemes if the ELR symbols are present after a U-SIG field 716 (which may correspond to examples in which the ELR PPDU format includes a U-SIG field 716). Such a second set of one or more modulation schemes may include a BPSK modulation scheme, a QBPSK modulation scheme, or a modulation scheme associated with tone alternating BPSK and QBPSK (such as a tone-by-tone alternating between BPSK and QBPSK). In accordance with tone alternating BPSK and QBPSK, a first set of tones may be associated with BPSK and a second set of tones may be associated with QBPSK. The first set of tones may alternate with the second set of tones or may be associated with any other pattern or distribution of tones, such as a split between a first/initial set of tones and a second/final set of tones.

FIG. 10 shows example ELR-SIG field designs 1000 and 1050 that support signaling designs for ELR transmissions. In some implementations, the wireless communication device 702 and the wireless communication device 704 may support one or more signaled or configured rules according to which the wireless communication device 702 and the wireless communication device 704 may place (such as locate, order, insert, or add) the ELR-SIG field 720 of the PPDU 710 and may support one or both of the ELR-SIG field design 1000 or the ELR-SIG field design 1050 in accordance with the placement of the ELR-SIG field 720 within the PPDU 710.

In some implementations, content-wise, the wireless communication device 702 and the wireless communication device 704 may leverage one or both of the ELR-SIG field design 1000 or the ELR-SIG field design 1050 to accommodate an early drop at an unintended receiving wireless communication device, which the wireless communication device 702 and the wireless communication device 704 may facilitate via an inclusion of one or more specific subfields within the ELR-SIG field 720. Such one or more subfields may include an uplink/downlink indicator subfield (or bit), a BSS color subfield (if, for example, the ELR symbol 718-a and the ELR symbol 718-b do not convey the BSS color), or a STA identifier subfield (such as a STA-ID subfield, which may be conditionally or selectively included in accordance with a placement of the ELR-SIG field 720 within the PPDU 710).

In some implementations, the wireless communication device 702 may place the ELR-SIG field 720 before an ELR-STF field (if present) or an ELR-LTF field. In some such implementations, channel estimation may come from 3+dB power boosted L-LTFs (such as two L-LTFs) and channel estimation accuracy may be increased by additionally, or alternatively, using ELR-mark symbols (such as the ELR symbol 718-a and the ELR symbol 718-b). In some implementations, to provide a comparable channel estimation accuracy to that associated with an ELR-LTF field, the wireless communication device 702 may perform power boosting on the ELR-mark symbols. Further, in some implementations, the ELR-SIG field 720 may follow 1× symbol operation. The ELR-SIG field 720 may include one or more copies or symbols in time domain-based repetitions and, in some implementations, a first copy/symbol of the ELR-SIG field 720 may include a guard interval (GI) and the one or more copies/symbols that follow the first copy/symbol may be absent of GIs. If the wireless communication device 702 places the ELR-SIG field 720 before the ELR-STF field or the ELR-LTF field (or before both), the wireless communication device 702 may use a one segment ELR PPDU structure (which may be associated with the ELR PPDU format 600 without the ELR-STF and ELR-LTF fields). The ELR-data field 722 also may be associated with 1× symbol operation. Additionally, in some implementations, the PPDU 710 (or one or both of the ELR-SIG field 720 or the ELR-data field 722) may be associated with additional (such as greater than a threshold quantity of) time domain repetitions to support triggered transmission.

In implementations in which the ELR-SIG field 720 is located before the ELR-STF field (if present) or the ELR-LTF field, the ELR-SIG field 720 may be associated with the ELR-SIG field design 1000. In accordance with the ELR-SIG field design 1000, the ELR-SIG field 720 may include one or more of a version number subfield of 2 bits, an uplink/downlink indicator subfield of 1 bit, a BSS color subfield of 6 bits (if the BSS color is not conveyed via the ELR symbol 718-a and the ELR symbol 718-b), a length subfield of 6 bits or 8 bits (unit in symbol, 4× symbol or equivalent), a STA identifier subfield of 11 bits, a coding subfield (such as a low-density parity check (LDPC)/binary convolutional code (BCC) (LDPC/BCC) subfield) of 1 bit, an MCS subfield of 1 or 2 bits, a CRC subfield of 4 bits, and a tail subfield of 6 bits. In some such implementations, the ELR-SIG field 720 may be associated with various potential quantities of bits, including 30 bits, 31 bits, 37 bits, or 41 bits, among other examples. In some implementations, the uplink/downlink indicator subfield and the STA identifier subfield may support operations at the wireless communication device 704 in scenarios in which the wireless communication device 704 operates or communicates via a select frequency band, such as a 2.4 GHz frequency band (such as if an indication of uplink or an identifier corresponding to a STA 104 may enable the wireless communication device 704 to perform an early drop because the wireless communication device 704 is relatively unlikely to be the intended receiver).

In some other implementations, the wireless communication device 702 may place the ELR-SIG field 720 after the ELR-LTF field. In some such implementations, channel estimation may come from the ELR-LTF field with or without power boosting. Further, in some such implementations, both the ELR-SIG field 720 and the ELR-data field 722 may be associated with a same modulation format. For example, if the wireless communication device 702 uses a dRU for the ELR payload, the ELR-LTF field, the ELR-SIG field 720, and the ELR-data field 722 may use a same dRU size and vary MCS, as applicable or suitable, for a higher ELR data rate. In some implementations, the ELR-SIG field 720 or the ELR-data field 722, or both, may be associated with a four-times (4×) duration. In some such implementations, the wireless communication device 704 may refrain from applying symbol level combining. Further, in some such implementations, the wireless communication device 702 and the wireless communication device 704 may support triggered transmissions (such as if the ELR modulation is associated with a specific RU size, such as RU242).

If the ELR-SIG field 720 is located after the ELR-LTF field, the ELR-SIG field 720 may be associated with the ELR-SIG field design 1050. In accordance with the ELR-SIG field design 1050, the ELR-SIG field 720 may include one or more of a version number subfield of 2 bits, an uplink/downlink indicator subfield of 1 bit, a BSS color subfield of 6 bits (if the BSS color is not conveyed via the ELR symbol 718-a and the ELR symbol 718-b), a length subfield of 6 or 8 bits, a coding subfield (such as an LDPC/BCC subfield) of 1 bit, an MCS subfield of 1 or 2 bits, a CRC subfield of 4 bits, and a tail subfield of 6 bits. In some such implementations, the ELR-SIG field 720 may be associated with various potential quantities of bits, including 19 bits, 20 bits, 26 bits, or 30 bits, among other examples. In accordance with the ELR-SIG field design 1050, the ELR-SIG field 720 may exclude a STA identifier subfield as, for example, a MAC address may follow (such as immediately follow) the ELR-SIG field 720. In other words, the wireless communication device 702 may include a STA identifier subfield within the ELR-SIG field 720 if (such as only if) the ELR-SIG field 720 is before the ELR-STF/ELR-LTF fields (because one or more ELR bystanders' early drop, or “drop off,” may be in accordance with the MAC address).

FIG. 11 shows an example modulation table 1100 that supports signaling designs for ELR transmissions. In some implementations, the wireless communication device 702 may construct, generate, modulate, or allocate (to resources) the ELR-SIG field 720 and the ELR-data field 722 in a relatively similar manner. In other words, modulation-wise, the wireless communication device 702 may generate the ELR-SIG field 720 and the ELR-data field 722 such that a processing or parsing of the ELR-SIG field 720 and the ELR-data field 722 is similar at the wireless communication device 704.

In some implementations, the wireless communication device 702 may modulate the ELR-SIG field 720 and the ELR-data field 722 in accordance with the modulation table 1100. For example, the wireless communication device 702 may use one or more communication parameters to transmit the PPDU 710 in accordance with a target data rate. The modulation table 1100 may be associated with examples in which the ELR-SIG field 720 transmits the ELR-SIG field 720 or the ELR-data field 722, or both, using one or more dRUs (such as one or more 26-tone dRUs or one or more 52-tone dRUs).

In some implementations, the wireless communication device 702 may target a data rate of 1 Mbps. In some such implementations, to generate the target 1 Mbps data rate, the wireless communication device 702 may use a code rate of ⅓ with a dRU52 transmission. Accordingly, the wireless communication device 702 and the wireless communication device 704, in accordance with the modulation table 1100, may support ⅓ BPSK with dRU52.

In some other implementations, the wireless communication device 702 may achieve the target 1 Mbps data rate in accordance with one or more other modulation and coding techniques. For example, in accordance with some implementations, the wireless communication device 702 may avoid a code rate of ⅓ in LDPC and BCC in accordance with leveraging one or more other code rates with coded bits repetition. In some implementations, for instance, the wireless communication device 702 may use a first modulation scheme with a code rate of ⅔ and with two-times (2×) coded bits repetition for one or both of the ELR-SIG field 720 or the ELR-data field 722. Additionally, or alternatively, the wireless communication device 702 may use a second modulation scheme with a code rate of ½ and with three-times (3×) coded bits repetition for one or both of the ELR-SIG field 720 or the ELR-data field 722. In some implementations, such a first modulation scheme may be BPSK, among other examples, and such a second modulation scheme may be QPSK, among other examples.

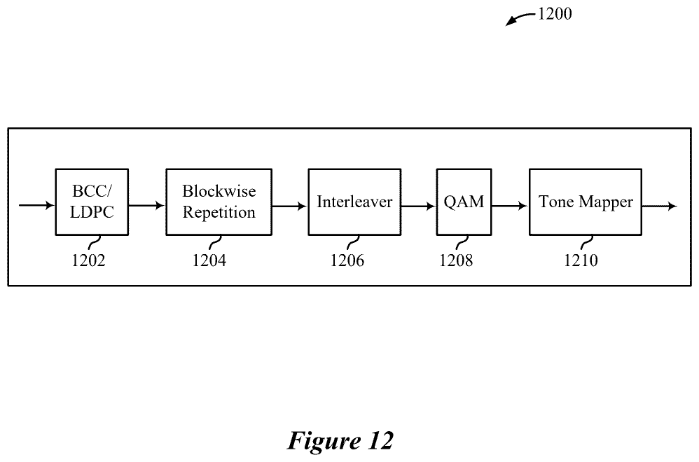

FIG. 12 shows an example transmit procedure 1200 that supports signaling designs for ELR transmissions. In some implementations, the wireless communication device 702 may utilize the transmit procedure 1200 to achieve a coded bits repetition, such as in association with targeting a threshold data rate (such as a target 1 Mbps data rate). In some networks, the wireless communication device 702 may utilize the transmit procedure 1200 for 1 MHZ MCS10, among other examples.

In accordance with the transmit procedure 1200, the wireless communication device 702 may encode a set of information bits (including at least, for example, information associated with one or both of the ELR-SIG field 720 or the ELR-data field 722) via a BCC/LDPC encoder 1202. In some implementations, the BCC/LDPC coding may be used as an outer code. The wireless communication device 702 may pass an output bitstream to a blockwise repetition block 1204 and, accordingly, may concatenate the BCC/LDPC coding (the outer code) with repetition coding (an inner code) and perform the blockwise repetition prior to passing the bitstream to an interleaver 1206 (such as prior to interleaving).

In some implementations, the wireless communication device 702 may use a same baseline interleaver 1206 (a BCC/LDPC interleaver) across an entire bandwidth of the PPDU 710. The wireless communication device 702 may pass an output of the interleaver 1206 to a QAM mapper 1208 and may map the bitstream to one or more modulation symbols. The wireless communication device 702 may map the modulation symbols to tones via the tone mapper 1210 (an LDPC tone mapper). In such implementations, the wireless communication device 702 may harvest frequency diversity gain in accordance with performing repetition combining, achieve a target tone efficiency, avoid a fractional symbol issue, and avoid a frequency spur, among other benefits. In some implementations, coded bits repetition may increase a PAPR. In some such implementations, the wireless communication device 702 may apply a mask over duplicated coded bits or a mask across the tones (such as an LTF sequence) prior to transmission to mitigate (such as to reduce below a threshold level) the PAPR.

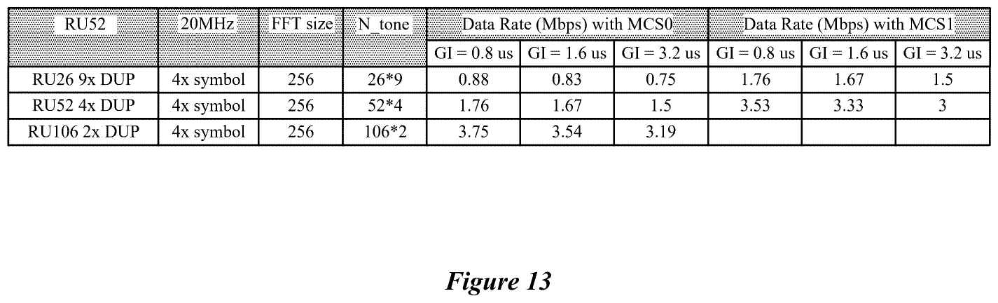

FIG. 13 shows an example modulation table 1300 that supports signaling designs for ELR transmissions. In some implementations, the wireless communication device 702 may generate or modulate one or both of the ELR-SIG field 720 or the ELR-data field 722 in accordance with the modulation table 1300. For example, the wireless communication device 702 may select one or more communication parameters in accordance with a target data rate (with a target or specified MCS) and may generate, modulate, and transmit at least the ELR-SIG field 720 or the ELR-data field 722 of the PPDU 710 in accordance with the selected communication parameters.

In some implementations, the wireless communication device 702 and the wireless communication device 704 may support frequency domain DUP (such as RU DUP) for the PPDU 710, or for at least a portion of the PPDU 710. For example, the wireless communication device 702 and the wireless communication device 704 may support frequency domain DUP for one or both of the ELR-SIG field 720 or the ELR-data field 722. In other words, one or both of the ELR-SIG field 720 or the ELR-data field 722 may be associated with frequency domain DUP.

In some networks, a 20 MHz OFDMA tone plan may include nine RU26, four RU52, and two RU106. In some implementations, the wireless communication device 702 and the wireless communication device 704 may support or perform duplication over RUs with a same size. Further, in some implementations, the wireless communication device 702 and the wireless communication device 704 may maintain one or more of an STF (such as an ELR-STF field), an LTF (such as an ELR-LTF field), and one or more pilot tones constructed in accordance with an OFDMA transmission format.

For example, the wireless communication device 702 and the wireless communication device 704 may support or perform RU26 duplication by nine-times (9×) over nine RU26 (such as over nine 26-tone RUs). One or both of the ELR-SIG field 720 or the ELR-data field 722 may be associated with the 9× duplication over the nine RU26. Additionally, or alternatively, the wireless communication device 702 and the wireless communication device 704 may support or perform RU52 duplication by four-times (4×) over four RU52 (such as over four 52-tone RUs). One or both of the ELR-SIG field 720 or the ELR-data field 722 may be associated with the 4× duplication over the four RU52. Additionally, or alternatively, the wireless communication device 702 and the wireless communication device 704 may support or perform RU106 duplication by two-times (2×) over two RU106 (such as over two 106-tone RUs). One or both of the ELR-SIG field 720 or the ELR-data field 722 may be associated with the 2× duplication over the two RU106.

The wireless communication device 704, in accordance with one or both of the ELR-SIG field 720 or the ELR-data field 722 being associated with frequency domain DUP, may add multiple RUs support for (such as associated with) tracking and decoding combining. In some implementations, frequency domain DUP may increase a PAPR, which one or both of the wireless communication device 702 or the wireless communication device 704 may mitigate in accordance with applying per tone rotations (such as per tone rotations associated with dual carrier modulation (DCM) or DUP modes). Additionally, or alternatively, one or both of the wireless communication device 702 or the wireless communication device 704 may mitigate the PAPR in accordance with applying a mask, such as in accordance with applying an LTF sequence (as a mask) to RU data tones. In addition to, or as an alternative from, frequency domain DUP, the wireless communication device 702 or the wireless communication device 704 may support RU242 with coded bits DUP.

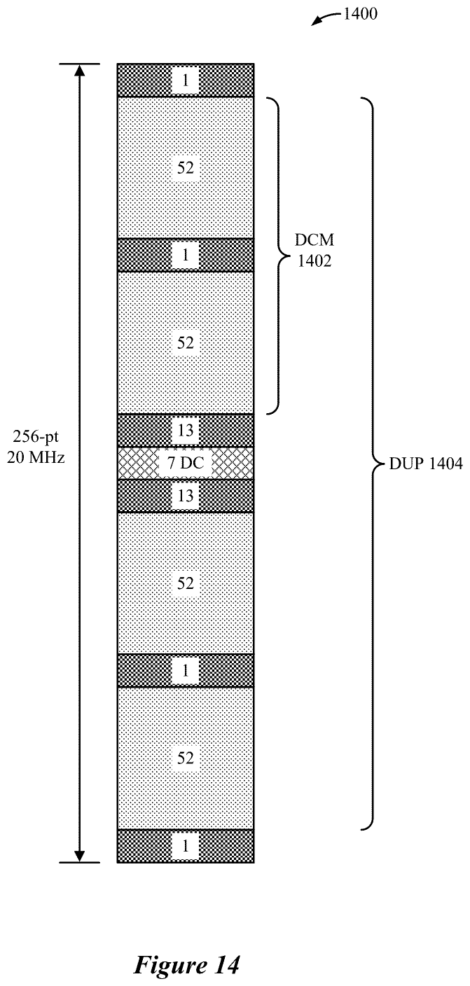

FIG. 14 shows an example DUP scheme 1400 that supports signaling designs for ELR transmissions. In some implementations, the wireless communication device 702 or the wireless communication device 704 may utilize the DUP scheme 1400 in association with transmitting or receiving at least a portion of the PPDU 710, such as at least one or both of the ELR-SIG field 720 or the ELR-data field 722. In some implementations, the DUP scheme 1400 may be associated with RU52 4× DUP with DUP mode rotations.

For example, the wireless communication device 702 or the wireless communication device 704 may use an MCS14 (which may be associated with a DUP mode (such as a DUP 1404) and applicable to various bandwidths including 80 MHz, 160 MHz, and 320 MHZ) and may apply MCS14 with RU52×4 for ELR. In accordance with such implementations, the wireless communication device 702 or the wireless communication device 704 may achieve a data rate of approximately 1.5-1.8 Mbps, depending on a GI.

In some implementations, the wireless communication device 702 or the wireless communication device 704 may enable MCS14 for RU×4. In some such implementations, a first set of RUs (such as the upper two 52-tone RUs) may form a DCM pair 1402 for modulation and a second set of RUs (such as the lower two 52-tone RUs) may be copies from the first set of RUs with tone rotations (such as tone rotations associated with a DUP mode). Such tone rotations may be associated with, for example, an application of a 180-degree rotation on each of the data tones in the third RU52. In some implementations, a UHR-LTF and data field may follow an RU52×4 tone plan that may be defined for 20 MHz.

In some implementations, a remaining 26 tones (such as a remaining 24 data tones and 2 pilot tones) relatively near (such as positioned around or contiguous to) a set of direct current (DC) tones may be used in one or more of various ways. In some implementations, the wireless communication device 702 or the wireless communication device 704 may use the remaining tones as additional data tones with tone DUP. Additionally, or alternatively, the wireless communication device 702 or the wireless communication device 704 may use the remaining tones as pilot tones to support phase tracking. Additionally, or alternatively, the wireless communication device 702 or the wireless communication device 704 may use the remaining tones for interference estimation. In some implementations, the wireless communication device 702 and the wireless communication device 704 may further support a rule according to which the wireless communication device 702 and the wireless communication device 704 may use MCS14 for 20 MHz, which may be associated with N_{SD,short}=15 and N_{SD}=48.

In some examples, N_{SD} may denote a quantity of data subcarriers (such as tones) per RU or per frequency segment. In some examples, N_{SD}, short may denote a quantity of data subcarriers (such as tones) in each symbol segment (which may be equal to one-quarter of the data subcarriers or tones in each OFDM symbol). A wireless communication device may use one or more symbol segments to define a coded bits boundary in a last OFDM symbol (such as a last OFDM symbol of a data field, such as an ELR-data field). A quantity of symbol segments in a last OFDM symbol may be denoted by an alpha parameter. There may be four symbol segments per OFDM symbol such that, if alpha=1, the last OFDM symbol may occupy one-quarter of the OFDM tones and such that, if alpha=2, the last OFDM symbol may occupy one-half of the tones, and so on.

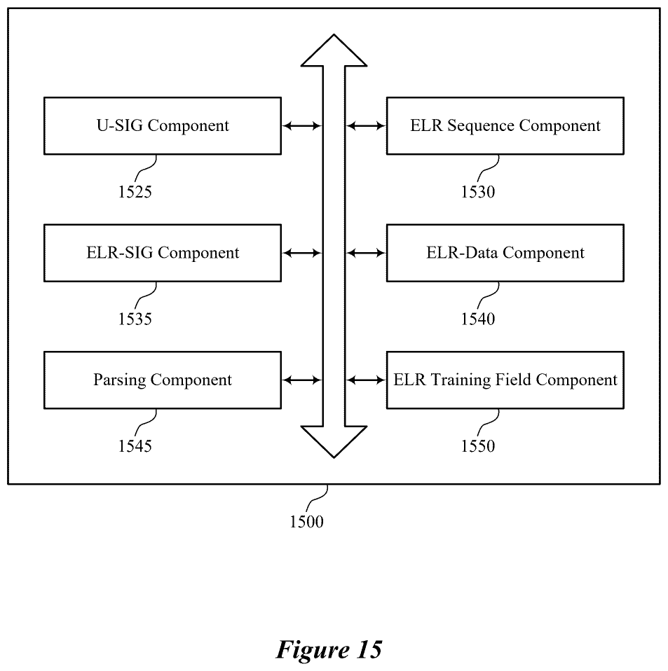

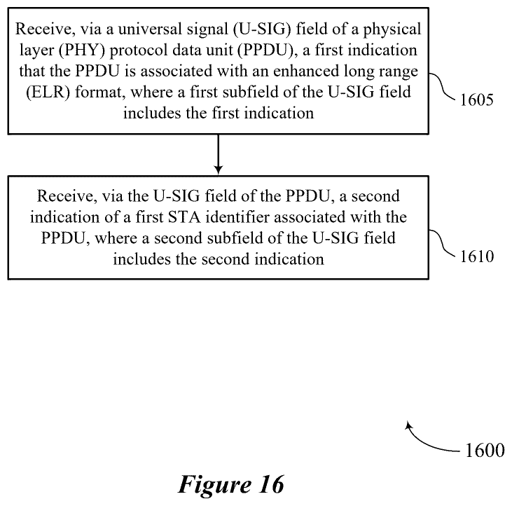

FIG. 15 shows a block diagram of an example wireless communication device 1500 that supports signaling designs for ELR transmissions. In some examples, the wireless communication device 1500 is configured to perform the processes 1600, 1700, 1800, 1900, 2000, and 2100 described with reference to FIGS. 16, 17, 18, 19, 20, and 21, respectively. The wireless communication device 1500 may include one or more chips, systems-on-a-chip (SoCs), chipsets, packages, components or devices that individually or collectively constitute or include a processing system. The processing system may interface with other components of the wireless communication device 1500 and may generally process information (such as inputs or signals) received from such other components and output information (such as outputs or signals) to such other components. In some aspects, an example chip may include a processing system, a first interface to output or transmit information, and a second interface to receive or obtain information. For example, the first interface may refer to an interface between the processing system of the chip and a transmission component, such that the wireless communication device 1500 may transmit the information output from the chip. In such an example, the second interface may refer to an interface between the processing system of the chip and a reception component, such that the wireless communication device 1500 may receive information that is passed to the processing system. In some such examples, the first interface also may obtain information, such as from the transmission component, and the second interface also may output information, such as to the reception component.

The processing system of the wireless communication device 1500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem).

In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1500 can be configurable or configured for use in an AP or STA, such as the AP 102 or the STA 104 described with reference to FIG. 1. In some other examples, the wireless communication device 1500 can be an AP or STA that includes such a processing system and other components including multiple antennas. The wireless communication device 1500 is capable of transmitting and receiving wireless communications in the form of, for example, wireless packets. For example, the wireless communication device 1500 can be configurable or configured to transmit and receive packets in the form of physical layer PPDUs and MPDUs conforming to one or more of the IEEE 802.11 family of wireless communication protocol standards. In some other examples, the wireless communication device 1500 can be configurable or configured to transmit and receive signals and communications conforming to one or more 3GPP specifications including those for 5G NR or 6G.

In some examples, the wireless communication device 1500 also includes or can be coupled with one or more application processors which may be further coupled with one or more other memories. In some examples, the wireless communication device 1500 further includes a user interface (UI) (such as a touchscreen or keypad) and a display, which may be integrated with the UI to form a touchscreen display that is coupled with the processing system. In some examples, the wireless communication device 1500 may further include one or more sensors such as, for example, one or more inertial sensors, accelerometers, temperature sensors, pressure sensors, or altitude sensors, that are coupled with the processing system. In some examples, the wireless communication device 1500 further includes at least one external network interface coupled with the processing system that enables communication with a core network or backhaul network that enables the wireless communication device 1500 to gain access to external networks including the Internet.

The wireless communication device 1500 may include a U-SIG component 1525, an ELR sequence component 1530, an ELR-SIG component 1535, an ELR-data component 1540, a parsing component 1545, an ELR training field component 1550, or any combination thereof. Portions of one or more of the U-SIG component 1525, the ELR sequence component 1530, the ELR-SIG component 1535, the ELR-data component 1540, the parsing component 1545, and the ELR training field component 1550 may be implemented at least in part in hardware or firmware. For example, one or more of the U-SIG component 1525, the ELR sequence component 1530, the ELR-SIG component 1535, the ELR-data component 1540, the parsing component 1545, and the ELR training field component 1550 may be implemented at least in part by at least a processor or a modem. In some examples, portions of one or more of the U-SIG component 1525, the ELR sequence component 1530, the ELR-SIG component 1535, the ELR-data component 1540, the parsing component 1545, and the ELR training field component 1550 may be implemented at least in part by a processor and software in the form of processor-executable code stored in memory.

The wireless communication device 1500 may support wireless communication in accordance with examples as disclosed herein. The U-SIG component 1525 is configurable or configured to receive, via a U-SIG field of a PPDU, a first indication that the PPDU is associated with an ELR format, where a first subfield of the U-SIG field includes the first indication. In some examples, the U-SIG component 1525 is configurable or configured to receive, via the U-SIG field of the PPDU, a second indication of a first STA identifier associated with the PPDU, where a second subfield of the U-SIG field includes the second indication.

In some examples, the U-SIG field excludes a puncture channel information subfield, an MCS subfield, a quantity of symbols subfield, and a spatial reuse subfield. In some examples, the parsing component 1545 is configurable or configured to selectively parse a remainder of the PPDU that follows the U-SIG field in accordance with at least the first indication. In some examples, to support selectively parsing the remainder of the PPDU that follows the U-SIG field, the parsing component 1545 is configurable or configured to parse the remainder of the PPDU in accordance with the wireless communication device being an ELR-capable device and a second STA identifier associated with the wireless communication device matching the first STA identifier associated with the PPDU. In some examples, to support selectively parsing the remainder of the PPDU that follows the U-SIG field, the parsing component 1545 is configurable or configured to drop the remainder of the PPDU in accordance with at least one of the wireless communication device being a non-ELR-capable device or a second STA identifier associated with the wireless communication device being different than the first STA identifier associated with the PPDU.

In some examples, the first subfield is a version identifier subfield within a version independent portion of the U-SIG field. In some examples, the version identifier subfield includes a set of multiple bits. In some examples, a codepoint indicated by the set of multiple bits of the version identifier subfield indicates that the PPDU is associated with the ELR format. In some examples, the set of multiple bits of the version identifier subfield is associated with a set of multiple valid codepoints. In some examples, the set of multiple valid codepoints includes the codepoint that indicates that the PPDU is associated with the ELR format, a second codepoint that indicates that the PPDU is associated with a UHR format, and a third codepoint that indicates that the PPDU is associated with an EHT format. In some examples, the U-SIG field includes five validate bits within a version dependent portion of the U-SIG field in accordance with the first subfield being the version identifier subfield within the version independent portion of the U-SIG field.

In some examples, the first subfield is an ELR subfield within a version dependent portion of the U-SIG field. In some examples, the ELR subfield is present within the U-SIG field in accordance with a codepoint indicated by a version identifier subfield within a version independent portion of the U-SIG field. In some examples, the ELR subfield includes one or more bits (such as two bits). In some examples, a value indicated by the one or more bits of the ELR subfield indicates that the PPDU is associated with the ELR format. In some examples, the one or more bits of the ELR subfield are associated with four valid values. In some examples, the four valid values include the value that indicates that the PPDU is associated with the ELR format and at least one value that indicates that the PPDU is associated with a non-ELR format. In some examples, the U-SIG field includes three validate bits within the version dependent portion of the U-SIG field in accordance with the first subfield being the ELR subfield within the version dependent portion of the U-SIG field.

In some examples, the second subfield is a STA identifier subfield within a version dependent portion of the U-SIG field. In some examples, the STA identifier subfield is present within the U-SIG field in accordance with the first indication that the PPDU is associated with the ELR format.

The ELR sequence component 1530 is configurable or configured to receive, via a set of ELR symbols of a PPDU, a first ELR sequence, where the first ELR sequence corresponds to a first BSS associated with the PPDU in accordance with a mapping between a set of multiple ELR sequences and a set of multiple BSSs.

In some examples, the parsing component 1545 is configurable or configured to selectively parse a remainder of the PPDU that follows the set of ELR symbols in accordance with the PPDU being associated with the first BSS. In some examples, the ELR sequence component 1530 is configurable or configured to communicate, via one or more association frames, information indicative of a second BSS associated with the wireless communication device, where the second BSS corresponds to a second ELR sequence in accordance with the mapping, and where selectively parsing the remainder of the PPDU that follows the set of ELR symbols is in accordance with a correlation between the first ELR sequence and the second ELR sequence.

In some examples, to support selectively parsing the remainder of the PPDU that follows the set of ELR symbols, the parsing component 1545 is configurable or configured to parse at least a portion of the remainder of the PPDU in accordance with the correlation between the first ELR sequence and the second ELR sequence satisfying a threshold correlation level. In some examples, in accordance with satisfying the threshold correlation level, the first ELR sequence and the second ELR sequence are a same sequence and, in accordance with the first ELR sequence and the second ELR sequence being the same sequence, the first BSS and the second BSS are a same BSS. In some examples, to support selectively parsing the remainder of the PPDU that follows the set of ELR symbols, the parsing component 1545 is configurable or configured to drop the remainder of the PPDU in accordance with the correlation between the first ELR sequence and the second ELR sequence failing to satisfy a threshold correlation level. In some examples, in accordance with failing to satisfy the threshold correlation level, the first ELR sequence and the second ELR sequence are different and, in accordance with the first ELR sequence and the second ELR sequence being different, the first BSS and the second BSS are different.

In some examples, in accordance with the mapping, each BSS of the set of multiple BSSs corresponds to a respective ELR sequence of the set of multiple ELR sequences, the set of multiple BSSs including the first BSS and the set of multiple ELR sequences including the first ELR sequence. In some examples, each ELR sequence of the set of multiple ELR sequences corresponds to a respective BSS color value of a set of multiple BSS color values, each BSS color value corresponding to a respective BSS of the set of multiple BSSs. In some examples, the set of multiple ELR sequences includes a quantity of 64 ELR sequences in accordance with each BSS color value being associated with 6 bits.

In some examples, the set of multiple ELR sequences is selected from a set of multiple available sequences. In some examples, the set of multiple ELR sequences is selected from the set of multiple available sequences such that ELR sequences of the set of multiple ELR sequences are associated with relatively lower PAPRs across the set of ELR symbols as compared to a remainder of the set of multiple available sequences.

In some examples, the wireless communication device applies a fixed mask to each sequence of the set of multiple available sequences to obtain a masked set of multiple available sequences. In some examples, the set of multiple ELR sequences is selected from the masked set of multiple available sequences such that ELR sequences of the set of multiple ELR sequences are associated with relatively lower PAPRs across the set of ELR symbols as compared to a remainder of the masked set of multiple available sequences.

In some examples, the wireless communication device applies a modulation rotation to at least a subset of data tones associated with the set of ELR symbols to obtain a set of modulation rotated ELR symbols. In some examples, the set of multiple ELR sequences is selected from the set of multiple available sequences such that ELR sequences of the set of multiple ELR sequences are associated with relatively lower PAPRs across the set of modulation rotated ELR symbols as compared to a remainder of the set of multiple available sequences.

In some examples, the wireless communication device applies a fixed mask to each sequence of the set of multiple available sequences to obtain a masked set of multiple available sequences. In some examples, the wireless communication device applies a modulation rotation to at least a subset of data tones associated with the set of ELR symbols to obtain a set of modulation rotated ELR symbols. In some examples, the set of multiple ELR sequences is selected from the masked set of multiple available sequences such that ELR sequences of the set of multiple ELR sequences are associated with relatively lower PAPRs across the set of modulation rotated ELR symbols as compared to a remainder of the masked set of multiple available sequences.

In some examples, the set of ELR symbols includes a first ELR symbol and a second ELR symbol. In some examples, the first ELR sequence is a length-96 sequence. In some examples, a first half of the first ELR sequence is mapped to a first set of data tones associated with the first ELR symbol and a second half of the first ELR sequence is mapped to a second set of data tones associated with the second ELR symbol.

In some examples, the first ELR sequence may be associated with a QBPSK modulation scheme in accordance with the PPDU excluding a U-SIG field. In some examples, the first ELR sequence may be associated with a BPSK modulation scheme, a QBPSK modulation scheme, or a modulation scheme associated with a tone-by-tone alternation between BPSK and QBPSK in accordance with the set of ELR symbols being present after a U-SIG field of the PPDU.

The ELR-SIG component 1535 is configurable or configured to receive, via a preamble portion of a PPDU associated with an ELR format, an ELR-SIG field that includes an uplink/downlink indicator subfield, a length subfield, a coding indicator subfield, and an MCS subfield. The ELR-data component 1540 is configurable or configured to receive, via a data portion of the PPDU associated with the ELR format, an ELR-data field in accordance with one or more of the uplink/downlink indicator subfield, the length subfield, the coding indicator subfield, and the MCS subfield included by the ELR-SIG field.

In some examples, the ELR training field component 1550 is configurable or configured to receive, via the preamble portion of the PPDU associated with the ELR format, an ELR-LTF, where the ELR-SIG field is located after the ELR-LTF. In some examples, the ELR-SIG field is located immediately after the ELR-LTF. In some examples, the ELR-SIG field further includes a BSS color subfield. In some examples, the ELR-SIG field further includes a version number subfield. In some examples, the version number subfield includes two bits and the length subfield includes six or eight bits. In some examples, the length subfield indicates a quantity of symbols associated with a 4× symbol duration. In some examples, the ELR-LTF, the ELR-SIG field, and the ELR-data field are associated with a same dRU size. In some examples, the ELR-SIG field and the ELR-data field are associated with a same modulation scheme. In some examples, the ELR-SIG field is associated with a 4× symbol operation.

In some examples, the ELR training field component 1550 is configurable or configured to receive, via the preamble portion of the PPDU associated with the ELR format, one or both of an ELR-STF or an ELR-LTF, where the ELR-SIG field is located prior to the ELR-STF or the ELR-LTF. In some examples, the ELR-SIG field is located immediately prior to the ELR-STF or the ELR-LTF. In some examples, the ELR-SIG field further includes a BSS color subfield. In some examples, the ELR-SIG field further includes a STA identifier subfield. In some examples, the ELR-SIG field further includes a version number subfield. In some examples, the version number subfield includes two bits and the length subfield includes six or eight bits. In some examples, the length subfield indicates a quantity of symbols associated with a 4× symbol duration. In some examples, the ELR-SIG field is associated with a 1× symbol operation. In some examples, an initial symbol of the ELR-SIG field includes a guard interval. In some examples, one or more symbols of the ELR-SIG field after the initial symbol exclude guard intervals. In some examples, the ELR-data field is associated with a 1× symbol operation.

In some examples, the ELR-SIG field and the ELR-data field are associated with a coding rate of one-third in accordance with being associated with a dRU size of 52 tones. In some examples, the ELR-SIG field and the ELR-data field are associated with a coding rate of two-thirds and a 2× coded bits repetition in accordance with being associated with a BPSK modulation scheme. In some examples, the ELR-SIG field and the ELR-data field are associated with a coding rate of one-half and a 3× coded bits repetition in accordance with being associated with a QPSK modulation scheme. In some examples, the ELR-SIG field and the ELR-data field are associated with a concatenation of an outer code with a repetition coding. In some examples, the repetition coding is performed prior to an interleaving.

In some examples, the ELR-SIG field and the ELR-data field are associated with a 26-tone RU and a duplication over a quantity of 26-tone RUs. In some examples, the duplication includes 9× duplication. In some examples, the quantity of 26-tone RUs includes nine 26-tone RUs. In some examples, the ELR-SIG field and the ELR-data field are associated with a 52-tone RU and a duplication over a quantity of 52-tone RUs. In some examples, the duplication includes 4× duplication. In some examples, the quantity of 52-tone RUs includes four 52-tone RUs. In some examples, the ELR-SIG field and the ELR-data field are associated with a 106-tone RU and a duplication over a quantity of 106-tone RUs. In some examples, the duplication includes 2× duplication. In some examples, the quantity of 106-tone RUs includes two 106-tone RUs.

In some examples, the preamble portion of the PPDU further includes an ELR-STF and an ELR-LTF. In some examples, the ELR-SIG field and the ELR-data field include a set of multiple pilot tones. In some examples, the ELR-STF, the ELR-LTF, and the set of multiple pilot tones are associated with an OFDMA transmission format.

In some examples, the ELR-SIG field and the ELR-data field are associated with a set of multiple symbols. In some examples, the set of multiple symbols is associated with a set of multiple tones. In some examples, a modulation rotation is applied to at least a subset of the set of multiple tones. In some examples, the ELR-SIG field and the ELR-data field are associated with a set of multiple symbols. In some examples, the set of multiple symbols is associated with a set of multiple tones. In some examples, a mask is applied to the set of multiple tones.

In some examples, the U-SIG component 1525 is configurable or configured to transmit, via a U-SIG field of a PPDU, a first indication that the PPDU is associated with an ELR format, where a first subfield of the U-SIG field includes the first indication. In some examples, the U-SIG component 1525 is configurable or configured to transmit, via the U-SIG field of the PPDU, a second indication of a first STA identifier associated with the PPDU, where a second subfield of the U-SIG field includes the second indication.

In some examples, the U-SIG field excludes a puncture channel information subfield, an MCS subfield, a quantity of symbols subfield, and a spatial reuse subfield. In some examples, the U-SIG component 1525 is configurable or configured to generate the U-SIG field of the PPDU in accordance with the PPDU being associated with the ELR format and in accordance with an intended receiver of the PPDU, where the intended receiver of the PPDU is associated with the first STA identifier.

In some examples, the first subfield is a version identifier subfield within a version independent portion of the U-SIG field. In some examples, the version identifier subfield includes a set of multiple bits. In some examples, a codepoint indicated by the set of multiple bits of the version identifier subfield indicates that the PPDU is associated with the ELR format. In some examples, the set of multiple bits of the version identifier subfield is associated with a set of multiple valid codepoints. In some examples, the set of multiple valid codepoints includes the codepoint that indicates that the PPDU is associated with the ELR format, a second codepoint that indicates that the PPDU is associated with a UHR format, and a third codepoint that indicates that the PPDU is associated with an EHT format. In some examples, the U-SIG field includes five validate bits within a version dependent portion of the U-SIG field in accordance with the first subfield being the version identifier subfield within the version independent portion of the U-SIG field.

In some examples, the first subfield is an ELR subfield within a version dependent portion of the U-SIG field. In some examples, the ELR subfield is present within the U-SIG field in accordance with a codepoint indicated by a version identifier subfield within a version independent portion of the U-SIG field. In some examples, the ELR subfield includes one or more bits. In some examples, a value indicated by the one or more bits of the ELR subfield indicates that the PPDU is associated with the ELR format. In some examples, the one or more bits of the ELR subfield are associated with four valid values. In some examples, the four valid values include the value that indicates that the PPDU is associated with the ELR format and at least one value that indicates that the PPDU is associated with a non-ELR format. In some examples, the U-SIG field includes three validate bits within the version dependent portion of the U-SIG field in accordance with the first subfield being the ELR subfield within the version dependent portion of the U-SIG field.

In some examples, the second subfield is a STA identifier subfield within a version dependent portion of the U-SIG field. In some examples, the STA identifier subfield is present within the U-SIG field in accordance with the first indication that the PPDU is associated with the ELR format.

In some examples, the ELR sequence component 1530 is configurable or configured to transmit, via a set of ELR symbols of a PPDU, a first ELR sequence, where the first ELR sequence corresponds to a first BSS associated with the PPDU in accordance with a mapping between a set of multiple ELR sequences and a set of multiple BSSs.

In some examples, the ELR sequence component 1530 is configurable or configured to select the first ELR sequence from the set of multiple ELR sequences in accordance with an intended receiver of the PPDU, where the first ELR sequence corresponds to the first BSS associated with the intended receiver of the PPDU.

In some examples, in accordance with the mapping, each BSS of the set of multiple BSSs corresponds to a respective ELR sequence of the set of multiple ELR sequences, the set of multiple BSSs including the first BSS and the set of multiple ELR sequences including the first ELR sequence. In some examples, each ELR sequence of the set of multiple ELR sequences corresponds to a respective BSS color value of a set of multiple BSS color values, each BSS color value corresponding to a respective BSS of the set of multiple BSSs. In some examples, the set of multiple ELR sequences includes a quantity of 64 ELR sequences in accordance with each BSS color value being associated with 6 bits.

In some examples, the set of multiple ELR sequences is selected from a set of multiple available sequences. In some examples, the set of multiple ELR sequences is selected from the set of multiple available sequences such that ELR sequences of the set of multiple ELR sequences are associated with relatively lower PAPRs across the set of ELR symbols as compared to a remainder of the set of multiple available sequences.

In some examples, the wireless communication device applies a fixed mask to each sequence of the set of multiple available sequences to obtain a masked set of multiple available sequences. In some examples, the set of multiple ELR sequences is selected from the masked set of multiple available sequences such that ELR sequences of the set of multiple ELR sequences are associated with relatively lower PAPRs across the set of ELR symbols as compared to a remainder of the masked set of multiple available sequences.

In some examples, the wireless communication device applies a modulation rotation to at least a subset of data tones associated with the set of ELR symbols to obtain a set of modulation rotated ELR symbols. In some examples, the set of multiple ELR sequences is selected from the set of multiple available sequences such that ELR sequences of the set of multiple ELR sequences are associated with relatively lower PAPRs across the set of modulation rotated ELR symbols as compared to a remainder of the set of multiple available sequences.

In some examples, the wireless communication device applies a fixed mask to each sequence of the set of multiple available sequences to obtain a masked set of multiple available sequences. In some examples, the wireless communication device applies a modulation rotation to at least a subset of data tones associated with the set of ELR symbols to obtain a set of modulation rotated ELR symbols. In some examples, the set of multiple ELR sequences is selected from the masked set of multiple available sequences such that ELR sequences of the set of multiple ELR sequences are associated with relatively lower PAPRs across the set of modulation rotated ELR symbols as compared to a remainder of the masked set of multiple available sequences.

In some examples, the set of ELR symbols includes a first ELR symbol and a second ELR symbol. In some examples, the first ELR sequence is a length-96 sequence. In some examples, a first half of the first ELR sequence is mapped to a first set of data tones associated with the first ELR symbol and a second half of the first ELR sequence is mapped to a second set of data tones associated with the second ELR symbol.

In some examples, the first ELR sequence may be associated with a QBPSK modulation scheme in accordance with the PPDU excluding a U-SIG field. In some examples, the first ELR sequence may be associated with a BPSK modulation scheme, a QBPSK modulation scheme, or a modulation scheme associated with a tone-by-tone alternation between BPSK and QBPSK in accordance with the set of ELR symbols being present after a U-SIG field of the PPDU.

In some examples, the ELR-SIG component 1535 is configurable or configured to transmit, via a preamble portion of a PPDU associated with an ELR format, an ELR-SIG field that includes an uplink/downlink indicator subfield, a length subfield, a coding indicator subfield, and an MCS subfield. In some examples, the ELR-data component 1540 is configurable or configured to transmit, via a data portion of the PPDU associated with the ELR format, an ELR-data field in accordance with one or more of the uplink/downlink indicator subfield, the length subfield, the coding indicator subfield, and the MCS subfield included by the ELR-SIG field.

In some examples, the ELR training field component 1550 is configurable or configured to transmit, via the preamble portion of the PPDU associated with the ELR format, an ELR-LTF, where the ELR-SIG field is located after the ELR-LTF. In some examples, the ELR-SIG field is located immediately after the ELR-LTF. In some examples, the ELR-SIG field further includes a BSS color subfield. In some examples, the ELR-SIG field further includes a version number subfield. In some examples, the version number subfield includes two bits and the length subfield includes six or eight bits. In some examples, the length subfield indicates a quantity of symbols associated with a 4× symbol duration. In some examples, the ELR-LTF, the ELR-SIG field, and the ELR-data field are associated with a same dRU size. In some examples, the ELR-SIG field and the ELR-data field are associated with a same modulation scheme. In some examples, the ELR-SIG field is associated with a 4× symbol operation.

In some examples, the ELR training field component 1550 is configurable or configured to transmit, via the preamble portion of the PPDU associated with the ELR format, one or both of an ELR-STF or an ELR-LTF, where the ELR-SIG field is located prior to the ELR-STF or the ELR-LTF. In some examples, the ELR-SIG field is located immediately prior to the ELR-STF or the ELR-LTF. In some examples, the ELR-SIG field further includes a BSS color subfield. In some examples, the ELR-SIG field further includes a STA identifier subfield. In some examples, the ELR-SIG field further includes a version number subfield. In some examples, the version number subfield includes two bits and the length subfield includes six or eight bits. In some examples, the length subfield indicates a quantity of symbols associated with a 4× symbol duration.

In some examples, the ELR-SIG field is associated with a 1× symbol operation. In some examples, an initial symbol of the ELR-SIG field includes a guard interval. In some examples, one or more symbols of the ELR-SIG field after the initial symbol exclude guard intervals. In some examples, the ELR-data field is associated with a 1× symbol operation.

In some examples, the ELR-SIG field and the ELR-data field are associated with a coding rate of one-third in accordance with being associated with a dRU size of 52 tones. In some examples, the ELR-SIG field and the ELR-data field are associated with a coding rate of two-thirds and a 2× coded bits repetition in accordance with being associated with a BPSK modulation scheme. In some examples, the ELR-SIG field and the ELR-data field are associated with a coding rate of one-half and a 3× coded bits repetition in accordance with being associated with a QPSK modulation scheme. In some examples, the ELR-SIG field and the ELR-data field are associated with a concatenation of an outer code with a repetition coding. In some examples, the repetition coding is performed prior to an interleaving.

In some examples, the ELR-SIG field and the ELR-data field are associated with a 26-tone RU and a duplication over a quantity of 26-tone RUs. In some examples, the duplication includes 9× duplication. In some examples, the quantity of 26-tone RUs includes nine 26-tone RUs. In some examples, the ELR-SIG field and the ELR-data field are associated with a 52-tone RU and a duplication over a quantity of 52-tone RUs. In some examples, the duplication includes 4× duplication. In some examples, the quantity of 52-tone RUs includes four 52-tone RUs. In some examples, the ELR-SIG field and the ELR-data field are associated with a 106-tone RU and a duplication over a quantity of 106-tone RUs. In some examples, the duplication includes 2× duplication. In some examples, the quantity of 106-tone RUs includes two 106-tone RUs.

In some examples, the preamble portion of the PPDU further includes an ELR-STF and an ELR-LTF. In some examples, the ELR-SIG field and the ELR-data field include a set of multiple pilot tones. In some examples, the ELR-STF, the ELR-LTF, and the set of multiple pilot tones are associated with an OFDMA transmission format.

In some examples, the ELR-SIG field and the ELR-data field are associated with a set of multiple symbols. In some examples, the set of multiple symbols is associated with a set of multiple tones. In some examples, a modulation rotation is applied to at least a subset of the set of multiple tones.

In some examples, the ELR-SIG field and the ELR-data field are associated with a set of multiple symbols. In some examples, the set of multiple symbols is associated with a set of multiple tones. In some examples, a mask is applied to the set of multiple tones.

FIG. 16 shows a flowchart illustrating an example process 1600 performable by or at a wireless communication device that supports signaling designs for ELR transmission. The operations of the process 1600 may be implemented by a wireless communication device or its components as described herein. For example, the process 1600 may be performed by a wireless communication device, such as the wireless communication device 1500 described with reference to FIG. 15, operating as or within a wireless AP or a wireless STA. In some examples, the process 1600 may be performed by a wireless AP or a wireless STA, such as one of the APs 102 or the STAs 104 described with reference to FIG. 1.

In some examples, in 1605, the wireless communication device may receive, via a U-SIG field of a PPDU, a first indication that the PPDU is associated with an ELR format, where a first subfield of the U-SIG field includes the first indication. The operations of 1605 may be performed in accordance with examples as disclosed herein. In some implementations, aspects of the operations of 1605 may be performed by a U-SIG component 1525 as described with reference to FIG. 15.

In some examples, in 1610, the wireless communication device may receive, via the U-SIG field of the PPDU, a second indication of a first STA identifier associated with the PPDU, where a second subfield of the U-SIG field includes the second indication. The operations of 1610 may be performed in accordance with examples as disclosed herein. In some implementations, aspects of the operations of 1610 may be performed by a U-SIG component 1525 as described with reference to FIG. 15.

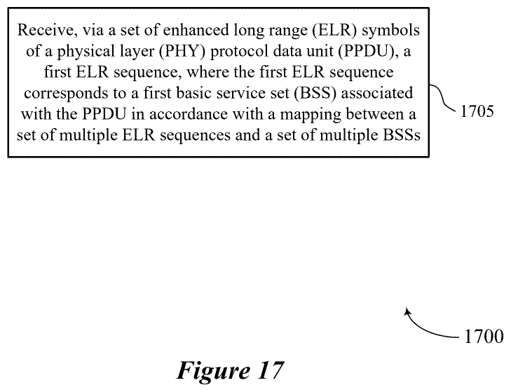

FIG. 17 shows a flowchart illustrating an example process 1700 performable by or at a wireless communication device that supports signaling designs for ELR transmission. The operations of the process 1700 may be implemented by a wireless communication device or its components as described herein. For example, the process 1700 may be performed by a wireless communication device, such as the wireless communication device 1500 described with reference to FIG. 15, operating as or within a wireless AP or a wireless STA. In some examples, the process 1700 may be performed by a wireless AP or a wireless STA, such as one of the APs 102 or the STAs 104 described with reference to FIG. 1.

In some examples, in 1705, the wireless communication device may receive, via a set of ELR symbols of a PPDU, a first ELR sequence, where the first ELR sequence corresponds to a first BSS associated with the PPDU in accordance with a mapping between a set of multiple ELR sequences and a set of multiple BSSs. The operations of 1705 may be performed in accordance with examples as disclosed herein. In some implementations, aspects of the operations of 1705 may be performed by an ELR sequence component 1530 as described with reference to FIG. 15.

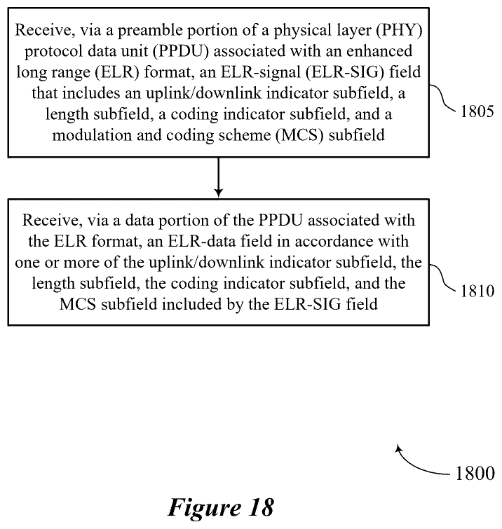

FIG. 18 shows a flowchart illustrating an example process 1800 performable by or at a wireless communication device that supports signaling designs for ELR transmission. The operations of the process 1800 may be implemented by a wireless communication device or its components as described herein. For example, the process 1800 may be performed by a wireless communication device, such as the wireless communication device 1500 described with reference to FIG. 15, operating as or within a wireless AP or a wireless STA. In some examples, the process 1800 may be performed by a wireless AP or a wireless STA, such as one of the APs 102 or the STAs 104 described with reference to FIG. 1.

In some examples, in 1805, the wireless communication device may receive, via a preamble portion of a PPDU associated with an ELR format, an ELR-SIG field that includes an uplink/downlink indicator subfield, a length subfield, a coding indicator subfield, and an MCS subfield. The operations of 1805 may be performed in accordance with examples as disclosed herein. In some implementations, aspects of the operations of 1805 may be performed by an ELR-SIG component 1535 as described with reference to FIG. 15.

In some examples, in 1810, the wireless communication device may receive, via a data portion of the PPDU associated with the ELR format, an ELR-data field in accordance with one or more of the uplink/downlink indicator subfield, the length subfield, the coding indicator subfield, and the MCS subfield included by the ELR-SIG field. The operations of 1810 may be performed in accordance with examples as disclosed herein. In some implementations, aspects of the operations of 1810 may be performed by an ELR-data component 1540 as described with reference to FIG. 15.

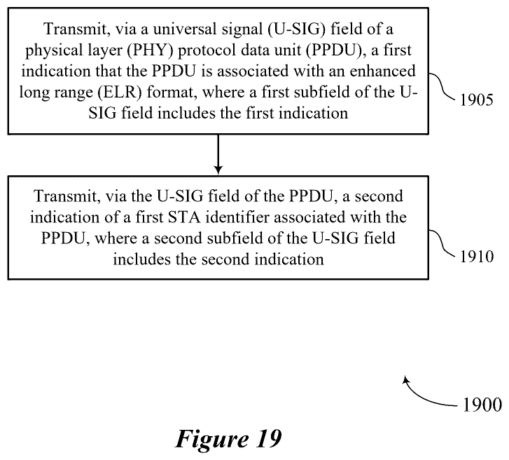

FIG. 19 shows a flowchart illustrating an example process 1900 performable by or at a wireless communication device that supports signaling designs for ELR transmission. The operations of the process 1900 may be implemented by a wireless communication device or its components as described herein. For example, the process 1900 may be performed by a wireless communication device, such as the wireless communication device 1500 described with reference to FIG. 15, operating as or within a wireless AP or a wireless STA. In some examples, the process 1900 may be performed by a wireless AP or a wireless STA, such as one of the APs 102 or the STAs 104 described with reference to FIG. 1.

In some examples, in 1905, the wireless communication device may transmit, via a U-SIG field of a PPDU, a first indication that the PPDU is associated with an ELR format, where a first subfield of the U-SIG field includes the first indication. The operations of 1905 may be performed in accordance with examples as disclosed herein. In some implementations, aspects of the operations of 1905 may be performed by a U-SIG component 1525 as described with reference to FIG. 15.

In some examples, in 1910, the wireless communication device may transmit, via the U-SIG field of the PPDU, a second indication of a first STA identifier associated with the PPDU, where a second subfield of the U-SIG field includes the second indication. The operations of 1910 may be performed in accordance with examples as disclosed herein. In some implementations, aspects of the operations of 1910 may be performed by a U-SIG component 1525 as described with reference to FIG. 15.

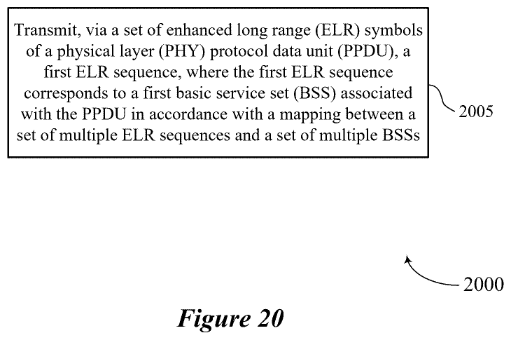

FIG. 20 shows a flowchart illustrating an example process 2000 performable by or at a wireless communication device that supports signaling designs for ELR transmission. The operations of the process 2000 may be implemented by a wireless communication device or its components as described herein. For example, the process 2000 may be performed by a wireless communication device, such as the wireless communication device 1500 described with reference to FIG. 15, operating as or within a wireless AP or a wireless STA. In some examples, the process 2000 may be performed by a wireless AP or a wireless STA, such as one of the APs 102 or the STAs 104 described with reference to FIG. 1.

In some examples, in 2005, the wireless communication device may transmit, via a set of ELR symbols of a PPDU, a first ELR sequence, where the first ELR sequence corresponds to a first BSS associated with the PPDU in accordance with a mapping between a set of multiple ELR sequences and a set of multiple BSSs. The operations of 2005 may be performed in accordance with examples as disclosed herein. In some implementations, aspects of the operations of 2005 may be performed by an ELR sequence component 1530 as described with reference to FIG. 15.

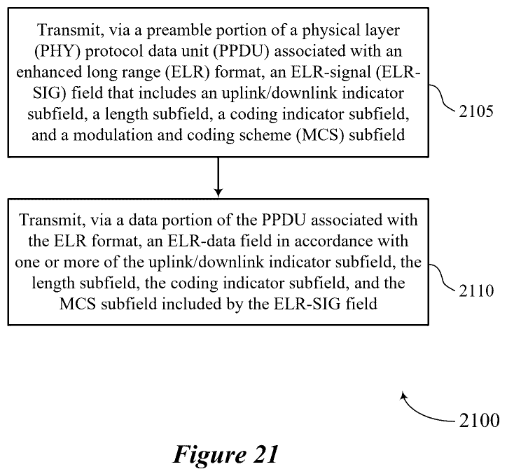

FIG. 21 shows a flowchart illustrating an example process 2100 performable by or at a wireless communication device that supports signaling designs for ELR transmission. The operations of the process 2100 may be implemented by a wireless communication device or its components as described herein. For example, the process 2100 may be performed by a wireless communication device, such as the wireless communication device 1500 described with reference to FIG. 15, operating as or within a wireless AP or a wireless STA. In some examples, the process 2100 may be performed by a wireless AP or a wireless STA, such as one of the APs 102 or the STAs 104 described with reference to FIG. 1.

In some examples, in 2105, the wireless communication device may transmit, via a preamble portion of a PPDU associated with an ELR format, an ELR-SIG field that includes an uplink/downlink indicator subfield, a length subfield, a coding indicator subfield, and an MCS subfield. The operations of 2105 may be performed in accordance with examples as disclosed herein. In some implementations, aspects of the operations of 2105 may be performed by an ELR-SIG component 1535 as described with reference to FIG. 15.

In some examples, in 2110, the wireless communication device may transmit, via a data portion of the PPDU associated with the ELR format, an ELR-data field in accordance with one or more of the uplink/downlink indicator subfield, the length subfield, the coding indicator subfield, and the MCS subfield included by the ELR-SIG field. The operations of 2110 may be performed in accordance with examples as disclosed herein. In some implementations, aspects of the operations of 2110 may be performed by an ELR-data component 1540 as described with reference to FIG. 15.

Implementation examples are described in the following numbered clauses:

Clause 1: A method for wireless communication at a wireless communication device, including: receiving, via a U-SIG field of a PPDU, a first indication that the PPDU is associated with an ELR format, where a first subfield of the U-SIG field includes the first indication; and receiving, via the U-SIG field of the PPDU, a second indication of a first STA identifier associated with the PPDU, where a second subfield of the U-SIG field includes the second indication.

Clause 2: The method of clause 1, where the U-SIG field excludes a puncture channel information subfield, an MCS subfield, a quantity of symbols subfield, and a spatial reuse subfield.

Clause 3: The method of any of clauses 1-2, further including: selectively parsing a remainder of the PPDU that follows the U-SIG field in accordance with at least the first indication.

Clause 4: The method of clause 3, where selectively parsing the remainder of the PPDU that follows the U-SIG field includes: parsing the remainder of the PPDU in accordance with the wireless communication device being an ELR-capable device and a second STA identifier associated with the wireless communication device matching the first STA identifier associated with the PPDU.

Clause 5: The method of any of clauses 3-4, where selectively parsing the remainder of the PPDU that follows the U-SIG field includes: dropping the remainder of the PPDU in accordance with at least one of the wireless communication device being a non-ELR-capable device or a second STA identifier associated with the wireless communication device being different than the first STA identifier associated with the PPDU.

Clause 6: The method of any of clauses 1-5, where the first subfield is a version identifier subfield within a version independent portion of the U-SIG field.

Clause 7: The method of clause 6, where the version identifier subfield includes a set of multiple bits, and a codepoint indicated by the set of multiple bits of the version identifier subfield indicates that the PPDU is associated with the ELR format.

Clause 8: The method of clause 7, where the set of multiple bits of the version identifier subfield is associated with a set of multiple valid codepoints, and the set of multiple valid codepoints includes the codepoint that indicates that the PPDU is associated with the ELR format, a second codepoint that indicates that the PPDU is associated with a UHR format, and a third codepoint that indicates that the PPDU is associated with an EHT format.

Clause 9: The method of any of clauses 6-8, where the U-SIG field includes five validate bits within a version dependent portion of the U-SIG field in accordance with the first subfield being the version identifier subfield within the version independent portion of the U-SIG field.

Clause 10: The method of any of clauses 1-9, where the first subfield is an ELR subfield within a version dependent portion of the U-SIG field, and the ELR subfield is present within the U-SIG field in accordance with a codepoint indicated by a version identifier subfield within a version independent portion of the U-SIG field.

Clause 11: The method of clause 10, where the ELR subfield includes one or more bits, and a value indicated by the one or more bits of the ELR subfield indicates that the PPDU is associated with the ELR format.

Clause 12: The method of clause 11, where the one or more bits of the ELR subfield are associated with four valid values, and the four valid values include the value that indicates that the PPDU is associated with the ELR format and at least one value that indicates that the PPDU is associated with a non-ELR format.

Clause 13: The method of any of clauses 10-12, where the U-SIG field includes three validate bits within the version dependent portion of the U-SIG field in accordance with the first subfield being the ELR subfield within the version dependent portion of the U-SIG field.

Clause 14: The method of any of clauses 1-13, where the second subfield is a STA identifier subfield within a version dependent portion of the U-SIG field, and the STA identifier subfield is present within the U-SIG field in accordance with the first indication that the PPDU is associated with the ELR format.

Clause 15: A method for wireless communication at a wireless communication device, including: receiving, via a set of ELR symbols of a PPDU, a first ELR sequence, where the first ELR sequence corresponds to a first BSS associated with the PPDU in accordance with a mapping between a set of multiple ELR sequences and a set of multiple BSSs.

Clause 16: The method of clause 15, further including: selectively parsing a remainder of the PPDU that follows the set of ELR symbols in accordance with the PPDU being associated with the first BSS.

Clause 17: The method of clause 16, further including: communicating, via one or more association frames, information indicative of a second BSS associated with the wireless communication device, where the second BSS corresponds to a second ELR sequence in accordance with the mapping, and where selectively parsing the remainder of the PPDU that follows the set of ELR symbols is in accordance with a correlation between the first ELR sequence and the second ELR sequence.

Clause 18: The method of clause 17, where selectively parsing the remainder of the PPDU that follows the set of ELR symbols includes: parsing at least a portion of the remainder of the PPDU in accordance with the correlation between the first ELR sequence and the second ELR sequence satisfying a threshold correlation level.

Clause 19: The method of clause 18, where in accordance with satisfying the threshold correlation level, the first ELR sequence and the second ELR sequence are a same sequence and, in accordance with the first ELR sequence and the second ELR sequence being the same sequence, the first BSS and the second BSS are a same BSS.

Clause 20: The method of any of clauses 17-19, where selectively parsing the remainder of the PPDU that follows the set of ELR symbols includes: dropping the remainder of the PPDU in accordance with the correlation between the first ELR sequence and the second ELR sequence failing to satisfy a threshold correlation level.

Clause 21: The method of clause 20, where in accordance with failing to satisfy the threshold correlation level, the first ELR sequence and the second ELR sequence are different and, in accordance with the first ELR sequence and the second ELR sequence being different, the first BSS and the second BSS are different.

Clause 22: The method of any of clauses 15-21, where in accordance with the mapping, each BSS of the set of multiple BSSs corresponds to a respective ELR sequence of the set of multiple ELR sequences, the set of multiple BSSs including the first BSS and the set of multiple ELR sequences including the first ELR sequence.

Clause 23: The method of clause 22, where each ELR sequence of the set of multiple ELR sequences corresponds to a respective BSS color value of a set of multiple BSS color values, each BSS color value corresponding to a respective BSS of the set of multiple BSSs.

Clause 24: The method of clause 23, where the set of multiple ELR sequences includes a quantity of 64 ELR sequences in accordance with each BSS color value being associated with 6 bits.

Clause 25: The method of any of clauses 22-24, where the set of multiple ELR sequences is selected from a set of multiple available sequences.

Clause 26: The method of clause 25, where the set of multiple ELR sequences is selected from the set of multiple available sequences such that ELR sequences of the set of multiple ELR sequences are associated with relatively lower PAPRs across the set of ELR symbols as compared to a remainder of the set of multiple available sequences.

Clause 27: The method of any of clauses 25-26, where the wireless communication device applies a fixed mask to each sequence of the set of multiple available sequences to obtain a masked set of multiple available sequences; and the set of multiple ELR sequences is selected from the masked set of multiple available sequences such that ELR sequences of the set of multiple ELR sequences are associated with relatively lower PAPRs across the set of ELR symbols as compared to a remainder of the masked set of multiple available sequences.

Clause 28: The method of any of clauses 25-27, where the wireless communication device applies a modulation rotation to at least a subset of data tones associated with the set of ELR symbols to obtain a set of modulation rotated ELR symbols; and the set of multiple ELR sequences is selected from the set of multiple available sequences such that ELR sequences of the set of multiple ELR sequences are associated with relatively lower PAPRs across the set of modulation rotated ELR symbols as compared to a remainder of the set of multiple available sequences.

Clause 29: The method of any of clauses 25-28, where the wireless communication device applies a fixed mask to each sequence of the set of multiple available sequences to obtain a masked set of multiple available sequences; the wireless communication device applies a modulation rotation to at least a subset of data tones associated with the set of ELR symbols to obtain a set of modulation rotated ELR symbols; and the set of multiple ELR sequences is selected from the masked set of multiple available sequences such that ELR sequences of the set of multiple ELR sequences are associated with relatively lower PAPRs across the set of modulation rotated ELR symbols as compared to a remainder of the masked set of multiple available sequences.

Clause 30: The method of any of clauses 15-29, where the set of ELR symbols includes a first ELR symbol and a second ELR symbol, the first ELR sequence is a length-96 sequence, and a first half of the first ELR sequence is mapped to a first set of data tones associated with the first ELR symbol and a second half of the first ELR sequence is mapped to a second set of data tones associated with the second ELR symbol.

Clause 31: The method of any of clauses 15-30, where the first ELR sequence is associated with a QBPSK modulation scheme in accordance with the PPDU excluding a U-SIG field.

Clause 32: The method of any of clauses 15-31, where the first ELR sequence is associated with a BPSK modulation scheme, a QBPSK modulation scheme, or a modulation scheme associated with a tone-by-tone alternation between BPSK and QBPSK in accordance with the set of ELR symbols being present after a U-SIG field of the PPDU.

Clause 33: A method for wireless communication at a wireless communication device, including: receiving, via a preamble portion of a PPDU associated with an ELR format, an ELR-SIG field that includes an uplink/downlink indicator subfield, a length subfield, a coding indicator subfield, and an MCS subfield; and receiving, via a data portion of the PPDU associated with the ELR format, an ELR-data field in accordance with one or more of the uplink/downlink indicator subfield, the length subfield, the coding indicator subfield, and the MCS subfield included by the ELR-SIG field.

Clause 34: The method of clause 33, further including: receiving, via the preamble portion of the PPDU associated with the ELR format, an ELR-LTF, where the ELR-SIG field is located after the ELR-LTF.

Clause 35: The method of clause 34, where the ELR-SIG field is located immediately after the ELR-LTF.

Clause 36: The method of any of clauses 34-35, where the ELR-SIG field further includes a BSS color subfield.

Clause 37: The method of any of clauses 34-36, where the ELR-SIG field further includes a version number subfield.

Clause 38: The method of clause 37, where the version number subfield includes two bits and the length subfield includes six or eight bits.

Clause 39: The method of any of clauses 37-38, where the length subfield indicates a quantity of symbols associated with a 4× symbol duration.

Clause 40: The method of any of clauses 34-39, where the ELR-LTF, the ELR-SIG field, and the ELR-data field are associated with a same dRU size.

Clause 41: The method of any of clauses 34-40, where the ELR-SIG field and the ELR-data field are associated with a same modulation scheme.

Clause 42: The method of any of clauses 34-41, where the ELR-SIG field is associated with a 4× symbol operation.

Clause 43: The method of any of clauses 33-42, further including: receiving, via the preamble portion of the PPDU associated with the ELR format, one or both of an ELR-STF or an ELR-LTF, where the ELR-SIG field is located prior to the ELR-STF or the ELR-LTF.

Clause 44: The method of clause 43, where the ELR-SIG field is located immediately prior to the ELR-STF or the ELR-LTF.

Clause 45: The method of any of clauses 43-44, where the ELR-SIG field further includes a BSS color subfield.

Clause 46: The method of any of clauses 43-45, where the ELR-SIG field further includes a STA identifier subfield.

Clause 47: The method of any of clauses 43-46, where the ELR-SIG field further includes a version number subfield.

Clause 48: The method of clause 47, where the version number subfield includes two bits and the length subfield includes six or eight bits.

Clause 49: The method of any of clauses 47-48, where the length subfield indicates a quantity of symbols associated with a 4× symbol duration.

Clause 50: The method of any of clauses 43-49, where the ELR-SIG field is associated with a 1× symbol operation, an initial symbol of the ELR-SIG field includes a guard interval, and one or more symbols of the ELR-SIG field after the initial symbol exclude guard intervals.

Clause 51: The method of any of clauses 43-50, where the ELR-data field is associated with a 1× symbol operation.

Clause 52: The method of any of clauses 33-51, where the ELR-SIG field and the ELR-data field are associated with a coding rate of one-third in accordance with being associated with a dRU size of 52 tones.

Clause 53: The method of any of clauses 33-52, where the ELR-SIG field and the ELR-data field are associated with a coding rate of two-thirds and a 2× coded bits repetition in accordance with being associated with a BPSK modulation scheme.

Clause 54: The method of any of clauses 33-53, where the ELR-SIG field and the ELR-data field are associated with a coding rate of one-half and a 3× coded bits repetition in accordance with being associated with a QPSK modulation scheme.

Clause 55: The method of any of clauses 33-54, where the ELR-SIG field and the ELR-data field are associated with a concatenation of an outer code with a repetition coding, the repetition coding is performed prior to an interleaving.

Clause 56: The method of any of clauses 33-55, where the ELR-SIG field and the ELR-data field are associated with a 26-tone RU and a duplication over a quantity of 26-tone RUs.

Clause 57: The method of clause 56, where the duplication includes 9× duplication, and the quantity of 26-tone RUs includes nine 26-tone RUs.

Clause 58: The method of any of clauses 33-57, where the ELR-SIG field and the ELR-data field are associated with a 52-tone RU and a duplication over a quantity of 52-tone RUs.

Clause 59: The method of clause 58, where the duplication includes 4× duplication, and the quantity of 52-tone RUs includes four 52-tone RUs.

Clause 60: The method of any of clauses 33-59, where the ELR-SIG field and the ELR-data field are associated with a 106-tone RU and a duplication over a quantity of 106-tone RUs.

Clause 61: The method of clause 60, where the duplication includes 2× duplication, and the quantity of 106-tone RUs includes two 106-tone RUs.

Clause 62: The method of any of clauses 33-61, where the preamble portion of the PPDU further includes an ELR-STF and an ELR-LTF, the ELR-SIG field and the ELR-data field include a set of multiple pilot tones, and the ELR-STF, the ELR-LTF, and the set of multiple pilot tones are associated with an OFDMA transmission format.

Clause 63: The method of any of clauses 33-62, where the ELR-SIG field and the ELR-data field are associated with a set of multiple symbols, the set of multiple symbols is associated with a set of multiple tones, and a modulation rotation is applied to at least a subset of the set of multiple tones.

Clause 64: The method of any of clauses 33-63, where the ELR-SIG field and the ELR-data field are associated with a set of multiple symbols, the set of multiple symbols is associated with a set of multiple tones, and a mask is applied to the set of multiple tones.

Clause 65: A method for wireless communication at a wireless communication device, including: transmitting, via a U-SIG field of a PPDU, a first indication that the PPDU is associated with an ELR format, where a first subfield of the U-SIG field includes the first indication; and transmitting, via the U-SIG field of the PPDU, a second indication of a first STA identifier associated with the PPDU, where a second subfield of the U-SIG field includes the second indication.

Clause 66: The method of clause 65, where the U-SIG field excludes a puncture channel information subfield, an MCS subfield, a quantity of symbols subfield, and a spatial reuse subfield.

Clause 67: The method of any of clauses 65-66, further including: generating the U-SIG field of the PPDU in accordance with the PPDU being associated with the ELR format and in accordance with an intended receiver of the PPDU, where the intended receiver of the PPDU is associated with the first STA identifier.

Clause 68: The method of any of clauses 65-67, where the first subfield is a version identifier subfield within a version independent portion of the U-SIG field.

Clause 69: The method of clause 68, where the version identifier subfield includes a set of multiple bits, and a codepoint indicated by the set of multiple bits of the version identifier subfield indicates that the PPDU is associated with the ELR format.

Clause 70: The method of clause 69, where the set of multiple bits of the version identifier subfield is associated with a set of multiple valid codepoints, and the set of multiple valid codepoints includes the codepoint that indicates that the PPDU is associated with the ELR format, a second codepoint that indicates that the PPDU is associated with a UHR format, and a third codepoint that indicates that the PPDU is associated with an EHT format.

Clause 71: The method of any of clauses 68-70, where the U-SIG field includes five validate bits within a version dependent portion of the U-SIG field in accordance with the first subfield being the version identifier subfield within the version independent portion of the U-SIG field.

Clause 72: The method of any of clauses 65-71, where the first subfield is an ELR subfield within a version dependent portion of the U-SIG field, and the ELR subfield is present within the U-SIG field in accordance with a codepoint indicated by a version identifier subfield within a version independent portion of the U-SIG field.

Clause 73: The method of clause 72, where the ELR subfield includes one or more bits, and a value indicated by the one or more bits of the ELR subfield indicates that the PPDU is associated with the ELR format.

Clause 74: The method of clause 73, where the one or more bits of the ELR subfield are associated with four valid values, and the four valid values include the value that indicates that the PPDU is associated with the ELR format and at least one value that indicates that the PPDU is associated with a non-ELR format.

Clause 75: The method of any of clauses 72-74, where the U-SIG field includes three validate bits within the version dependent portion of the U-SIG field in accordance with the first subfield being the ELR subfield within the version dependent portion of the U-SIG field.

Clause 76: The method of any of clauses 65-75, where the second subfield is a STA identifier subfield within a version dependent portion of the U-SIG field, and the STA identifier subfield is present within the U-SIG field in accordance with the first indication that the PPDU is associated with the ELR format.

Clause 77: A method for wireless communication at a wireless communication device, including: transmitting, via a set of ELR symbols of a PPDU, a first ELR sequence, where the first ELR sequence corresponds to a first BSS associated with the PPDU in accordance with a mapping between a set of multiple ELR sequences and a set of multiple BSSs.

Clause 78: The method of clause 77, further including: selecting the first ELR sequence from the set of multiple ELR sequences in accordance with an intended receiver of the PPDU, where the first ELR sequence corresponds to the first BSS associated with the intended receiver of the PPDU.

Clause 79: The method of any of clauses 77-78, where in accordance with the mapping, each BSS of the set of multiple BSSs corresponds to a respective ELR sequence of the set of multiple ELR sequences, the set of multiple BSSs including the first BSS and the set of multiple ELR sequences including the first ELR sequence.

Clause 80: The method of clause 79, where each ELR sequence of the set of multiple ELR sequences corresponds to a respective BSS color value of a set of multiple BSS color values, each BSS color value corresponding to a respective BSS of the set of multiple BSSs.

Clause 81: The method of clause 80, where the set of multiple ELR sequences includes a quantity of 64 ELR sequences in accordance with each BSS color value being associated with 6 bits.

Clause 82: The method of any of clauses 79-81, where the set of multiple ELR sequences is selected from a set of multiple available sequences.

Clause 83: The method of clause 82, where the set of multiple ELR sequences is selected from the set of multiple available sequences such that ELR sequences of the set of multiple ELR sequences are associated with relatively lower PAPRs across the set of ELR symbols as compared to a remainder of the set of multiple available sequences.

Clause 84: The method of any of clauses 82-83, where the wireless communication device applies a fixed mask to each sequence of the set of multiple available sequences to obtain a masked set of multiple available sequences; and the set of multiple ELR sequences is selected from the masked set of multiple available sequences such that ELR sequences of the set of multiple ELR sequences are associated with relatively lower PAPRs across the set of ELR symbols as compared to a remainder of the masked set of multiple available sequences.

Clause 85: The method of any of clauses 82-84, where the wireless communication device applies a modulation rotation to at least a subset of data tones associated with the set of ELR symbols to obtain a set of modulation rotated ELR symbols; and the set of multiple ELR sequences is selected from the set of multiple available sequences such that ELR sequences of the set of multiple ELR sequences are associated with relatively lower PAPRs across the set of modulation rotated ELR symbols as compared to a remainder of the set of multiple available sequences.

Clause 86: The method of any of clauses 82-85, where the wireless communication device applies a fixed mask to each sequence of the set of multiple available sequences to obtain a masked set of multiple available sequences; the wireless communication device applies a modulation rotation to at least a subset of data tones associated with the set of ELR symbols to obtain a set of modulation rotated ELR symbols; and the set of multiple ELR sequences is selected from the masked set of multiple available sequences such that ELR sequences of the set of multiple ELR sequences are associated with relatively lower PAPRs across the set of modulation rotated ELR symbols as compared to a remainder of the masked set of multiple available sequences.

Clause 87: The method of any of clauses 77-86, where the set of ELR symbols includes a first ELR symbol and a second ELR symbol, the first ELR sequence is a length-96 sequence, and a first half of the first ELR sequence is mapped to a first set of data tones associated with the first ELR symbol and a second half of the first ELR sequence is mapped to a second set of data tones associated with the second ELR symbol.

Clause 88: The method of any of clauses 77-87, where the first ELR sequence is associated with a QBPSK modulation scheme in accordance with the PPDU excluding a U-SIG field.

Clause 89: The method of any of clauses 77-88, where the first ELR sequence is associated with a BPSK modulation scheme, a QBPSK modulation scheme, or a modulation scheme associated with a tone-by-tone alternation between BPSK and QBPSK in accordance with the set of ELR symbols being present after a U-SIG field of the PPDU.

Clause 90: A method for wireless communication at a wireless communication device, including: transmitting, via a preamble portion of a PPDU associated with an ELR format, an ELR-SIG field that includes an uplink/downlink indicator subfield, a length subfield, a coding indicator subfield, and an MCS subfield; and transmitting, via a data portion of the PPDU associated with the ELR format, an ELR-data field in accordance with one or more of the uplink/downlink indicator subfield, the length subfield, the coding indicator subfield, and the MCS subfield included by the ELR-SIG field.

Clause 91: The method of clause 90, further including: transmitting, via the preamble portion of the PPDU associated with the ELR format, an ELR-LTF, where the ELR-SIG field is located after the ELR-LTF.

Clause 92: The method of clause 91, where the ELR-SIG field is located immediately after the ELR-LTF.

Clause 93: The method of any of clauses 91-92, where the ELR-SIG field further includes a BSS color subfield.

Clause 94: The method of any of clauses 91-93, where the ELR-SIG field further includes a version number subfield.

Clause 95: The method of clause 94, where the version number subfield includes two bits and the length subfield includes six or eight bits.

Clause 96: The method of any of clauses 94-95, where the length subfield indicates a quantity of symbols associated with a 4× symbol duration.

Clause 97: The method of any of clauses 91-96, where the ELR-LTF, the ELR-SIG field, and the ELR-data field are associated with a same dRU size.

Clause 98: The method of any of clauses 91-97, where the ELR-SIG field and the ELR-data field are associated with a same modulation scheme.

Clause 99: The method of any of clauses 91-98, where the ELR-SIG field is associated with a 4× symbol operation.

Clause 100: The method of any of clauses 90-99, further including: transmitting, via the preamble portion of the PPDU associated with the ELR format, one or both of an ELR-STF or an ELR-LTF, where the ELR-SIG field is located prior to the ELR-STF or the ELR-LTF.

Clause 101: The method of clause 100, where the ELR-SIG field is located immediately prior to the ELR-STF or the ELR-LTF.

Clause 102: The method of any of clauses 100-101, where the ELR-SIG field further includes a BSS color subfield.

Clause 103: The method of any of clauses 100-102, where the ELR-SIG field further includes a STA identifier subfield.

Clause 104: The method of any of clauses 100-103, where the ELR-SIG field further includes a version number subfield.

Clause 105: The method of clause 104, where the version number subfield includes two bits and the length subfield includes six or eight bits.

Clause 106: The method of any of clauses 104-105, where the length subfield indicates a quantity of symbols associated with a 4× symbol duration.

Clause 107: The method of any of clauses 100-106, where the ELR-SIG field is associated with a 1× symbol operation, an initial symbol of the ELR-SIG field includes a guard interval, and one or more symbols of the ELR-SIG field after the initial symbol exclude guard intervals.

Clause 108: The method of any of clauses 100-107, where the ELR-data field is associated with a 1× symbol operation.

Clause 109: The method of any of clauses 90-108, where the ELR-SIG field and the ELR-data field are associated with a coding rate of one-third in accordance with being associated with a dRU size of 52 tones.

Clause 110: The method of any of clauses 90-109, where the ELR-SIG field and the ELR-data field are associated with a coding rate of two-thirds and a 2× coded bits repetition in accordance with being associated with a BPSK modulation scheme.

Clause 111: The method of any of clauses 90-110, where the ELR-SIG field and the ELR-data field are associated with a coding rate of one-half and a 3× coded bits repetition in accordance with being associated with a QPSK modulation scheme.

Clause 112: The method of any of clauses 90-111, where the ELR-SIG field and the ELR-data field are associated with a concatenation of an outer code with a repetition coding, the repetition coding is performed prior to an interleaving.

Clause 113: The method of any of clauses 90-112, where the ELR-SIG field and the ELR-data field are associated with a 26-tone RU and a duplication over a quantity of 26-tone RUs.

Clause 114: The method of clause 113, where the duplication includes 9× duplication, and the quantity of 26-tone RUs includes nine 26-tone RUs.

Clause 115: The method of any of clauses 90-114, where the ELR-SIG field and the ELR-data field are associated with a 52-tone RU and a duplication over a quantity of 52-tone RUs.

Clause 116: The method of clause 115, where the duplication includes 4× duplication, and the quantity of 52-tone RUs includes four 52-tone RUs.

Clause 117: The method of any of clauses 90-116, where the ELR-SIG field and the ELR-data field are associated with a 106-tone RU and a duplication over a quantity of 106-tone RUs.

Clause 118: The method of clause 117, where the duplication includes 2× duplication, and the quantity of 106-tone RUs includes two 106-tone RUs.

Clause 119: The method of any of clauses 90-118, where the preamble portion of the PPDU further includes an ELR-STF and an ELR-LTF, the ELR-SIG field and the ELR-data field include a set of multiple pilot tones, and the ELR-STF, the ELR-LTF, and the set of multiple pilot tones are associated with an OFDMA transmission format.

Clause 120: The method of any of clauses 90-119, where the ELR-SIG field and the ELR-data field are associated with a set of multiple symbols, the set of multiple symbols is associated with a set of multiple tones, and a modulation rotation is applied to at least a subset of the set of multiple tones.

Clause 121: The method of any of clauses 90-120, where the ELR-SIG field and the ELR-data field are associated with a set of multiple symbols, the set of multiple symbols is associated with a set of multiple tones, and a mask is applied to the set of multiple tones.

Clause 122: A wireless communication device, including: a processing system that includes processor circuitry and memory circuitry that stores code, the processing system configured to cause the wireless communication device to: receive, via a U-SIG field of a PPDU, a first indication that the PPDU is associated with an ELR format, where a first subfield of the U-SIG field includes the first indication; and receive, via the U-SIG field of the PPDU, a second indication of a first STA identifier associated with the PPDU, where a second subfield of the U-SIG field includes the second indication.

Clause 123: The wireless communication device of clause 122, where the U-SIG field excludes a puncture channel information subfield, an MCS subfield, a quantity of symbols subfield, and a spatial reuse subfield.

Clause 124: The wireless communication device of any of clauses 122-123, where the processing system is further configured to cause the wireless communication device to: selectively parse a remainder of the PPDU that follows the U-SIG field in accordance with at least the first indication.

Clause 125: The wireless communication device of clause 124, where, to selectively parse the remainder of the PPDU that follows the U-SIG field, the processing system is configured to cause the wireless communication device to: parse the remainder of the PPDU in accordance with the wireless communication device being an ELR-capable device and a second STA identifier associated with the wireless communication device matching the first STA identifier associated with the PPDU.

Clause 126: The wireless communication device of any of clauses 124-125, where, to selectively parse the remainder of the PPDU that follows the U-SIG field, the processing system is configured to cause the wireless communication device to: drop the remainder of the PPDU in accordance with at least one of the wireless communication device being a non-ELR-capable device or a second STA identifier associated with the wireless communication device being different than the first STA identifier associated with the PPDU.

Clause 127: The wireless communication device of any of clauses 122-126, where the first subfield is a version identifier subfield within a version independent portion of the U-SIG field.

Clause 128: The wireless communication device of clause 127, where the version identifier subfield includes a set of multiple bits, and a codepoint indicated by the set of multiple bits of the version identifier subfield indicates that the PPDU is associated with the ELR format.

Clause 129: The wireless communication device of clause 128, where the set of multiple bits of the version identifier subfield is associated with a set of multiple valid codepoints, and the set of multiple valid codepoints includes the codepoint that indicates that the PPDU is associated with the ELR format, a second codepoint that indicates that the PPDU is associated with a UHR format, and a third codepoint that indicates that the PPDU is associated with an EHT format.

Clause 130: The wireless communication device of any of clauses 127-129, where the U-SIG field includes five validate bits within a version dependent portion of the U-SIG field in accordance with the first subfield being the version identifier subfield within the version independent portion of the U-SIG field.

Clause 131: The wireless communication device of any of clauses 122-130, where the first subfield is an ELR subfield within a version dependent portion of the U-SIG field, and the ELR subfield is present within the U-SIG field in accordance with a codepoint indicated by a version identifier subfield within a version independent portion of the U-SIG field.

Clause 132: The wireless communication device of clause 131, where the ELR subfield includes one or more bits, and a value indicated by the one or more bits of the ELR subfield indicates that the PPDU is associated with the ELR format.

Clause 133: The wireless communication device of clause 132, where: the one or more bits of the ELR subfield are associated with four valid values, and the four valid values include the value that indicates that the PPDU is associated with the ELR format and at least one value that indicates that the PPDU is associated with a non-ELR format.

Clause 134: The wireless communication device of any of clauses 131-133, where the U-SIG field includes three validate bits within the version dependent portion of the U-SIG field in accordance with the first subfield being the ELR subfield within the version dependent portion of the U-SIG field.

Clause 135: The wireless communication device of any of clauses 122-134, where the second subfield is a STA identifier subfield within a version dependent portion of the U-SIG field, and the STA identifier subfield is present within the U-SIG field in accordance with the first indication that the PPDU is associated with the ELR format.

Clause 136: A wireless communication device, including: a processing system that includes processor circuitry and memory circuitry that stores code, the processing system configured to cause the wireless communication device to: receive, via a set of ELR symbols of a PPDU, a first ELR sequence, where the first ELR sequence corresponds to a first BSS associated with the PPDU in accordance with a mapping between a set of multiple ELR sequences and a set of multiple BSSs.

Clause 137: The wireless communication device of clause 136, where the processing system is further configured to cause the wireless communication device to: selectively parse a remainder of the PPDU that follows the set of ELR symbols in accordance with the PPDU being associated with the first BSS.

Clause 138: The wireless communication device of clause 137, where the processing system is further configured to cause the wireless communication device to: communicate, via one or more association frames, information indicative of a second BSS associated with the wireless communication device, where the second BSS corresponds to a second ELR sequence in accordance with the mapping, and where selectively parsing the remainder of the PPDU that follows the set of ELR symbols is in accordance with a correlation between the first ELR sequence and the second ELR sequence.

Clause 139: The wireless communication device of clause 138, where, to selectively parse the remainder of the PPDU that follows the set of ELR symbols, the processing system is configured to cause the wireless communication device to: parse at least a portion of the remainder of the PPDU in accordance with the correlation between the first ELR sequence and the second ELR sequence satisfying a threshold correlation level.

Clause 140: The wireless communication device of clause 139, where in accordance with satisfying the threshold correlation level, the first ELR sequence and the second ELR sequence are a same sequence and, in accordance with the first ELR sequence and the second ELR sequence being the same sequence, the first BSS and the second BSS are a same BSS.

Clause 141: The wireless communication device of any of clauses 138-140, where, to selectively parse the remainder of the PPDU that follows the set of ELR symbols, the processing system is configured to cause the wireless communication device to: drop the remainder of the PPDU in accordance with the correlation between the first ELR sequence and the second ELR sequence failing to satisfy a threshold correlation level.

Clause 142: The wireless communication device of clause 141, where in accordance with failing to satisfy the threshold correlation level, the first ELR sequence and the second ELR sequence are different and, in accordance with the first ELR sequence and the second ELR sequence being different, the first BSS and the second BSS are different.

Clause 143: The wireless communication device of any of clauses 136-142, where in accordance with the mapping, each BSS of the set of multiple BSSs corresponds to a respective ELR sequence of the set of multiple ELR sequences, the set of multiple BSSs including the first BSS and the set of multiple ELR sequences including the first ELR sequence.

Clause 144: The wireless communication device of clause 143, where each ELR sequence of the set of multiple ELR sequences corresponds to a respective BSS color value of a set of multiple BSS color values, each BSS color value corresponding to a respective BSS of the set of multiple BSSs.

Clause 145: The wireless communication device of clause 144, where the set of multiple ELR sequences includes a quantity of 64 ELR sequences in accordance with each BSS color value being associated with 6 bits.

Clause 146: The wireless communication device of any of clauses 143-145, where the set of multiple ELR sequences is selected from a set of multiple available sequences.

Clause 147: The wireless communication device of clause 146, where the set of multiple ELR sequences is selected from the set of multiple available sequences such that ELR sequences of the set of multiple ELR sequences are associated with relatively lower PAPRs across the set of ELR symbols as compared to a remainder of the set of multiple available sequences.

Clause 148: The wireless communication device of any of clauses 146-147, where the wireless communication device applies a fixed mask to each sequence of the set of multiple available sequences to obtain a masked set of multiple available sequences; and the set of multiple ELR sequences is selected from the masked set of multiple available sequences such that ELR sequences of the set of multiple ELR sequences are associated with relatively lower PAPRs across the set of ELR symbols as compared to a remainder of the masked set of multiple available sequences.

Clause 149: The wireless communication device of any of clauses 146-148, where the wireless communication device applies a modulation rotation to at least a subset of data tones associated with the set of ELR symbols to obtain a set of modulation rotated ELR symbols; and the set of multiple ELR sequences is selected from the set of multiple available sequences such that ELR sequences of the set of multiple ELR sequences are associated with relatively lower PAPRs across the set of modulation rotated ELR symbols as compared to a remainder of the set of multiple available sequences.

Clause 150: The wireless communication device of any of clauses 146-149, where the wireless communication device applies a fixed mask to each sequence of the set of multiple available sequences to obtain a masked set of multiple available sequences; the wireless communication device applies a modulation rotation to at least a subset of data tones associated with the set of ELR symbols to obtain a set of modulation rotated ELR symbols; and the set of multiple ELR sequences is selected from the masked set of multiple available sequences such that ELR sequences of the set of multiple ELR sequences are associated with relatively lower PAPRs across the set of modulation rotated ELR symbols as compared to a remainder of the masked set of multiple available sequences.

Clause 151: The wireless communication device of any of clauses 136-150, where the set of ELR symbols includes a first ELR symbol and a second ELR symbol, the first ELR sequence is a length-96 sequence, and a first half of the first ELR sequence is mapped to a first set of data tones associated with the first ELR symbol and a second half of the first ELR sequence is mapped to a second set of data tones associated with the second ELR symbol.

Clause 152: The wireless communication device of any of clauses 136-151, where the first ELR sequence is associated with a QBPSK modulation scheme in accordance with the PPDU excluding a U-SIG field.

Clause 153: The wireless communication device of any of clauses 136-152, where the first ELR sequence is associated with a BPSK modulation scheme, a QBPSK modulation scheme, or a modulation scheme associated with a tone-by-tone alternation between BPSK and QBPSK in accordance with the set of ELR symbols being present after a U-SIG field of the PPDU.

Clause 154: A wireless communication device, including: a processing system that includes processor circuitry and memory circuitry that stores code, the processing system configured to cause the wireless communication device to: receive, via a preamble portion of a PPDU associated with an ELR format, an ELR-SIG field that includes an uplink/downlink indicator subfield, a length subfield, a coding indicator subfield, and an MCS subfield; and receive, via a data portion of the PPDU associated with the ELR format, an ELR-data field in accordance with one or more of the uplink/downlink indicator subfield, the length subfield, the coding indicator subfield, and the MCS subfield included by the ELR-SIG field.

Clause 155: The wireless communication device of clause 154, where the processing system is further configured to cause the wireless communication device to: receive, via the preamble portion of the PPDU associated with the ELR format, an ELR-LTF, where the ELR-SIG field is located after the ELR-LTF.

Clause 156: The wireless communication device of clause 155, where the ELR-SIG field is located immediately after the ELR-LTF.

Clause 157: The wireless communication device of any of clauses 155-156, where the ELR-SIG field further includes a BSS color subfield.

Clause 158: The wireless communication device of any of clauses 155-157, where the ELR-SIG field further includes a version number subfield.

Clause 159: The wireless communication device of clause 158, where the version number subfield includes two bits and the length subfield includes six or eight bits.

Clause 160: The wireless communication device of any of clauses 158-159, where the length subfield indicates a quantity of symbols associated with a 4× symbol duration.

Clause 161: The wireless communication device of any of clauses 155-160, where the ELR-LTF, the ELR-SIG field, and the ELR-data field are associated with a same dRU size.

Clause 162: The wireless communication device of any of clauses 155-161, where the ELR-SIG field and the ELR-data field are associated with a same modulation scheme.

Clause 163: The wireless communication device of any of clauses 155-162, where the ELR-SIG field is associated with a 4× symbol operation.

Clause 164: The wireless communication device of any of clauses 154-163, where the processing system is further configured to cause the wireless communication device to: receive, via the preamble portion of the PPDU associated with the ELR format, one or both of an ELR-STF or an ELR-LTF, where the ELR-SIG field is located prior to the ELR-STF or the ELR-LTF.

Clause 165: The wireless communication device of clause 164, where the ELR-SIG field is located immediately prior to the ELR-STF or the ELR-LTF.

Clause 166: The wireless communication device of any of clauses 164-165, where the ELR-SIG field further includes a BSS color subfield.

Clause 167: The wireless communication device of any of clauses 164-166, where the ELR-SIG field further includes a STA identifier subfield.

Clause 168: The wireless communication device of any of clauses 164-167, where the ELR-SIG field further includes a version number subfield.

Clause 169: The wireless communication device of clause 168, where the version number subfield includes two bits and the length subfield includes six or eight bits.

Clause 170: The wireless communication device of any of clauses 168-169, where the length subfield indicates a quantity of symbols associated with a 4× symbol duration.

Clause 171: The wireless communication device of any of clauses 164-170, where the ELR-SIG field is associated with a 1× symbol operation, an initial symbol of the ELR-SIG field includes a guard interval, and one or more symbols of the ELR-SIG field after the initial symbol exclude guard intervals.

Clause 172: The wireless communication device of any of clauses 164-171, where the ELR-data field is associated with a 1× symbol operation.

Clause 173: The wireless communication device of any of clauses 154-172, where the ELR-SIG field and the ELR-data field are associated with a coding rate of one-third in accordance with being associated with a dRU size of 52 tones.

Clause 174: The wireless communication device of any of clauses 154-173, where the ELR-SIG field and the ELR-data field are associated with a coding rate of two-thirds and a 2× coded bits repetition in accordance with being associated with a BPSK modulation scheme.

Clause 175: The wireless communication device of any of clauses 154-174, where the ELR-SIG field and the ELR-data field are associated with a coding rate of one-half and a 3× coded bits repetition in accordance with being associated with a QPSK modulation scheme.

Clause 176: The wireless communication device of any of clauses 154-175, where the ELR-SIG field and the ELR-data field are associated with a concatenation of an outer code with a repetition coding, the repetition coding is performed prior to an interleaving.

Clause 177: The wireless communication device of any of clauses 154-176, where the ELR-SIG field and the ELR-data field are associated with a 26-tone RU and a duplication over a quantity of 26-tone RUs.

Clause 178: The wireless communication device of clause 177, where: the duplication includes 9× duplication, and the quantity of 26-tone RUs includes nine 26-tone RUs.

Clause 179: The wireless communication device of any of clauses 154-178, where the ELR-SIG field and the ELR-data field are associated with a 52-tone RU and a duplication over a quantity of 52-tone RUs.

Clause 180: The wireless communication device of clause 179, where: the duplication includes 4× duplication, and the quantity of 52-tone RUs includes four 52-tone RUs.

Clause 181: The wireless communication device of any of clauses 154-180, where the ELR-SIG field and the ELR-data field are associated with a 106-tone RU and a duplication over a quantity of 106-tone RUs.

Clause 182: The wireless communication device of clause 181, where: the duplication includes 2× duplication, and the quantity of 106-tone RUs includes two 106-tone RUs.

Clause 183: The wireless communication device of any of clauses 154-182, where the preamble portion of the PPDU further includes an ELR-STF and an ELR-LTF, the ELR-SIG field and the ELR-data field include a set of multiple pilot tones, and the ELR-STF, the ELR-LTF, and the set of multiple pilot tones are associated with an OFDMA transmission format.

Clause 184: The wireless communication device of any of clauses 154-183, where the ELR-SIG field and the ELR-data field are associated with a set of multiple symbols, the set of multiple symbols is associated with a set of multiple tones, and a modulation rotation is applied to at least a subset of the set of multiple tones.

Clause 185: The wireless communication device of any of clauses 154-184, where the ELR-SIG field and the ELR-data field are associated with a set of multiple symbols, the set of multiple symbols is associated with a set of multiple tones, and a mask is applied to the set of multiple tones.

Clause 186: A wireless communication device, including: a processing system that includes processor circuitry and memory circuitry that stores code, the processing system configured to cause the wireless communication device to: transmit, via a U-SIG field of a PPDU, a first indication that the PPDU is associated with an ELR format, where a first subfield of the U-SIG field includes the first indication; and transmit, via the U-SIG field of the PPDU, a second indication of a first STA identifier associated with the PPDU, where a second subfield of the U-SIG field includes the second indication.

Clause 187: The wireless communication device of clause 186, where the U-SIG field excludes a puncture channel information subfield, an MCS subfield, a quantity of symbols subfield, and a spatial reuse subfield.

Clause 188: The wireless communication device of any of clauses 186-187, where the processing system is further configured to cause the wireless communication device to: generate the U-SIG field of the PPDU in accordance with the PPDU being associated with the ELR format and in accordance with an intended receiver of the PPDU, where the intended receiver of the PPDU is associated with the first STA identifier.

Clause 189: The wireless communication device of any of clauses 186-188, where the first subfield is a version identifier subfield within a version independent portion of the U-SIG field.

Clause 190: The wireless communication device of clause 189, where the version identifier subfield includes a set of multiple bits, and a codepoint indicated by the set of multiple bits of the version identifier subfield indicates that the PPDU is associated with the ELR format.

Clause 191: The wireless communication device of clause 190, where the set of multiple bits of the version identifier subfield is associated with a set of multiple valid codepoints, and the set of multiple valid codepoints includes the codepoint that indicates that the PPDU is associated with the ELR format, a second codepoint that indicates that the PPDU is associated with a UHR format, and a third codepoint that indicates that the PPDU is associated with an EHT format.

Clause 192: The wireless communication device of any of clauses 189-191, where the U-SIG field includes five validate bits within a version dependent portion of the U-SIG field in accordance with the first subfield being the version identifier subfield within the version independent portion of the U-SIG field.

Clause 193: The wireless communication device of any of clauses 186-192, where the first subfield is an ELR subfield within a version dependent portion of the U-SIG field, and the ELR subfield is present within the U-SIG field in accordance with a codepoint indicated by a version identifier subfield within a version independent portion of the U-SIG field.

Clause 194: The wireless communication device of clause 193, where the ELR subfield includes one or more bits, and a value indicated by the one or more bits of the ELR subfield indicates that the PPDU is associated with the ELR format.

Clause 195: The wireless communication device of clause 194, where: the one or more bits of the ELR subfield are associated with four valid values, and the four valid values include the value that indicates that the PPDU is associated with the ELR format and at least one value that indicates that the PPDU is associated with a non-ELR format.

Clause 196: The wireless communication device of any of clauses 193-195, where the U-SIG field includes three validate bits within the version dependent portion of the U-SIG field in accordance with the first subfield being the ELR subfield within the version dependent portion of the U-SIG field.

Clause 197: The wireless communication device of any of clauses 186-196, where the second subfield is a STA identifier subfield within a version dependent portion of the U-SIG field, and the STA identifier subfield is present within the U-SIG field in accordance with the first indication that the PPDU is associated with the ELR format.

Clause 198: A wireless communication device, including: a processing system that includes processor circuitry and memory circuitry that stores code, the processing system configured to cause the wireless communication device to: transmit, via a set of ELR symbols of a PPDU, a first ELR sequence, where the first ELR sequence corresponds to a first BSS associated with the PPDU in accordance with a mapping between a set of multiple ELR sequences and a set of multiple BSSs.

Clause 199: The wireless communication device of clause 198, where the processing system is further configured to cause the wireless communication device to: select the first ELR sequence from the set of multiple ELR sequences in accordance with an intended receiver of the PPDU, where the first ELR sequence corresponds to the first BSS associated with the intended receiver of the PPDU.

Clause 200: The wireless communication device of any of clauses 198-199, where in accordance with the mapping, each BSS of the set of multiple BSSs corresponds to a respective ELR sequence of the set of multiple ELR sequences, the set of multiple BSSs including the first BSS and the set of multiple ELR sequences including the first ELR sequence.

Clause 201: The wireless communication device of clause 200, where each ELR sequence of the set of multiple ELR sequences corresponds to a respective BSS color value of a set of multiple BSS color values, each BSS color value corresponding to a respective BSS of the set of multiple BSSs.

Clause 202: The wireless communication device of clause 201, where the set of multiple ELR sequences includes a quantity of 64 ELR sequences in accordance with each BSS color value being associated with 6 bits.

Clause 203: The wireless communication device of any of clauses 200-202, where the set of multiple ELR sequences is selected from a set of multiple available sequences.

Clause 204: The wireless communication device of clause 203, where the set of multiple ELR sequences is selected from the set of multiple available sequences such that ELR sequences of the set of multiple ELR sequences are associated with relatively lower PAPRs across the set of ELR symbols as compared to a remainder of the set of multiple available sequences.

Clause 205: The wireless communication device of any of clauses 203-204, where the wireless communication device applies a fixed mask to each sequence of the set of multiple available sequences to obtain a masked set of multiple available sequences; and the set of multiple ELR sequences is selected from the masked set of multiple available sequences such that ELR sequences of the set of multiple ELR sequences are associated with relatively lower PAPRs across the set of ELR symbols as compared to a remainder of the masked set of multiple available sequences.

Clause 206: The wireless communication device of any of clauses 203-205, where the wireless communication device applies a modulation rotation to at least a subset of data tones associated with the set of ELR symbols to obtain a set of modulation rotated ELR symbols; and the set of multiple ELR sequences is selected from the set of multiple available sequences such that ELR sequences of the set of multiple ELR sequences are associated with relatively lower PAPRs across the set of modulation rotated ELR symbols as compared to a remainder of the set of multiple available sequences.

Clause 207: The wireless communication device of any of clauses 203-206, where the wireless communication device applies a fixed mask to each sequence of the set of multiple available sequences to obtain a masked set of multiple available sequences; the wireless communication device applies a modulation rotation to at least a subset of data tones associated with the set of ELR symbols to obtain a set of modulation rotated ELR symbols; and the set of multiple ELR sequences is selected from the masked set of multiple available sequences such that ELR sequences of the set of multiple ELR sequences are associated with relatively lower PAPRs across the set of modulation rotated ELR symbols as compared to a remainder of the masked set of multiple available sequences.

Clause 208: The wireless communication device of any of clauses 198-207, where the set of ELR symbols includes a first ELR symbol and a second ELR symbol, the first ELR sequence is a length-96 sequence, and a first half of the first ELR sequence is mapped to a first set of data tones associated with the first ELR symbol and a second half of the first ELR sequence is mapped to a second set of data tones associated with the second ELR symbol.

Clause 209: The wireless communication device of any of clauses 198-208, where the first ELR sequence is associated with a QBPSK modulation scheme in accordance with the PPDU excluding a U-SIG field.

Clause 210: The wireless communication device of any of clauses 198-209, where the first ELR sequence is associated with a BPSK modulation scheme, a QBPSK modulation scheme, or a modulation scheme associated with a tone-by-tone alternation between BPSK and QBPSK in accordance with the set of ELR symbols being present after a U-SIG field of the PPDU.

Clause 211: A wireless communication device, including: a processing system that includes processor circuitry and memory circuitry that stores code, the processing system configured to cause the wireless communication device to: transmit, via a preamble portion of a PPDU associated with an ELR format, an ELR-SIG field that includes an uplink/downlink indicator subfield, a length subfield, a coding indicator subfield, and an MCS subfield; and transmit, via a data portion of the PPDU associated with the ELR format, an ELR-data field in accordance with one or more of the uplink/downlink indicator subfield, the length subfield, the coding indicator subfield, and the MCS subfield included by the ELR-SIG field.

Clause 212: The wireless communication device of clause 211, where the processing system is further configured to cause the wireless communication device to: transmit, via the preamble portion of the PPDU associated with the ELR format, an ELR-LTF, where the ELR-SIG field is located after the ELR-LTF.

Clause 213: The wireless communication device of clause 212, where the ELR-SIG field is located immediately after the ELR-LTF.

Clause 214: The wireless communication device of any of clauses 212-213, where the ELR-SIG field further includes a BSS color subfield.

Clause 215: The wireless communication device of any of clauses 212-214, where the ELR-SIG field further includes a version number subfield.

Clause 216: The wireless communication device of clause 215, where the version number subfield includes two bits and the length subfield includes six or eight bits.

Clause 217: The wireless communication device of any of clauses 215-216, where the length subfield indicates a quantity of symbols associated with a 4× symbol duration.

Clause 218: The wireless communication device of any of clauses 212-217, where the ELR-LTF, the ELR-SIG field, and the ELR-data field are associated with a same dRU size.

Clause 219: The wireless communication device of any of clauses 212-218, where the ELR-SIG field and the ELR-data field are associated with a same modulation scheme.

Clause 220: The wireless communication device of any of clauses 212-219, where the ELR-SIG field is associated with a four-times (4×) symbol operation.

Clause 221: The wireless communication device of any of clauses 211-220, where the processing system is further configured to cause the wireless communication device to: transmit, via the preamble portion of the PPDU associated with the ELR format, one or both of an ELR-STF or an ELR-LTF, where the ELR-SIG field is located prior to the ELR-STF or the ELR-LTF.

Clause 222: The wireless communication device of clause 221, where the ELR-SIG field is located immediately prior to the ELR-STF or the ELR-LTF.

Clause 223: The wireless communication device of any of clauses 221-222, where the ELR-SIG field further includes a BSS color subfield.

Clause 224: The wireless communication device of any of clauses 221-223, where the ELR-SIG field further includes a STA identifier subfield.

Clause 225: The wireless communication device of any of clauses 221-224, where the ELR-SIG field further includes a version number subfield.

Clause 226: The wireless communication device of clause 225, where the version number subfield includes two bits and the length subfield includes six or eight bits.

Clause 227: The wireless communication device of any of clauses 225-226, where the length subfield indicates a quantity of symbols associated with a 4× symbol duration.

Clause 228: The wireless communication device of any of clauses 221-227, where the ELR-SIG field is associated with a 1× symbol operation, an initial symbol of the ELR-SIG field includes a guard interval, and one or more symbols of the ELR-SIG field after the initial symbol exclude guard intervals.

Clause 229: The wireless communication device of any of clauses 221-228, where the ELR-data field is associated with a 1× symbol operation.

Clause 230: The wireless communication device of any of clauses 211-229, where the ELR-SIG field and the ELR-data field are associated with a coding rate of one-third in accordance with being associated with a dRU size of 52 tones.

Clause 231: The wireless communication device of any of clauses 211-230, where the ELR-SIG field and the ELR-data field are associated with a coding rate of two-thirds and a 2× coded bits repetition in accordance with being associated with a BPSK modulation scheme.

Clause 232: The wireless communication device of any of clauses 211-231, where the ELR-SIG field and the ELR-data field are associated with a coding rate of one-half and a 3× coded bits repetition in accordance with being associated with a QPSK modulation scheme.

Clause 233: The wireless communication device of any of clauses 211-232, where the ELR-SIG field and the ELR-data field are associated with a concatenation of an outer code with a repetition coding, the repetition coding is performed prior to an interleaving.

Clause 234: The wireless communication device of any of clauses 211-233, where the ELR-SIG field and the ELR-data field are associated with a 26-tone RU and a duplication over a quantity of 26-tone RUs.

Clause 235: The wireless communication device of clause 234, where: the duplication includes 9× duplication, and the quantity of 26-tone RUs includes nine 26-tone RUs.

Clause 236: The wireless communication device of any of clauses 211-235, where the ELR-SIG field and the ELR-data field are associated with a 52-tone RU and a duplication over a quantity of 52-tone RUs.

Clause 237: The wireless communication device of clause 236, where: the duplication includes 4× duplication, and the quantity of 52-tone RUs includes four 52-tone RUs.

Clause 238: The wireless communication device of any of clauses 211-237, where the ELR-SIG field and the ELR-data field are associated with a 106-tone RU and a duplication over a quantity of 106-tone RUs.

Clause 239: The wireless communication device of clause 238, where: the duplication includes 2× duplication, and the quantity of 106-tone RUs includes two 106-tone RUs.

Clause 240: The wireless communication device of any of clauses 211-239, where the preamble portion of the PPDU further includes an ELR-STF and an ELR-LTF, the ELR-SIG field and the ELR-data field include a set of multiple pilot tones, and the ELR-STF, the ELR-LTF, and the set of multiple pilot tones are associated with an OFDMA transmission format.

Clause 241: The wireless communication device of any of clauses 211-240, where the ELR-SIG field and the ELR-data field are associated with a set of multiple symbols, the set of multiple symbols is associated with a set of multiple tones, and a modulation rotation is applied to at least a subset of the set of multiple tones.

Clause 242: The wireless communication device of any of clauses 211-241, where the ELR-SIG field and the ELR-data field are associated with a set of multiple symbols, the set of multiple symbols is associated with a set of multiple tones, and a mask is applied to the set of multiple tones.

Clause 243: A wireless communication device, including at least one means for performing a method of any of clauses 1-14.

Clause 244: A non-transitory computer-readable medium storing code for wireless communication, the code including instructions executable by a processing system to perform a method of any of clauses 1-14.

Clause 245: A wireless communication device, including at least one means for performing a method of any of clauses 15-32.

Clause 246: A non-transitory computer-readable medium storing code for wireless communication, the code including instructions executable by a processing system to perform a method of any of clauses 15-32.

Clause 247: A wireless communication device, including at least one means for performing a method of any of clauses 33-64.

Clause 248: A non-transitory computer-readable medium storing code for wireless communication, the code including instructions executable by a processing system to perform a method of any of clauses 33-64.

Clause 249: A wireless communication device, including at least one means for performing a method of any of clauses 65-76.

Clause 250: A non-transitory computer-readable medium storing code for wireless communication, the code including instructions executable by a processing system to perform a method of any of clauses 65-76.

Clause 251: A wireless communication device, including at least one means for performing a method of any of clauses 77-89.

Clause 252: A non-transitory computer-readable medium storing code for wireless communication, the code including instructions executable by a processing system to perform a method of any of clauses 77-89.

Clause 253: A wireless communication device, including at least one means for performing a method of any of clauses 90-121.

Clause 254: A non-transitory computer-readable medium storing code for wireless communication, the code including instructions executable by a processing system to perform a method of any of clauses 90-121.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A wireless communication device, comprising:
a processing system that includes processor circuitry and memory circuitry that stores code, the processing system configured to cause the wireless communication device to:
receive, via a universal signal (U-SIG) field of a physical layer (PHY) protocol data unit (PPDU), a first indication that the PPDU is associated with an enhanced long range (ELR) format, wherein a first subfield of the U-SIG field comprises the first indication; and
receive, via the U-SIG field of the PPDU, a second indication of a first station (STA) identifier associated with the PPDU, wherein a second subfield of the U-SIG field comprises the second indication.

2. The wireless communication device of claim 1, wherein the U-SIG field excludes a puncture channel information subfield, a modulation and coding scheme (MCS) subfield, a quantity of symbols subfield, and a spatial reuse subfield.

3. The wireless communication device of claim 1, wherein the processing system is further configured to cause the wireless communication device to:
selectively parse a remainder of the PPDU that follows the U-SIG field in accordance with at least the first indication.

4. The wireless communication device of claim 3, wherein, to selectively parse the remainder of the PPDU that follows the U-SIG field, the processing system is configured to cause the wireless communication device to:
parse the remainder of the PPDU in accordance with:
the wireless communication device being an ELR-capable device; and
a second STA identifier associated with the wireless communication device matching the first STA identifier associated with the PPDU.

5. The wireless communication device of claim 3, wherein, to selectively parse the remainder of the PPDU that follows the U-SIG field, the processing system is configured to cause the wireless communication device to:
drop the remainder of the PPDU in accordance with at least one of:
the wireless communication device being a non-ELR-capable device; or
a second STA identifier associated with the wireless communication device being different than the first STA identifier associated with the PPDU.

6-9. (canceled)

10. The wireless communication device of claim 1, wherein:
the first subfield is an ELR subfield within a version dependent portion of the U-SIG field; and
the ELR subfield is present within the U-SIG field in accordance with a codepoint indicated by a version identifier subfield within a version independent portion of the U-SIG field.

11. The wireless communication device of claim 10, wherein:
the ELR subfield comprises one or more bits; and
a value indicated by the one or more bits of the ELR subfield indicates that the PPDU is associated with the ELR format.

12. (canceled)

13. The wireless communication device of claim 10, wherein the U-SIG field comprises three validate bits within the version dependent portion of the U-SIG field in accordance with the first subfield being the ELR subfield within the version dependent portion of the U-SIG field.

14. The wireless communication device of claim 1, wherein:
the second subfield is a STA identifier subfield within a version dependent portion of the U-SIG field; and
the STA identifier subfield is present within the U-SIG field in accordance with the first indication that the PPDU is associated with the ELR format.

15-64. (canceled)

65. A wireless communication device, comprising:
a processing system that includes processor circuitry and memory circuitry that stores code, the processing system configured to cause the wireless communication device to:
transmit, via a universal signal (U-SIG) field of a physical layer (PHY) protocol data unit (PPDU), a first indication that the PPDU is associated with an enhanced long range (ELR) format, wherein a first subfield of the U-SIG field comprises the first indication; and
transmit, via the U-SIG field of the PPDU, a second indication of a first station (STA) identifier associated with the PPDU, wherein a second subfield of the U-SIG field comprises the second indication.

66. The wireless communication device of claim 65, wherein the U-SIG field excludes a puncture channel information subfield, a modulation and coding scheme (MCS) subfield, a quantity of symbols subfield, and a spatial reuse subfield.

67. The wireless communication device of claim 65, wherein the processing system is further configured to cause the wireless communication device to:
generate the U-SIG field of the PPDU in accordance with the PPDU being associated with the ELR format and in accordance with an intended receiver of the PPDU, wherein the intended receiver of the PPDU is associated with the first STA identifier.

68-71. (canceled)

72. The wireless communication device of claim 65, wherein:
the first subfield is an ELR subfield within a version dependent portion of the U-SIG field; and
the ELR subfield is present within the U-SIG field in accordance with a codepoint indicated by a version identifier subfield within a version independent portion of the U-SIG field.

73. The wireless communication device of claim 72, wherein:
the ELR subfield comprises one or more bits; and
a value indicated by the one or more bits of the ELR subfield indicates that the PPDU is associated with the ELR format.

74. (canceled)

75. The wireless communication device of claim 72, wherein the U-SIG field comprises three validate bits within the version dependent portion of the U-SIG field in accordance with the first subfield being the ELR subfield within the version dependent portion of the U-SIG field.

76. The wireless communication device of claim 65, wherein:
the second subfield is a STA identifier subfield within a version dependent portion of the U-SIG field; and
the STA identifier subfield is present within the U-SIG field in accordance with the first indication that the PPDU is associated with the ELR format.

77-121. (canceled)

122. A method for wireless communication at a wireless communication device, comprising:
receiving, via a universal signal (U-SIG) field of a physical layer (PHY) protocol data unit (PPDU), a first indication that the PPDU is associated with an enhanced long range (ELR) format, wherein a first subfield of the U-SIG field comprises the first indication; and
receiving, via the U-SIG field of the PPDU, a second indication of a first station (STA) identifier associated with the PPDU, wherein a second subfield of the U-SIG field comprises the second indication.

123. The method of claim 122, wherein the U-SIG field excludes a puncture channel information subfield, a modulation and coding scheme (MCS) subfield, a quantity of symbols subfield, and a spatial reuse subfield.

124. The method of claim 122, further comprising:
selectively parsing a remainder of the PPDU that follows the U-SIG field in accordance with at least the first indication.

125. The method of claim 124, wherein selectively parsing the remainder of the PPDU that follows the U-SIG field comprises:
parsing the remainder of the PPDU in accordance with:
the wireless communication device being an ELR-capable device; and
a second STA identifier associated with the wireless communication device matching the first STA identifier associated with the PPDU.

126. The method of claim 124, wherein selectively parsing the remainder of the PPDU that follows the U-SIG field comprises:
dropping the remainder of the PPDU in accordance with at least one of:
the wireless communication device being a non-ELR-capable device; or
a second STA identifier associated with the wireless communication device being different than the first STA identifier associated with the PPDU.

127-130. (canceled)

131. The method of claim 122, wherein:
the first subfield is an ELR subfield within a version dependent portion of the U-SIG field, and
the ELR subfield is present within the U-SIG field in accordance with a codepoint indicated by a version identifier subfield within a version independent portion of the U-SIG field.

132. The method of claim 131, wherein:
the ELR subfield comprises one or more bits, and
a value indicated by the one or more bits of the ELR subfield indicates that the PPDU is associated with the ELR format.

133. (canceled)

134. The method of claim 131, wherein the U-SIG field comprises three validate bits within the version dependent portion of the U-SIG field in accordance with the first subfield being the ELR subfield within the version dependent portion of the U-SIG field.

135. The method of claim 122, wherein:
the second subfield is a STA identifier subfield within a version dependent portion of the U-SIG field, and
the STA identifier subfield is present within the U-SIG field in accordance with the first indication that the PPDU is associated with the ELR format.

136-185. (canceled)

186. A method for wireless communication at a wireless communication device, comprising:
transmitting, via a universal signal (U-SIG) field of a physical layer (PHY) protocol data unit (PPDU), a first indication that the PPDU is associated with an enhanced long range (ELR) format, wherein a first subfield of the U-SIG field comprises the first indication; and
transmitting, via the U-SIG field of the PPDU, a second indication of a first station (STA) identifier associated with the PPDU, wherein a second subfield of the U-SIG field comprises the second indication.

187. The method of claim 186, wherein the U-SIG field excludes a puncture channel information subfield, a modulation and coding scheme (MCS) subfield, a quantity of symbols subfield, and a spatial reuse subfield.

188. The method of claim 186, further comprising:
generating the U-SIG field of the PPDU in accordance with the PPDU being associated with the ELR format and in accordance with an intended receiver of the PPDU, wherein the intended receiver of the PPDU is associated with the first STA identifier.

189-192. (canceled)

193. The method of claim 186, wherein:
the first subfield is an ELR subfield within a version dependent portion of the U-SIG field, and
the ELR subfield is present within the U-SIG field in accordance with a codepoint indicated by a version identifier subfield within a version independent portion of the U-SIG field.

194-196. (canceled)

197. The method of claim 186, wherein:
the second subfield is a STA identifier subfield within a version dependent portion of the U-SIG field, and
the STA identifier subfield is present within the U-SIG field in accordance with the first indication that the PPDU is associated with the ELR format.

198-242. (canceled)
